(19) United States
(12) Patent Application Publication
(10) Pub. No.: US 2016/0065637 A1
(43) Pub. Date: Mar. 3, 2016

(54) SYSTEM AND METHOD FOR DYNAMIC CRITERIA, REQUEST-LISTS, EVENT-LISTS, AND PLAYLISTS

(71) Applicant: Matt O'MALLEY, Lake Balboa,, CA (US)

(72) Inventor: Matt O'Malley, Lake Balboa, CA (US)

(21) Appl. No.: 14/764,981

(22) PCT Filed: Jan. 31, 2014
(86) PCT No.: PCT/US14/14172

§ 371 Date: Jul. 30, 2015

Related U.S. Application Data
(60) Provisional application No. 61/759,386, filed on Jan. 31, 2013.

(51) Int. Cl. H04L 29/06; H04L 29/08

(52) U.S. Cl. CPC H04L 65/4084; H04L 67/306; H04L 67/22; H04L 65/1063

(57) ABSTRACT

A computer-implemented system and method is describe, providing an exchange platform operationally connected to a network for receiving a request from an identified first client and retrieving a playlist of multimedia segments from an associated playlist container that is dynamically generated based on a criteria, including a budget criteria, monetary criteria, request-list criteria, source list criteria, a temporal criteria, an availability criteria, a consumption criteria, a user input criteria, a lifespan criteria, a feed back criteria, an originality criteria, an update criteria, and a previously stored prioritization criteria.

### CLAIM FOR PRIORITY AND CROSS REFERENCE TO RELATED APPLICATIONS

This international patent application (filed under PCT) claims the priority benefit and priority of U.S. provisional patent application Ser. No. 61/759,386, under 35 U.S.C. 119 §(e), which was filed on Jan. 31, 2013, the disclosure of which is specifically incorporated herein in its entirety by reference.

### BACKGROUND

### Field

Embodiments relates to the field of communications and more particularly to improved methods and systems for generating, updating, delivering, prioritizing, and tracking playlists, request-lists, event-lists, and associated multimedia segments, content, metadata, metatags, and/or criteria dynamically.

### SUMMARY

This summary herein is provided to introduce a selection of concepts in a simplified form that are further described below in the Detailed Description. This summary is not intended to exclusively identify key features or essential features of the claimed subject matter, nor is it intended as an aid in determining the scope of the claimed subject matter. Further, the numbering employed in this summary is not related to the numbering of specific parts or steps, but rather for contextual relationships.

In various non-limiting embodiments, a computer-implemented system and method is describe, providing an exchange platform operationally connected to a network for receiving a request from an identified first client and retrieving a playlist of multimedia segments from an associated playlist container that is dynamically generated based on a criteria, including a budget criteria, monetary, request-list criteria, source list criteria, a temporal criteria, an availability criteria, a consumption criteria, a user input criteria, a lifespan criteria, a feedback criteria, an originality criteria, an update criteria, and a previously stored prioritization criteria.

### BRIEF DESCRIPTION OF THE DRAWINGS

FIG. 1 is a block diagram depicting an embodiment of the Network Communication System 38 as presented.

FIG. 2 is a block diagram depicting an embodiment of the NCS 38 where the Exchange Platform is depicted in more detail and a plurality of the Participants 46 and Account(s) 60 are interconnected via a variety of options/methods.

FIG. 3 depicts an operating environment 37 in which the various systems, methods, and data structures described herein may be implemented.

FIG. 4 depicts a schematic view of one embodiment, wherein the Media Server 100 is communicatively coupled to the third-Party Server 101a.

FIG. 5 depicts a call flow of an embodiment employing a 3^{rd} Party Server (501) connected to a Network with a Media Server (502) and a Client (503).

FIG. 6a depicts a call flow embodiment similar to FIG. 5, but where the Client could be either be a computer or mobile device.

FIG. 6b depicts a call flow embodiment similar to FIG. 6a, but specifically for the Mobile Client 530, where at 531 a “Mobile Client Initiates a Phone Call by Hitting ‘Send.’”

FIG. 7 is a flowchart of an embodiment depicting a relationship of FIGS. 8-12 following input from the EP 50 (and/or Media Servers), Clients, and 3^{rd} Parties for creating a new criteria and/or modifying an existing criteria.

FIG. 8 depicts a flowchart of an embodiment of a request-list and criteria submission update by a particular user, where a search is performed and any discovered content is then prioritized within a dynamic playlist and typically, subsequently retrieved and/or played for the particular user.

FIG. 9 depicts a flowchart of an embodiment of evaluating and generating a content originality score based on a variety of criteria and/or metrics.

FIG. 10 depicts a flowchart of an embodiment of the event-list, criteria submissions, and retrievals.

FIG. 11 depicts a flowchart of an embodiment employing the dynamic playlist and associated prioritization before consumption.

FIG. 12 depicts a flowchart of an embodiment of a dynamic-playlist request.

FIG. 13 is a flowchart of an embodiment depicting a relationship of UI Figs for managing Request lists.

FIG. 14a illustrates a system 700 in an example implementation of the user interface in portrait mode in which the Participant/user 46 may create, modify, manage, and/or the like, content, data, feedback, logic, Request-List, Event-List, Playlists, and/or the like, in an embodiment.

FIG. 14b illustrates the system 700 in an example implementation of the user interface, now in landscape mode, where the Participant/user 46 has pressed the “start” 710 function in the previous FIG. 14a, in an embodiment.

FIG. 15a illustrates the system 700 in an example implementation of the user interface in landscape mode in which the Participant/user 46 may create and/or modify a particular request, e.g. pressing button 707 at FIG. 14a or pressing button 718 at FIG. 14b, in various non-limiting embodiments.

FIG. 15b illustrates the system 700 in an example implementation of the user interface in which the Participant/user 46 has pressed a “Show Demo” 732 button/function in the previous FIG. 15a to advance to a Demo 1 for a Sports Category A 735 example, where the participant/user 46 may make it active/inactive via a “on/off” toggle 728, in various non-limiting embodiments.

FIG. 15c illustrates the system 700 in an example implementation of the user interface in which the Participant/user 46 has pressed a “Next” 748 button/function in the previous FIG. 15b to advance to a Demo 2 for a Financial News Category A example, now 748a.

FIG. 16a illustrates the system 700 in an example implementation of the user interface in which the Participant/user 46 has pressed the “Next” 748 button/function in the previous FIG. 14c to advance to a Demo 3 for an Entertainment Category A example, in various non-limiting embodiments.

FIG. 16b illustrates the system 700 in an example implementation of the user interface in which the Participant/user 46 has pressed the “Next” 748 button/function in the previous FIG. 16a to advance to a Demo 4 for another Entertainment Category A example, in various non-limiting embodiments.

FIG. 16c illustrates the system 700 in an example implementation of the user interface in which the Participant/user 46 has pressed the “Search Tags or Keyword(s)” 737c button/function in the previous FIG. 16b to advance to an Application Header 753 which depicts “Search Tags/Keywords”, in various non-limiting embodiments.

FIG. 17a illustrates the system 700 in an example implementation of the user interface in which the Participant/user 46 has pressed the “Playlist Logic” 747 button/function back in the previous FIG. 16b to advance to a “Create/Define Time Window and/or Source Links/Tags” page/functionality, in various non-limiting embodiments.

FIG. 17b illustrates the system 700 in an example implementation of the user interface in which the Participant/user 46 has a “Request Feedback Groups and Rating Minimum” page/functionality for the Request List, in various non-limiting embodiments.

FIG. 17c illustrates the system 700 in an example implementation of the user interface in which the Participant/user 46 has a “Request Settings, Logic, Rules, Lifespan, Etc.” page/functionality for the Request List, in various non-limiting embodiments.

FIG. 18a illustrates the system 700 in an example implementation of the user interface in which the Participant/user 46 has pressed the “edit” button/function in the previous FIG. 18a next to Playlists to advance to “My Only Playlist,” with the Request List and associated Playlist Logic incorporating Search/Keyword Rules via a drop-down selection 843 option, in various non-limiting embodiments.

FIG. 18b illustrates the system 700 in an example implementation of the user interface in which the Participant/user 46 has selected the drop-down selection 843 option for Time Logic/Priority, in various non-limiting embodiments.

FIG. 18c illustrates the system 700 in an example implementation of the user interface in which the Participant/user 46 has an overall view from a “My Content and Message Manager” page/functionality, in various non-limiting embodiments.

FIG. 19 is a flowchart of an embodiment depicting a relationship of UI Figs for managing Event Lists.

FIG. 20a illustrates the system 700 in an example implementation of the user interface in which the Participant/user 46 may create and/or modify a particular event or event-list, e.g. pressing button 708 at FIG. 14a, in various non-limiting embodiments.

FIG. 20b illustrates the system 700 in an example implementation of the user interface in which the Participant/user 46 has a “My First Event” page/functionality for creating an event/task, in various non-limiting embodiments.

FIG. 20c illustrates the system 700 in an example implementation of the user interface in which the Participant/user 46 has a “My First Event” page/functionality and displays an event/task being created, in various non-limiting embodiments.

FIG. 21a illustrates the system 700 in an example implementation of the user interface in which the Participant/user 46 has pressed the “Add To Event-List” 886 button/function back in the previous FIG. 21b to advance to a scheduled event titled “Event-List: ‘Mom's Monday,’” where the page/functionality provides event details that can be viewed, entered, modified, and/or the like, along with providing event management options like Reminder, Life Span, Repeats, and/or the like, in various non-limiting embodiments.

FIG. 21b illustrates the system 700 in an example implementation of the user interface in which the Participant/user 46 has a “Participants: Setup” page/functionality for creating/editing Participant/Contact profiles and related rules, in various non-limiting embodiments.

FIG. 21c illustrates the system 700 in an example implementation of the user interface in which the Participant/user 46 has a “Distribution: Setup” page/functionality for creating/editing the Event-List's Participant distribution profiles and rules, in various non-limiting embodiments.

FIGS. 22a-22h depict a variety of options: (e.g. playback scripts) Options 1a-4a and 1b-4b of the system 700 in an example implementation of the user interface in which the Participant/user 46 can select from the variety of options.

FIGS. 23a-23h also depict a variety of options: Options 1c-4c and 1d-4d of the system 700 in an example implementation of the user interface in which the Participant/user 46 can select from the variety of options.

FIG. 24a illustrates the system 700 in an example implementation of the user interface in which the Participant/user 46 may edit the Event-List, here “Mom's Monday Event-List” page/functionality that can include event details for a particular time (in this case, the time is one day).

FIG. 24b illustrates the system 700 in an example implementation of the user interface in which the Participant/user 46 has rearranged the order of the tasks in “Mom's Monday Event-List” page, in various non-limiting embodiments.

FIG. 24c illustrates the system 700 in an example implementation of the user interface in which the Participant/user 46 is managing a particular task listed on “Mom's Monday” page/functionality, where the Participant can perform such actions as “Adjust Time” 978 and/or select the particular task listed, e.g. “Picked Up Juddi on Time,” “Picked Up Juddi Late,” Adjust Tasks &/or Times,” and/or the like, in various non-limiting embodiments.

FIG. 25a illustrates the system 700 in an example implementation of the user interface in which the Participant/user 46 may manage, edit and/or modify a particular event or event-list, e.g. here, pressing a “Yes” button in rows 957c and 958c under a “Done” header in the row 956c to show that two tasks on this Event-list are done/completed, in various non-limiting embodiments.

FIG. 25b illustrates the system 700 in an example implementation of the user interface in which the Participant/user 46 who may utilized a list of shortcut keys to update the status and logic employed in the Event-List and associated playlists heard by other participants (e.g. family members), e.g. “Currently Ahead of Schedule by 15 Minutes).

FIG. 25c illustrates the system 700 in an example implementation of the user interface in which the Participant/user 46 has adjusted the tasks times according to FIG. 22b, in various non-limiting embodiments.

FIG. 26a illustrates the system 700 in an example implementation of the user interface in which the Participant/user 46 accesses “Playlist-1” 980 to view/create/define Playlist Logic 991 and/or view/create/define Time Window, in various non-limiting embodiments.

FIG. 26b illustrates the system 700 in an example implementation of the user interface in which the Participant/user 46 may organize and/or user-selectively assign content to a particular Playlist and/or Playlists, in various non-limiting embodiments.

FIG. 26c illustrates the system 700 in an example implementation of the user interface in which the Participant/user 46 has an overall view from a “My Content and Message Manager” page/functionality displaying the increase in Playlists 835b to 7 (an increase of +6 from the Playlists 835a in FIG. 18a), and the increase in Participants 837b to 5 (an increase of +4 from the Participants 837a in FIG. 18a), in various non-limiting embodiments.

FIG. 27 is a block diagram depicting another embodiment of the Network Communication System 38.

FIG. 28 is a block diagram depicting an another embodiment of the Exchange Platform (EP) 50 in more detail.

### DETAILED DESCRIPTION

With the ever increasing proliferation of communication modes, features, and applications, especially with mobile devices, network providers, mobile network operators (MNO) 42, hardware manufacturers, application providers, and/or the like, are continually searching for systems and methods to best deliver and monitor enhanced services and products. Features and applications may incorporate such content or multimedia segments as text, images, audio, video, maps, polls, and/or the like, where users may wish to communicate (e.g. voice, voicemail, email. IM, SMS. MMS, Chat, Social, and/or the like), consume content (e.g. view text/images/video, hear audio, feel alerts, and/or the like), and share content (e.g. playlists, calendars, tasks, feedback, chat/social threads, contacts, and/or the like).

Consequently customers demand ever improved data and/or information synchronization and near real-time access, updates, alerts, and/or the like. In various non-limiting embodiments, supporting services would preferably employ dynamic, logic-based, intelligent networks, and/or the like to help meet this demand, and/or discover new relevant data, information, services, products, opportunities, goals, concerns, conflicts, strategies, and/or the like.

Various embodiments are described and illustrated in this specification to provide an overall understanding of the structure, function, operation, manufacture, and use of the disclosed compositions, systems, and methods. It is understood that the various embodiments described and illustrated in this specification are non-limiting and non-exhaustive. Thus, the present disclosure is not limited by the description of the various non-limiting and non-exhaustive embodiments disclosed in this specification. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. The various embodiments disclosed and described in this specification can comprise, consist of, or consist essentially of, or be characterized by the features and characteristics as variously described herein.

Any patent, publication, or other disclosure material identified herein is specifically incorporated herein by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in various non-limiting embodiments,” “in another embodiment,” “in various non-limiting embodiments,” and similar language throughout this specification may, but do not necessarily, all refer to the same embodiment.

The term “modules,” and as employed herein, is considered a computer-executable program electronically stored on a computer-readable storage medium (e.g. storage medium). The term “modules” is used in some embodiments of the present disclosure. These modules provide information to a Participant 46, with the modules carrying one or more sequences of instructions, wherein execution of the one or more sequences of instructions by one or more processors embodied therein causes the one or more processors to perform a method for providing information via a Controller 114 to the Participant 46 using a computer (e.g. a laptop computer, desktop computer, cellular phone (e.g. including analog and/or digital networks), smartphone, wireless-enable-computer, and/or the like), typically with a display and input method (e.g. keypad, touchscreen, audio commands, speaker, audio translator, and/or the like) as a communication device. In various non-limiting embodiments, a who is operationally connected to an Exchange Platform (EP) 50 using the communication device operationally connected to a Network Communication System (NCS) 38, where he/she/it may potentially exchange information/data with the EP 50, is hereinafter together referred to as the Participant 46.

In various non-limiting embodiments, the communication device may be a phone, such as a cell phone, smartphone, mobile phone, landlines, personal digital assistant (PDA)/phone, or the like that may be employed in a cellular network and/or mobile network (MN). In various non-limiting embodiments, the communication device may also be a Voice over Internet Protocol (VoIP) device/client. For example, the communication device may be a computing device, such as a desktop computer, laptop computer, tablet computer, or PDA, with software enabling the computing device to make VoIP calls over the Internet, or the communication device could simply be a device that plays audio and accepts commands, such as voice commands. Some embodiments do not require the communication device to have voice communication capabilities and/or where voice communications or commands are not required or utilized. Some examples of the mobile device 105 may include, without limitation, the Personal Digital Assistant (PDA), cell phone, smart-phone, tablet computer 65, laptop computer 106, netbook, “Vehicle GPS & Computer” 67, Television/IPTV 68, or other network appliance capable of communicating over the network 300, such as private networks, WiFi, WiMax, mesh networks, and/or the like.

Modules can be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions electronically stored in different locations which, when joined logically together, comprise the module and achieve the stated purpose for the module.

Further, storage medium can include, but is not limited to, one or more of the following: any type of physical media, including floppy disks, optical discs, DVDs, CD-ROMs, microdrives, magneto-optical disks, holographic storage devices, ROMs, RAMs, EPROMs, EEPROMs, DRAMs, PRAMS, VRAMs, flash memory devices, magnetic or optical cards, nano-systems (including molecular memory ICs); paper or paper-based media; and any type of media or device suitable for storing instructions and/or information. Various embodiments include a computer program product that can be transmitted in whole or in part and over one or more public and/or private networks wherein the transmission includes instructions and/or information which can be used by one or more processors to perform any of the features presented herein.

A module of executable code can be a single instruction, or many instructions, and may even be distributed over several different code segments, among different programs, and across several memory devices. Similarly, operational data may be identified and illustrated herein within modules, and may be embodied in any suitable form and organized within any suitable type of data structure. In various non-limiting embodiments, the operational data may be collected as a single data set, or may be distributed over different locations including over different storage devices, and may exist, at least partially, merely as electronic signals on a system or network. In various non-limiting embodiments, these modules track and analyze data traffic of the NCS 38, carrying one or more sequences of instructions, wherein execution of the one or more sequences of instructions by one or more processors embodied therein causes the one or more processors to perform a method for exchanging information with an Exchange Platform 50, to a user of the NCS 38.

The following description and the annexed drawings set forth in detail certain illustrative features of the one or more aspects. These features are indicative, however, of but a few of the various ways in which the principles of various aspects may be employed, and this description is intended to include all such aspects and their equivalents.

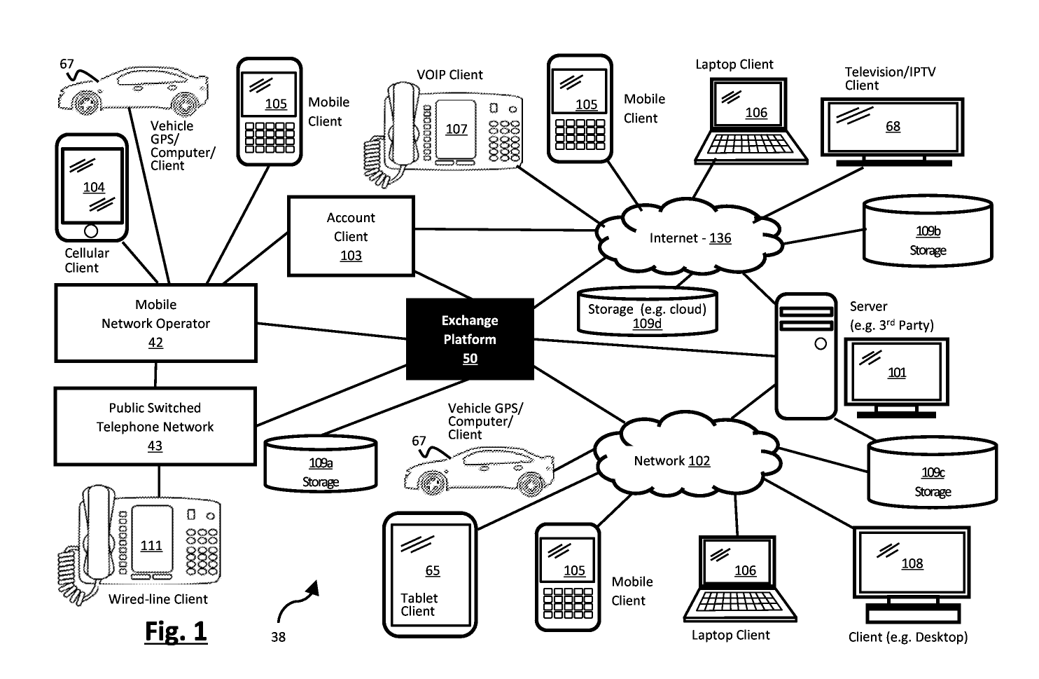

FIG. 1 is a block diagram depicting an embodiment of the Network Communication System 38 as presented. In various non-limiting embodiments, the Exchange Platform 50 monitors and manages QoS, interactions, requests, updates, and/or the like, of a plurality of network communication devices/users (including nodes, participants, MNO subscribers, etc.). The plurality of network communication devices/users, in general, the network communication user utilize a computer client/communication device comprising a Laptop Client 106, a Client 108 in-general (e.g. a desktop client), a Cellular Client 104, a Mobile Client 105, wireless-enable-computer/client, a Tablet Client 65, a vehicle with GPS and computer/client 67, a Television/IPTV Client 68, a VOIP Client/phone 107, a Server 101 (e.g. a Third-Party Server 101a), and/or the like, typically with a display and input method (e.g. keypad, touchscreen, audio commands, speaker, audio translator, and/or the like) as the communication device. In various non-limiting embodiments, the Exchange Platform 50 system, modules, and associated computer implemented methods track and analyze data traffic, requests, and/or the like of the NCS 38 and the plurality of operationally connected network communication devices/users.

In general and in various non-limiting embodiments, a cellular systems support the Signaling System 7 (SS7) integrated Services Digital Network User Part (ISUP) call control protocol, as described in American National Standards Institute (ANSI) standard T1.113-1995, “Signaling System Number 7 (SS7)-Integrated Services Digital Network (ISDN) User Part,” 1995, New York, N.Y., (which is hereby specifically incorporated herein by reference in its entirety for all purposes) which can be implemented in the present disclosure.

In various non-limiting embodiments, one system for delivering enhanced services in an ISUP network is described in U.S. Pat. No. 5,377,186 to Wegner, et al. (which is hereby specifically incorporated herein by reference in its entirety for all purposes) which can be implemented in the present disclosure. The Wegner et al system uses a Local Switch (LS) connected through the network to a Service Control Point (SCP) wherein a subscriber services database resides. The SCP generally retrieves call processing information to forward a call to a desired final destination. The LS is provisioned for ISUP. A number of loop-back trunks with defined Circuit Identification Code (CIC) pairs are also provisioned on the LS. The routing table in the LS is modified to route the voice signal for calls requesting the enhanced subscriber service to the outbound connection of one of the loop-back trunks, and to route to the SCP the associated ISUP messages. The SCP is modified so that an ISUP interface will perform limited switch-type functions, e.g., number translation, using parameters in the 40 ISUP call-setup messages that were originally intended for conditions such as call forwarding. To the network, the SCP appears to be a switch.

In various non-limiting embodiments, the Network Communication System 38 may comprise any network (e.g. Mobile, LAN, WAN, WLAN, MAN, Internet, Intranet, and/or the like) depicted here as a Network 102, an Internet 136, a Mobile Network Operator (MNO) 42, a Public Switched Telephone Network (PSTN) 43, the Exchange Platform 50, and/or the like, where each may be operatively connected to each other and/or a variety of computer clients, servers, storage, devices, peripherals, and/or the like.

In various non-limiting embodiments, each operational connection, communication link, protocol, and/or the like inside the NCS 38 may be any type suitable for a functioning network protocol, connection, communication link and/or the like, such as a Transmission Control Protocol (TCP) connection, a Transmission Control Protocol/Internet Protocol (TCP/IP) connection, a User Datagram Protocol (UDP), a User Datagram Protocol/Internet Protocol (UDP/IP), a hypertext transfer protocol (HTTP) and/or the like. In various non-limiting embodiments, the network connection and communication link/protocol may also incorporate and/or comprise a Signal System Number 7 (SS7) network with a Voice Trunk Connection (SS7/VTC), an IP Multimedia Subsystem (IMS) or other Long Term Evolution (LTE) communication protocols, communication links, connections, and/or the like.

In various non-limiting embodiments, there is at least one Mobile Network Operator (MNO) 42, which is preferably operationally connected to an at least one Exchange Platform 50 and where the MNO 42 typically has clients, subscribers, participants, accounts, and/or users comprising Cellular Clients 104, Mobile Clients 105, Account Clients 103, and/or the like. In various non-limiting embodiments, there may be a plurality of Mobile Network Operators 42 independently connected (not shown). In various non-limiting embodiments, the Mobile Network Operators 42 would preferably incorporate traditional equipment and means for communication and data exchange comprising cell towers which allow calling parties to operationally connect via radio-telecommunications links and where the cell tower or similar is operationally connected to a mobile switching center (MSC) 140 over multi-frequency (MF) trunk. MSC generally includes a plurality of loop-back trunks, where the loop-back trunk has an outbound side and an inbound side with respect to the MSC.

U.S. Pat. No. 5,396,543 to Beeson, Jr. et at entitled “Signaling arrangements in a cellular mobile telecommunications switching system” (which is hereby specifically incorporated herein by reference in its entirety for all purposes) which can be implemented in the present disclosure. The Beeson. Jr, et al abstract states: Apparatus and methods for providing cellular mobile telecommunication service in accordance with the requirements of the Global Systems for Mobile Communications (GSM) standard. A modular switching system is provided which performs the functions of the mobile switching center, plus those of a home location register, authentication center, visitor location register, and equipment identity register. In various non-limiting embodiments, the latter functions are advantageously spread among the modules of the switching system, thus avoiding the getting started’ cost of expensive dedicated data bases. A wireless global switching module advantageously switches mobile communications control messages among the modules of the system and between the modules and the base station systems, and terminates signaling links between the mobile switching center and the base station systems.

U.S. Pat. No. 5,459,727 to Vannucci entitled “Wireless Telecommunication System” (which is hereby specifically incorporated herein by reference in its entirety for all purposes) which can be implemented in the present disclosure, where the abstract states: The [Vannucci] disclosure overcomes the prior art limitations by dividing a coverage area into very small regions or cells. The inventive system can be built as an adjunct to a wired telecommunication system such as a PBX. Advantageously, because of the relatively small size of each cell, transceivers in the inventive system can use very low transmission power, compared with a pico-cellular communications system, to communicate with a fixed transceiver. In addition, because of the relatively short distance between the mobile handset and the fixed transceiver, the communication paths between any two transceivers are reduced and, therefore, the multipath distortion which can affect the received signals is substantially reduced.

U.S. Pat. No. 5,101,501 to Gilhousen et al entitled “Method and system for providing a soft handoff in communications in a CDMA Cellular Telephone System” (which is hereby specifically incorporated herein by reference in its entirety for all purposes) which can be implemented in the present disclosure, where the abstract states: In a cellular telephone system a [Gilhousen el al] system for directing communications between a mobile user and cell-sites as a mobile user changes cell-site service areas. The mobile user includes an apparatus for, while in communication with another system user via one cell-site, determining a transition of the mobile user from the cell-site service area to the service area of another cell-site. The system includes circuitry responsive to the indication for coupling communications between the mobile user and the other system user via the new cell-site while the mobile user also remains in communication with the system user via the first cell-site. The system further includes apparatus responsive to the coupling of the communications between the mobile user and the other system user via the new cell-site for terminating the communications between the mobile user and another system user via cell-site with communications continuing between the mobile user and the system user via the new cell-site.

In various non-limiting embodiments, the Public Switched Telephone Network 43 would preferably operatively communicate and exchange data with the Exchange Platform 50 and allow communications and data exchange with typically Wired-Line Clients 111, and/or the like. In various non-limiting embodiments, there may be a plurality of PSTN 43 independently connected (not shown). In various non-limiting embodiments, the PSTN 43 may incorporate traditional equipment and means for communication and data exchange.

U.S. Pat. No. 4,124,773 to Elkins entitled “Audio storage and distribution system” (which is hereby specifically incorporated herein by reference in its entirety for all purposes) which can be implemented in the present disclosure, where the abstract states: This invention relates to an electronic system and a method for storing and distributing audio signals over existing communication lines. The [Elkins] system comprises a compressor for compressing in a predetermined manner the waveform amplitude of an input analog signal, thereby forming a compressed analog signal, be compressed analog signal is then converted into a digital signal by an analog to digital converter. A digital interface subsystem stores and retrieves selected ones of the digital signals for transmission over a communications line. At a remote end of the communications line the digital signal is converted back to its analog compressed signal representation by a digital to analog converter. The compressed analog signal is then expanded in a manner complimentary to the compressor operation, thus reconstructing the analog signal. A selector generator is provided at the remote end of the communications line for generating a command signal over the communications line to command signal over the communication line to command the digital interface subsystem to select the desired one of the stored digital signals.

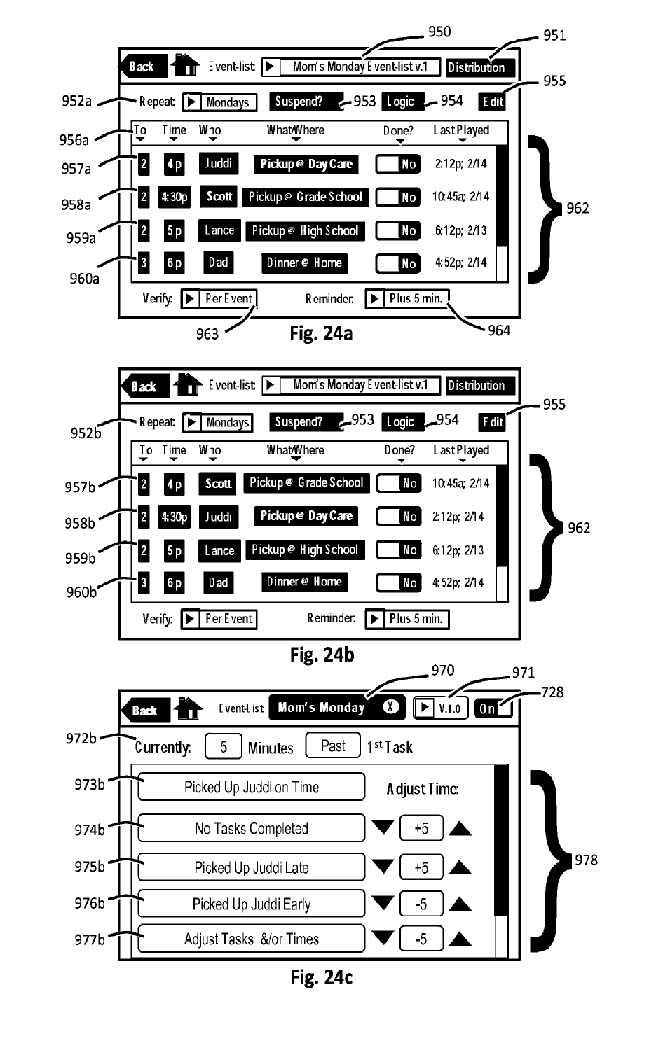

In various non-limiting embodiments, the EP 50 may communicate with the Mobile Network Operator 42 from, in one embodiment, outside the network via any communication connection via the SS7/VTC and/or the TCP/IP connection. In various non-limiting embodiments, the EP 50 and/or components of the EP 50 may also be located within another environment, say within a Communications System 42 environment (see a Media Server 100b in FIG. 24). In various non-limiting embodiments, the EP 50 is also operatively connected to the Account Client 103 that may be via any type network connection that allows for data communication, say a wired connection such as the TCP/IP connection, but may also be via a wireless connection.

In various non-limiting embodiments, the EP 50 is typically also operatively connected to the Internet 136 and/or the Network 102 where each may allow for a variety of computer client and server two-way (e.g. bi-directional) communications, such as a VOIP Client 107, the Mobile Client 105, a Desktop Client 108, the Server 101 (e.g. the 3^{rd}-Party Server), and/or the like. In various non-limiting embodiments, the EP 50 is typically also operatively connected to a Storage 109a. In various non-limiting embodiments, a Storage 109 may incorporate and/or comprise a plurality of hardware devices, virtual hardware, software, and methodologies, including stand-alone hardware, a Storage 109b through the Internet 136 and/or the Network 102, storage interconnected via other computers/devices such as a Storage 109c, storage in the cloud, and/or the like.

In various non-limiting embodiments, the communication devices may support an application where, for example, the network connection may or may not require a connection or persistent connection. An application, also referred to as an “app,” generally refers to a software application that executes on the computing device, such as the mobile device 105 (e.g., the mobile device refers to a computing device that includes a processor for executing a software application). For example, mobile devices 105 include smart phones, tablets 65, laptops 103, and/or other mobile devices 105. Various application platforms exist for different operating systems, such as Microsoft Windows® platforms, Google Android® platforms, and Apple iOS® platforms. Application markets (e.g., app stores) exist for each of these application platforms, which can make available thousands to millions of different apps for such platforms. For example, various apps are available for executing on smart phones such as the HTC EVO® or Apple iPhone®, tablets such as the Samsung Galaxay Tab®, Microsoft Surface®, Motorola Xoom® or Apple iPad®, embedded devices executing the Google Android® operating system, and computer operating systems such as Apple Mac OS X® and Microsoft Windows 8®.

Also, as these operating system platforms for mobile devices 105 converge with legacy computer desktop and laptop operating system platforms (e.g., Microsoft Windows® 8 and Apple Mac OS X®), similar app markets and availability of common apps across such platforms are becoming increasingly common.

In various non-limiting embodiments, the delivery the communication device/client may also include the Voice over Internet Protocol (VoIP) device/client 107. For example, the communication device may be a computing device, such as a desktop computer/client, laptop computer/client, tablet computer client, and/or the like, with software enabling the computing device client to make VoIP calls over the Internet, or the communication device client could simply be a device that plays audio and accepts commands, such as voice commands. In various non-limiting embodiments, the communication device does not require packet data communications to interact with the EP 50. For example, the EP 50 may send an audio message alert to a Landline Phone (e.g. Wired-Lined Client 111), where the Landline Phone does not employ a packet data protocol/communications.

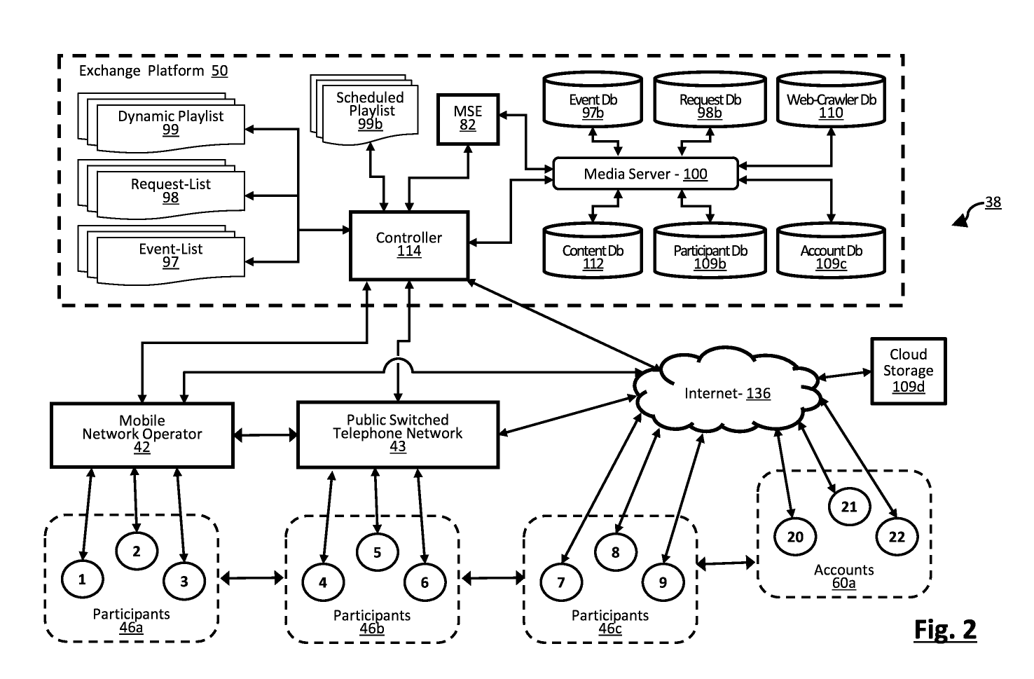

FIG. 2 is a block diagram depicting an embodiment of the NCS 38 where the Exchange Platform is depicted in more detail and a plurality of the Participants 46 (e.g. device/users) and Account(s) 60 are interconnected via a variety of options/methods. In various non-limiting embodiments, the EP 50 would preferably allow an Account or plurality of Accounts 60a (e.g. 20, 21, and 22) to interact with the EP 50 via the Internet 136, but the interaction/connection may be any type of viable communication connection. In various non-limiting embodiments, the Accounts 60a are typically third parties with content, data, information, and/or the like, who may also create, utilize, target, deliver, prioritize, rank, sort, monitor and/or the like. Whereas the Participants 46 is typically someone or a machine that generally consumes content, but may also request, search, organize, track, comment, pull, download, stream, push/share, chat, text/SMS, and/or the like, data, content, media, and/or the like.

In various non-limiting embodiments the Participants 46 can also be Accounts 60; and in some embodiments, Accounts 60 can also be Participants 46. In various non-limiting embodiments, the terms “Accounts” and “Participants” are interchangeable. In various non-limiting embodiments, the terms “devices/users” (e.g. device or users) and “Participants” are interchangeable. In various non-limiting embodiments, the terms “devices/users” and “Accounts” are interchangeable. In various non-limiting embodiments, the terms “devices, users, members, participants, accounts, and clients” are all interchangeable. In various non-limiting embodiments, the terms “devices” and “artificial intelligent systems” are interchangeable.

In various non-limiting embodiments, the Participants 46a (e.g. 1, 2, 3) are Participants 46 who are operationally connected to the Mobile Network Operator 42 via his/her/its Communication Device, where the Participants 46a (1, 2, 3) may all be operationally connected to the same Mobile Network Operator 42 or via a variety of Mobile Network Operators. Participants 46b (e.g. 4, 5, 6) are Participants 46 who are operationally connected to the PSTN 43 via his/her/its Communication Device, where Participants 46b (4, 5, 6) may all be operationally connected to the same PSTN 43 or via a variety of PSTNs 43. In various non-limiting embodiments, the Participants 46c (e.g. 7, 8, 9) are Participants 46 who are operationally connected to the Internet 136 via his/her/its Communication Device, where Participants 46c (7, 8, 9) may all be operationally connected to the Internet 136 via the same Access Point and/or ISP or via a variety of Access Points and/or a variety of ISPs. In various non-limiting embodiments, there may be one or more additional storage devices, such as a cloud storage 109d operationally connected to the Internet 136 and utilized for storage for the disclosed system, users, devices, participants, accounts, and/or the like.

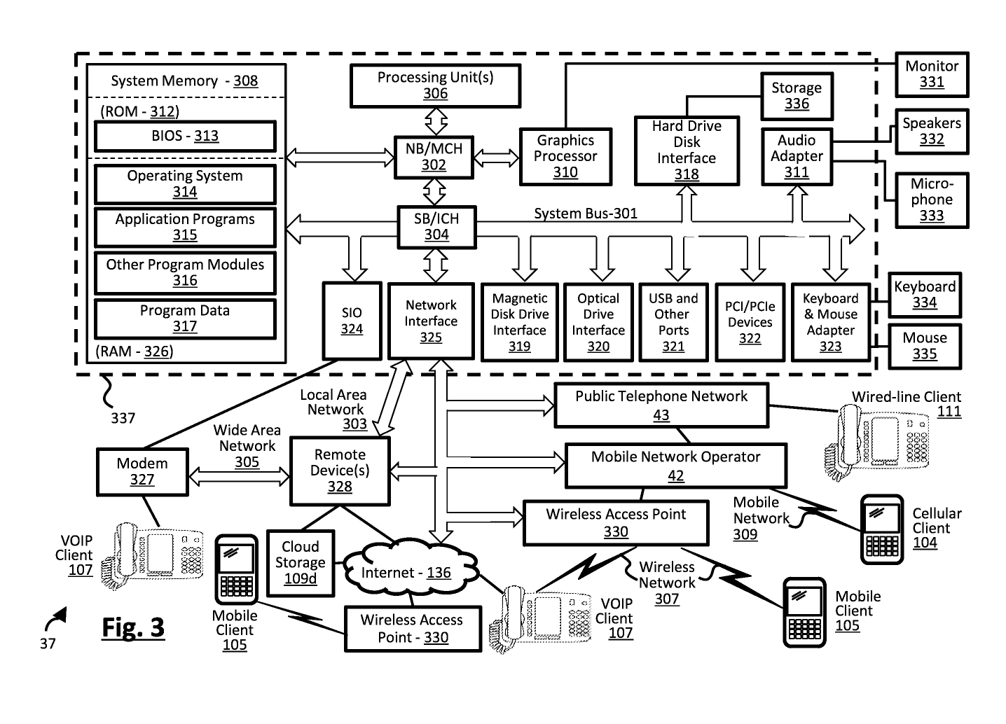

In various non-limiting embodiments, the Participants are computer clients/users (e.g. from FIG. 1) comprising the Television/IPTV Clients 68, the Mobile Clients 105 (e.g. a Personal Digital Assistant (PDA), the Laptop Clients 106, the VOIP Client 107, the Tablet Client 65, the Desktop Client 108, the Server 42 (e.g. the Third Party Server) and/or the like; who are operationally connected to the Internet 136 directly and/or via the Access Point and/or the ISP or via a variety of Access Points (e.g. FIG. 3), and/or a variety of ISPs, and/or a variety of the Networks 102, and/or the like. In various non-limiting embodiments, the MNO 42, PSTN 43, Internet 136, Network 102, and/or the like may be operationally interconnected. In various non-limiting embodiments, the MNO 42, PSTN 43, and Internet 136 may be operationally interconnected and Participants 46a, 46b, and 46c may be operationally interconnected, where some communication devices may, for example, seamlessly roam, transfer, and/or the like from one network to another. In various non-limiting embodiments, the communication devices may support an application where a network connection may not require a constant connection. Further, in various non-limiting embodiments, content, playlists, event-list, requests-lists, criteria, playlist associated container items, and/or the like may be transferred peer-to-peer (e.g. via ad-hoc networks, mesh networks, Bluetooth, Wi-Fi, NFR, and/or the like) and/or may employ transferrable media methods, cabling, and/or the like to transfer some content. In various non-limiting embodiments, playlists can comprise segments for multimedia elements or multimedia segments. In various non-limiting embodiments, the segments of multimedia elements or multimedia segments can comprise elements from previously stored playlists, event-lists, request-lists, and/or the like. In various non-limiting embodiments, the term “event-list,” request-list,” and/or “playlist” are each interchangeable. In various non-limiting embodiments, the “associated criteria, items, elements, metadata, multimedia segments, and/or containers of the “playlist,” “event-list,” and/or “request-list are each interchangeable.

In various non-limiting embodiments, the Communication Devices used by Participants 46 in FIG. 2 would preferably be a transceiver (e.g. computer, mobile phone, smartphone, PDA, cellular phone (e.g. including analog and/or digital networks), and/or the like) that allows operationally interactions, communications, synchronizations, data exchanges and/or the like, bi-directionally from itself and the EP 50. In various non-limiting embodiments, utilizing a cellular communication (e.g. including analog and/or digital networks) and/or MN, as an example, where a mobile subscriber, the “Participant 1” (e.g. 46a) uses a mobile telephone as the communication device and may connect to another Participant 46, say the “Participant 2” (e.g. 46b) through the MNO 42, where the EP 50 may also be employed. In various non-limiting embodiments, the EP 50 and/or some components of the EP 50 may be physically located separately from the MNO 42 and/or where all or some components are physically located inside the MNO's 42 network.

In various non-limiting embodiments, the EP 50 may comprise the Controller 114, a Message Selection Engine (MSE) 82, a Media Server 100, an Event Database (Db) 97b, a Request Db 98b, a Web-Crawler Db 110, a Content Db 112, a Participant Db 109b, an Account Db 109c, a Dynamic Playlist 99, a Request-List 98, an Event-List 97, and a Scheduled-Playlist 99b (e.g. a predetermined playlist, a predetermine multimedia segment, predetermined playlist container, element, criteria, and/or the like). In various non-limiting embodiments, the EP 50 is typically operatively connected to the Internet 136, the Network 102, the MNO 42, PSTN 43, and/or the like via the Controller 114. In various non-limiting embodiments, the terms “Playlist, Event List, and/or Request-List” are each interchangeable. In various non-limiting embodiments, the terms “Playlist items, Event List items, and/or Request List items” are each interchangeable. In various non-limiting embodiments, the terms “Predetermined Playlist” and “Scheduled Playlist” are interchangeable. In various non-limiting embodiments, the terms “Playlist” and “Dynamic Playlist” are interchangeable.

In various non-limiting embodiments, a request made by/to/for the EP 50 may comprise receiving, analyzing, selecting, aggregating, sorting, sequencing, scoring, ranking, tracking, sending, and/or delivering data, content, media, logic and/or the like, throughout the NCS 38. In various non-limiting embodiments, the delivery would be to the communication device/client.

In various non-limiting embodiments, the audio message alert (also referred to as an Actionable Audio Message (AAM)) (not depicted) sent by the EP 50, may be initiated by a flagging of the network communication device/user by a mobile network operator (MNO) 42, where the flagging of the network communication device/user prompts the EP 50 to employ a message selection engine (MSE) 82 (FIG. 2) that may send and/or play the AAM during the call setup time of a phone call. In various non-limiting embodiments, the AAM may be play(ed), triggered, paused, delayed, forwarded, stored, retrieved, and/or the like.

In various non-limiting embodiments, the AAM may incorporate a variety of associated prompts/actions (e.g. via a Dual-Tone Multi-Frequency (DTMF) for a particular campaign and campaign rules), where the EP 50 would employ an action selection engine (ASE) (not depicted) to select a specific action to associate with the AAM (e.g. and the particular campaign and campaign rules) sent to the network communication device/user. In various non-limiting embodiments, the AAM sent by the EP 50 may be initiated by a flagging of the network communication device/user by the MNO 42, where the flagging of the network communication device/user prompts the EP 50 to employ a MSE 82 that may send and/or play the AAM during the call setup time of a phone call.

In various non-limiting embodiments, the AAM is an audio message that may be played and/or where voice communications or commands are not required or utilized. In various non-limiting embodiments, the AAM is an audio message that may be played and/or where voice communications or commands may or may not be required or utilized. Some embodiments do not require the communication device to have voice communication capabilities and/or where voice communications or commands are not required or utilized. In various non-limiting embodiments, the sending/playing of the AAM by the EP 50 to the network communication device/user may be sent, transmitted, queued, and/or played to any type of network communication device, whether the device employs the packet data protocol/communications or not.

In various non-limiting embodiments, the network communication device/user (e.g. FIG. 2) would preferably employ the packet data protocol/communications. In various non-limiting embodiments, the plurality of network communication devices/users comprises the participants 46 (e.g. 46a, 46b, 46c, and/or the like), Accounts 60a, and/or the like. In various non-limiting embodiments, the terms “mobile devices/users” (e.g. mobile device or user)” and “participant” 46 are interchangeable.

In various non-limiting embodiments, the system modules track and analyze data traffic of the NCS 38 of the network communication device via a data packet analysis of a data packet flowing along a communication link, including communication links in the network 102.

In various non-limiting embodiments, the EP 50 would preferably monitor packets in near real-time, if not real-time. In various non-limiting embodiments, the analysis of the data packets/traffic would include discerning any new and/or updated requests, and/or the like where the analysis would preferably incorporate computer instructions, logic, rules, filters, weighing, and/or the like to generate a collective value. In various non-limiting embodiments, the analysis for requests, updates, and/or the likes would preferably include values that define each element incorporated and its associated threshold value, range start/end, and/or the like, and/or methods generate values, from say, existing data, similar defaults, and/or logic. In various non-limiting embodiments, the values that define each incorporated and associated threshold value, range start/end, and/or the like would preferably incorporate near-real-time, if not real-time, network intelligence to generate values dynamically. In various non-limiting embodiments, the generated values dynamically incorporate inputs comprising the user, artificial intelligence, machine learning, analysis, group consensus, conditions, and/or some combination or permutations of these.

In various non-limiting embodiments, a particular request would preferably prompt an alert when the analysis produced a value that surpasses a particular set threshold value and/or a particular dynamic threshold value (and/or where the value fell within the set range and/or the dynamic range). In various non-limiting embodiments, the alert would preferably prompt the MSE 82 and the ASE to send a message/action (e.g. notification/alert) to the communication device/user accordingly. For example, the message/action may simply be acknowledging an analysis, perception, assumption, consumption, expectation, bill, payment method, limit, restriction, and/or the like.

In various non-limiting embodiments, the EP 50 includes user login capabilities, billing management, the ability to specify and load content, request-List, event-list, playlist, data, feedback, logic, and rules electronically, intelligently, automatically, systematically (e.g. machine learning/artificial intelligent system), intelligently, and/or user/actor selectively, and/or some combination or permutations of these. In various non-limiting embodiments, the EP 50 further allows third parties or Accounts 60a to create, manage, distribute, measure, report, offer, track, sequence, score, adjust, and/or the like their content, data, and/or media for clients (e.g. desktop client 108). In various non-limiting embodiments, the Accounts 60a may accessed the EP 50 through a standard web interface, and the EP 50 may also provide a unique Application Programming Interface (API) solution for Accounts 60a who wish to provide direct and/or conditional (e.g. paid, limited, subscription, lease, streamed, downloaded, and/or the like) access to their content, media, data and/or the like.

In various non-limiting embodiments, the EP 50 allows the Accounts 60 to setup specific and/or conditional rules for access, as well as what specific requests, follow-up actions, feedback, logic, and/or the like a particular Participant 46 or a particular Participant 46 segment type, a particular access type or a particular access segment type, another segmentation type, a particular window of time, a particular network type, a particular account type, and/or the like, setup with rules and instructions for each particular piece of content, data, rule, and/or the like. In addition, the EP 50 provides Accounts 60a organizational capabilities and reporting functionality, including revenue reports with various ways to view data, such as summary totals by Participant 46 segmentations (e.g. Demographics, Psychographics, Location, Motion, Contact History, Behavioral, etc.); timing, and usage tracking; feedback, requests, consumption, action metrics and/or conversion metrics; and event optimization and completion goals (also see other features, details, and/or embodiments, e.g. FIG. 24).

In various non-limiting embodiments, the playlist is one method for organizing, sequencing, prioritizing, and/or sharing content, criteria, and/or meta data. U.S. Pat. No. 7,689,705 to Lester et al entitled “Interactive delivery of media using dynamic playlist generation subject to restrictive criteria” (which is hereby specifically incorporated herein by reference in its entirety for all purposes) which can be implemented in the present disclosure, where the abstract states: A media delivery scheme distributes a stream of media files to a group of users while allowing individual users to request specific media files. In one embodiment, a media server 100 maintains a playlist of media files to broadcast, and requests for media must satisfy certain restrictive criteria to be added to the playlist. In another aspect of a preferred embodiment, the media server 100 schedules requested media so as to comply with provisions of the DMCA.

In various non-limiting embodiments, the Scheduled Playlist 99b is generally a playlist with a predetermined schedule, content, sequence, prioritization, feedback, and/or the like, whereas the Dynamic Playlist 99 is generally a playlist where the schedule, content, sequence, prioritization, feedback, criteria, meta-data and/or the like allows for dynamic modifications. In various non-limiting embodiments, the Dynamic Playlist 99 modifications may be in real-time and/or near real-time. In various non-limiting embodiments, the Dynamic Playlist 99 modifications may be automatically, systematically (e.g. via artificial intelligence/machine learning), conditionally, and/or actor and/or user-selectively. In various non-limiting embodiments, a playlist, whether the Scheduled Playlist 99b or the Dynamic Playlist 99 may or may not include audio, say only video, graphics, text, maps, and/or some combination or permutation.

In various non-limiting embodiments, the Request-list 97 (e.g. a playlist content, sequence, prioritization, ranking, scoring, feedback, meta-data and/or the like, related content, media, criteria, data, meta-data and/or the like) is one method for requesting content and/or prioritizing content (e.g. for the Dynamic Playlist 99). In various non-limiting embodiments, the Event-list 97 (e.g. to-do-list, task-list, and/or the like) is another method for organizing, sequencing, and sharing content. In various non-limiting embodiments, the playlist may comprise elements from an Event-List 97 and vice versa. In various non-limiting embodiments, the terms “playlists” and “event-lists” are interchangeable. In various non-limiting embodiments, the “associated criteria, items, elements, metadata, multimedia segments, and/or containers of the “playlist” and the “event-list” are interchangeable.

FIG. 3 depicts an operating environment 37 in which the various systems, methods, and data structures described herein may be implemented. In various non-limiting embodiments, the exemplary Operating Environment 37 of FIG. 3 includes a general purpose computing device in the form of a Computer 337, including a Processing Unit 306, a System Memory 308, and a System Bus 301 that operatively couples various system components, including the System Memory to the Processing Unit 306. In various non-limiting embodiments, there may be only one or there may be more than one processing unit 306, such that the processor of Computer 337 comprises a single central processing unit (CPU), or a plurality of processing units, commonly referred to as a parallel processing environment. In various non-limiting embodiments, the Computer 337 may be a conventional computer, a distributed computer, or any other type of computer.

In various non-limiting embodiments, and in-general, the (Computer 337 represents the computer utilized in the EP 50, and/or Media Server 100, preferably wherein the functionality required to perform a variety of disclosed system and module functions is provided by the Computer 337 and/or similar. In various non-limiting embodiments, the Computer 337 represents a particular computer associated with the EP 50 and/or Media Server 100, preferably wherein the functionality required to perform a variety of disclosed system and module functions is provided by the Computer 337 and/or similar.

In various non-limiting embodiments, the Computer 337 may represent the computer and functionally utilized in the third party server, and/or account, preferably wherein the functionality required to perform a variety of disclosed system and module functions is provided by the Computer 337 and/or similar. In various non-limiting embodiments, the Computer 337 represents a particular computer associated with the third party server, and/or account, preferably wherein the functionality required to perform a variety of disclosed system and module functions is provided by the Computer 337 and/or similar.

In various non-limiting embodiments, the Computer 337 may represent the computer and functionally utilized in the client, and/or device, preferably wherein the functionality required to perform a variety of disclosed system and module functions is provided by the Computer 337 and/or similar. In various non-limiting embodiments, the Computer 337 represents a particular computer associated with the client, and/or device, preferably wherein the functionality required to perform a variety of disclosed system and module functions is provided by the Computer 337 and/or similar.

In various non-limiting embodiments, the System Bus 301 may be any of several types of bus structures, including a memory bus or memory controller, a peripheral bus, and/or a local bus using any of a variety of bus architectures. In various non-limiting embodiments, the system memory may also be referred to as simply the memory, and includes Read Only Memory (ROM) 312 and random access memory (RAM) 326. A basic input/output system (BIOS) 313, containing be basic routines that help to transfer information between elements within the Computer 337, such as during start-up, is stored in ROM 312. In various non-limiting embodiments, the Computer 337 further includes a hard disk drive (e.g. storage 336 or storage medium) for reading from and writing to a hard disk (e.g. Storage 336, Storage 109, 109a, 109b, 109c), a magnetic disk drive for reading from or writing to a removable magnetic disk, and an optical disk drive for reading from or writing to a removable optical disk, such as CD-ROM, digital versatile disk (DVD), or other optical media.

In various non-limiting embodiments, the hard disk drive, magnetic disk drive, and optical disk drive are connected to the System Bus 301 by a Hard Disk Drive Interface 318, a Magnetic Disk Drive Interface 319, and an Optical Disk Drive Interface 320, respectively. In various non-limiting embodiments, the drives and their associated computer-readable media provide nonvolatile storage of computer-readable instructions, data structures, program modules and other data for the computer 337. It should be appreciated by those skilled in the art that any type of computer-readable media which can store data that is accessible by a computer, such as magnetic cassettes, flash memory cards, flash memory devices (e.g. card, stick), smart cards, digital video disks, Bernoulli cartridges, random access memories (RAMs), read only memories (ROMs), and the like, may be used in the Operating Environment 300.

A number of program modules may be electronically stored on the hard disk, magnetic disk, optical disk, ROM 312, or RAM 326, including an Operating System 314, one or more Application Programs 315, Other Program Modules 316, and Program Data 317. At least one of the Application Programs 315 is a host application operable to control presentation of media and/or content using a playlist and respond to user and application initiated events.

A user may enter commands and information into the personal computer 337 through input devices such as a Keyboard 334 and pointing device or a Mouse 335. Other input devices may include a Microphone 333, a (not shown) joystick, game pad, satellite dish, scanner, and/or the like. In various non-limiting embodiments, these and other input devices are often connected to the Processing Unit 306 through a serial port interface or SIO 324 that is coupled to the System Bus 301, but may be connected by other interfaces, such as a parallel port, game port, a universal serial bus (USB) and Other Ports 321, or a PCI/PCIe Devices (IO) 322. A Monitor 331 or other type of display device is also connected to the System Bus 301 via an interface, such as a video adapter and may include a Graphics Processor 310. In addition to the monitor, computers typically include other peripheral output devices, such as a Speaker(s) 332, and printers (not shown).

In various non-limiting embodiments, the Computer 337 may operate in a networked environment using logical connections to one or more remote devices (e.g. clients, servers, storages, and/or the like), such as a Remote device 328 or connect to one or more than one additional storage devices, such as the cloud storage 109d. In various non-limiting embodiments, these logical connections may be achieved by a communication device coupled to or a part of the Computer 337, or in other manners. In various non-limiting embodiments, the Remote device 328 may be another computer, a server, a router, a network PC, a client, a peer device or other common network node, and typically includes many or all of the elements described above relative to the Computer 337. In various non-limiting embodiments, the logical connections depicted herein include a local-area network (LAN) 303, a wide-area network (WAN) 305, and the Internet 136. Such networking environments are commonplace in office networks, enterprise-wide computer networks, intranets and the Internal, which are all types of networks.

When used in a LAN-networking environment, the Computer 337 is connected to the LAN 303 through an adapter or Network Interface 325, which is one type of communications device. When used in a WAN-networking environment, the Computer 337 typically includes a Modem 327, a type of communications device, or any other type of communications device for establishing communications over the WAN 305. In various non-limiting embodiments, the Modem 327, which may be internal or external, is connected to the System Bus 301 via the serial port interface/SIO 324. In a networked environment, program modules depicted relative to the Computer 337, or portions thereof, may be stored in the remote memory storage device (not shown here).

In addition to the LAN 303 and the WAN 305, the logical connections may include a Public Switched Telephone Network (PSTN) 43, a Mobile Network Operator 42 (with a Mobile Network 309), and a Wireless Access Point 330 (with a Wireless Network 307). When used in PSTN 43, the Computer 337 typically includes a type of communications device such as a Wired-Line Client 111, or any other type of communications device for establishing communications over the PSTN 43. In the PSTN 43 environment, the program modules, or portions thereof, may be stored at the PSTN 43.

In various non-limiting embodiments, the logical connections for the Mobile Network Operator 42 with the associated Mobile Network 309, the Computer 337 typically includes a type of communications device such as the Cellular Client 104, or any other type of communications device for establishing communications over the Mobile Network 309. In the Mobile Network 309 environment, the program modules, or portions thereof, may be electronically stored on the storage. e.g. at the MNO 42 and/or within the communications devices.

In various non-limiting embodiments, the logical connections for the Wireless Access Point 330 with the associated Wireless Network 307, the Computer 337 typically includes a type of communications device such as the Mobile Client 105, VOIP Client 107 or any other type of communications device for establishing communications over the Wireless Network 307. In the Wireless Network 307 environment, the program modules or portions thereof may be electronically stored on storage at the Wireless Access Point 330 and/or within the communications devices.

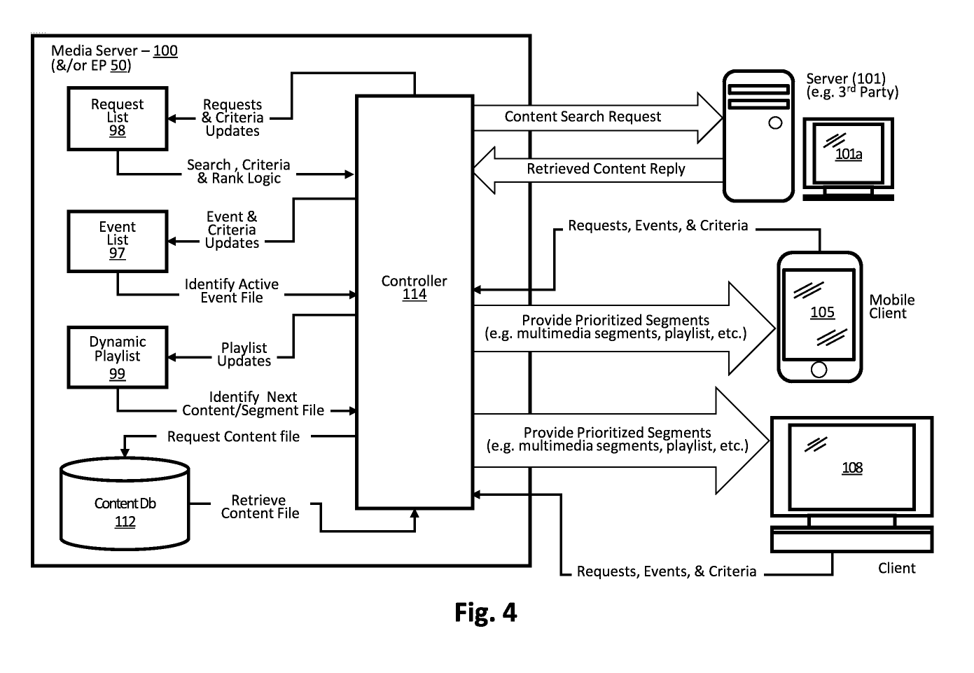

FIG. 4 depicts a schematic view of one embodiment, wherein the Media Server 100 is communicatively coupled to the third-Party Server 101a. In various non-limiting embodiments, the 3^{rd} Party Server 101a can both receive a “Content Search Request(s)” and send (e.g. transmit) a “Retrieved Content Reply” to the Media Server 100, say via a connection such as the Network 102, and/or the Internet 136 (FIGS. 1-3). In various non-limiting embodiments, the Media Server 100 can operate independently of the EP 50, in connection with the EP 50, and/or in place of the EP 50 (e.g. assuming the functionality of the EP 50.

In various non-limiting embodiments, the Media Server 100 would preferably be operationally coupled to a client (or a plurality of clients) via a network, such as the Internet 136; however, only two clients (e.g. Mobile Client 105 and Client 108) are shown for purposes of explanation. In various non-limiting embodiments, the Third-Party Server 101a would typically comprise a computer system maintained by an entity such as a media service and/or content provider. In various non-limiting embodiments, the client 108 comprises a system owned by a user capable of receiving media and/or content over a network, such as a personal computer (e.g. Desktop Client 108, FIG. 1). Alternatively, the Mobile Client 105 may be another device equipped to receive and play media and/or content, such as a cellular telephone (e.g. including analog and/or digital networks), smartphone, mobile device, or a personal digital assistant (PDA). As used herein, “network” and “computer network” connote any communications network over which electronic devices can send and/or receive electronic media/content (e.g. media items).

In various non-limiting embodiments, the Media Server 100 is adapted to transmit (e.g. send and/or receive) content, data, and/or media (e.g. push, pull, broadcast, stream, and/or the like) to multiple clients. To this end, the Media Server 100 comprises the Controller 114 that controls the functionality of the Media Server 100. In various non-limiting embodiments, the Media Server 100 further comprises a storage medium for electronically storing a Content Db 112, which comprises data, content, and media files utilized in transmitting content, data, and media. In various non-limiting embodiments, the Content Db 112 may be physically located in a storage device of the Media Server 100, or it may be located in storage devices remote from the Media Server 100, but communicatively coupled thereto. For example, the media server 100 may be coupled to the Content Db 112 over the Network 102 (see FIGS. 1-3), wherein the Media Server 100 retrieves media and/or content files from the Storage 109c over the Network 102 as the content, data, and/or media files are needed.

In various non-limiting embodiments, the Media Server 100 maintains the Request-List 98 that defines which logic, content, data and/or media is to be conditionally searched, acquired, sorted, sequenced, ranked, and/or the like. In various non-limiting embodiments, the Request-List 98 is preferably electronically stored in a Request-List 98 memory on the media server 100, e.g., in the media server's random access memory (RAM). As with the Content Db 112, the Request-List 98 may be stored in a remote memory location and accessed via a network connection.

In various non-limiting embodiments, the Media Server 100 similarly maintains the Event-List 97 that defines which logic, content, data, media and/or events are pending, completed, modified, removed, added, assigned, challenged, sorted, sequenced, ranked, and/or the like. In various non-limiting embodiments, this Event-List 97 is preferably electronically stored in the Event-List 97 memory on the Media Server 100, e.g., in the Media Server's RAM. As with the Request-List 98 and Content Db 112, the Event-List 97 may be stored in a remote memory location and accessed via a network connection.

In various non-limiting embodiments, the Media Server 100 similarly maintains the Dynamic Playlist 99 that defines which logic, content, data, and/or media are to be scheduled, sequenced, consumed, modified, removed, added, assigned, challenged, sorted, sequenced, ranked, shared, tracked, scored, and/or the like. In various non-limiting embodiments, the Dynamic-List 99 is preferably electronically stored in an Dynamic-List 97 memory on the Media Server 100, e.g., in the Media Server's RAM. As with the Request-List 98, the Event-List 97, and Content Db 112, the Dynamic Playlist 99 may be stored in a remote memory location and accessed via a network connection.

In various non-limiting embodiments, the Media Server 100 may search, intelligently crawl, monitor, pull, push, score, and/or the like, content, data, and/or media over the Network 102 to the clients and/or servers. In one embodiment, the Media Server 100 sends media and/or content files according to the Dynamic Playlist 99 to a specific network address (e.g., to an IP address, an Electronic Serial Number, Access Network Identifier, Automatic Number Identification, Mobile Equipment Identifier, GSM Cell ID, and/or the like) of the client (e.g. the Mobile Client 105 or the Client 108).

Using a combination of hardware and software, the Clients 108 receive the content, data, media, and/or the like, over the computer Network 102 (e.g. “Provide Prioritized Segments”) when conditions and rules call for the Media Server 100 to send specific media, content, data, and/or the like; when there is a specific request (e.g. by the Participant 46 “Requests, Events, * Criteria”) to, say initiate playback of the dynamic playlist; and/or when there is a specific request to pull the dynamic playlist and/or components, logic, and/or the like related to the latest dynamic playlist iterations. In this way, Clients 108 pull and/or push, playlists, content, media, data, logic, feedback, and/or like, in and/or out of the Media Server 100.

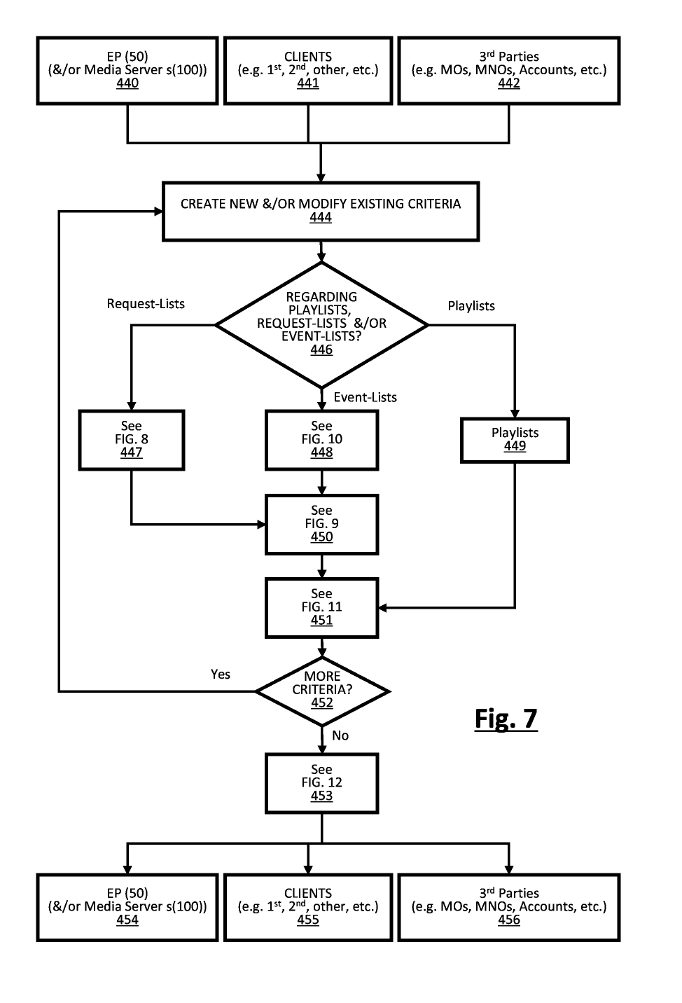

In addition to receiving media and/or content from the Media Server 100, individual Clients 108 can transmit specific media and/or content requests to the Media Server 100, while simultaneously receiving the content, media, logic, and/or data. In various non-limiting embodiments, the Controller 114 receives and processes each client's media and/or content request, as shown in the flowcharts of FIGS. 7, 8, 9, 10, and 11.

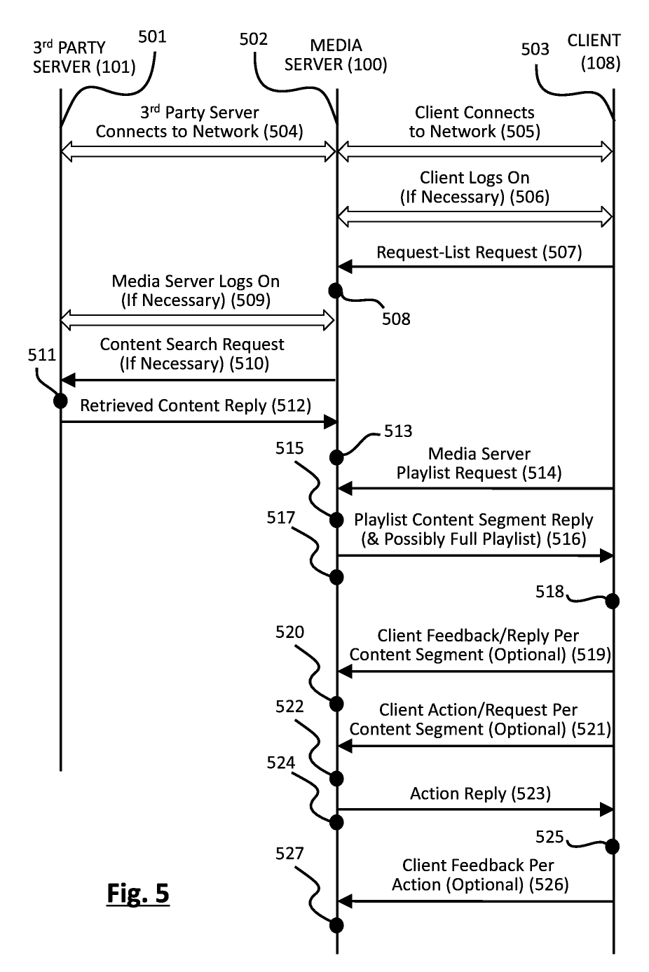

FIG. 5 depicts a call flow of an embodiment employing a 3^{rd} Party Server (501) connected to a Network with a Media Server (502) and a Client (503). Here, the 3^{rd} Party Server could be similar what was depicted in FIG. 4. In various non-limiting the third party Server and the Client could be interchangeable. Starting with the 3^{rd} Party Server 501, which is connected to the Network at 504 via a “3^{rd} Party Server Connects to Network”, which allows communications between the 3^{rd} Party Server and the Media Server, which may also be connected to a Client at 505 via a “Client Connects to Network”, which allows communications between the Media Server and the Client, where there could be a plurality of Clients. If necessary, the Client may log into Network 102 at 506 where a “Client Logs On (If Necessary)”.

At 507, the Client submits a “Request-List Request,” which is sent to the Media Server. In various non-limiting embodiments, the “Request-List Request” is processed by the Media Server at 508 and if necessary, the Media Sever logs into the appropriate 3^{rd} Party Server (where there could be a plurality of 3^{rd}-Party Servers) with a “Media Server Logs On (If Necessary)” at 509. In some instances, the “Request-List Request” 507 may already reside on the Media Server and in some cases it may need to transmit the request to one or more 3^{rd} Party Servers.

Next at 510, a “Content Search Request (If Necessary)” is transmitted to the 3^{rd} Party Server. In various non-limiting embodiments, the 3^{rd} Party Server(s) processes the Requests at 511 before sending a “Retrieved Content Reply” in step 512. In various non-limiting embodiments, the “Retrieved Content Reply” is processed by the Media Server at 513 and stored according to the current rules, instructions, and/or conditions. When a subsequent request is made by the Client to the Media Server in a “Media Server Playlist Request” step 514, the Media Server processes the Playlist Request incorporating the current conditions, data, content, rules, and the like at 515, before returning a “Playlist Content Segment Reply (& Possibly Full Playlist)” at 516 where, depending on the current conditions, data, content, rules, and the like; the Media Server may only send the Content Segment with the highest priority on the Client's Playlist back to the Client or may send additional elements, such as meta-tags, parts of the playlist, the full playlist, and the Content Segments according to the playlist and/or according to rules and conditions, such as the client's/user's device, time of day, network traffic, client's/user's typical usage patterns, client's/user's subscription plan, rules, fees paid, and/or the like.

In various non-limiting embodiments, the Media Server tracks what was requested, retrieved, sent and consumed by the Client at 517 and the Client's device (e.g. mobile device, computer, and/or the like) can either play the highest prioritized content segment on the playlist, or let the Client select what content segments to play and/or interact with (e.g. reading metadata, meta-tags, reviews, and/or the like) at 518. In addition, the Client can generate or reply with feedback at 519 with a “Client Feedback/Reply Per Content Segment (Optional),” which is collected, analyzed, and electronically stored in the Media Server at 520. Further, Client's actions/requests can also be sent to the Media Server via a “Client Action/Request Per Content Segment (Optional) at 521 where it is collected, analyzed, and electronically stored at 522.

If the Client sends an Action/Request to the Media Server, e.g. for more data, meta-data, another content segment, recommendation, recommendation-request, other user feedback, update, user input, criteria, and/or the like, then that request is sent via an “Action Reply” in step 523 to the Client. In various non-limiting embodiments, the Media Server tracks what was requested, retrieved, sent and consumed by the Client at 524. In various non-limiting embodiments, the Client usage of the playlist and related items (e.g. actions, requests, feedback, metadata, meta-tags, recommendations, and/or the like) where the Client/user can provide feedback per Action in a “Client Feedback Per Action (Optional)” step 526; which can track each interaction per moment in time, per device, per historical behavior and patterns, and/or other relative metrics to create and update data patterns that are collected, analyzed, and electronically stored in the Media Server at 527.

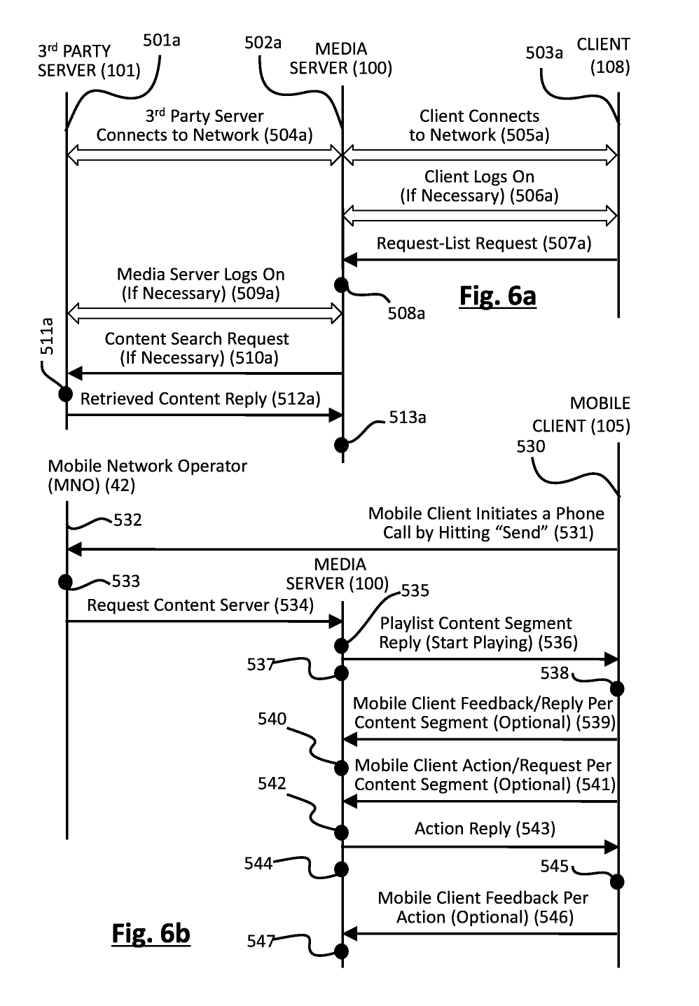

FIG. 6a depicts a call flow embodiment similar to FIG. 5, but where the Client could be either a computer or mobile device. Steps 501a through 513a in FIG. 6a function similarly to FIG. 5, where the Client making the “Request-List Request” in step 507 could be either a wired computer and/or a Mobile Client, such as wireless enabled device, smartphone, cellular telephone (e.g. including analog and/or digital networks), and/or the like.

FIG. 6b depicts a call flow embodiment similar to FIG. 6a, but specifically for the Mobile Client 530, performs a “Mobile Client Initiates a Phone Call by Hitting ‘Send’” at 531. These instructions are transmitted to a Mobile Network Operator (42) at 532. Next at 533, the Mobile Network Operator may decide to forward information and/or the call to the Media Server by sending a “Request Media Server” at 534. At 535 the Media Server processes the request and sends a “Playlist Content Segment Reply (Start Playing) in step 536 to the Mobile Client. In this embodiment the content (e.g. multimedia item) segment may be played and/or queued for the Mobile Client during the initial call setup process, for example, but could also be played, queued, and/or located at other designated moments, and/or location, such as during the termination side connection, during the call, following the call, and/or as the user/Client selects and/or designates. In various non-limiting embodiments, the content segment and/or playlist could be stored for future playback on the Media Server for sending and/or playing on a subsequent call made by the Mobile Client and/or sent and stored on the mobile device itself.

In various non-limiting embodiments, the Mobile Client can interact with the content segment at 538 and, in addition, generate a “Mobile Client Feedback/Reply Per Content Segment (Optional)” at 539. In various non-limiting embodiments, the Media Server tracks interactions and what was requested, retrieved, sent/transmitted, modified, skipped, deleted, and consumed by the Mobile Client at 540. In addition, the Mobile Client actions/requests can also be sent to the Media Server via a “Mobile Client Action/Request Per Content Segment (Optional)” at 541 where it is collected, analyzed, and electronically stored at 542.

If the Mobile Client 105 sends an Action/Request to the Media Server, e.g. for more data, meta-data, modification, another content segment, recommendation, recommendation-request, other user feedback, and/or the like, then that request is sent via an “Action Reply” at 543 to the Mobile Client. In various non-limiting embodiments, the Media Server tracks what was requested, retrieved, sent/transmitted, modified, skipped, deleted, reprioritized and consumed by the Mobile Client at 544. In various non-limiting embodiments, the Media Server tracks what was criteria was modified by the Mobile Client at 544.

In various non-limiting embodiments, the Mobile Client receives and can interact with the “Action Reply” and, in addition, the Mobile Client usage of the message segment played/queued, modified, skipped, deleted, and/or reprioritized and the same for the playlist, playlist criteria, and associated playlist container and related items (e.g. actions, requests, feedback, metadata, meta-tags, recommendations, and/or the like) generates additional Mobile Client/user data 545. Further, the Mobile Client/user can automatically, systematically, and/or user-selectively, provide feedback per Action in a “Mobile Client Feedback Per Action (Optional)” at 546, which can track each interaction per user, per moment in time, per device, per historical behavior and patterns, per location, and/or other relative metrics to create and update data patterns that are collected, analyzed, and electronically stored in the Media Server at 547.

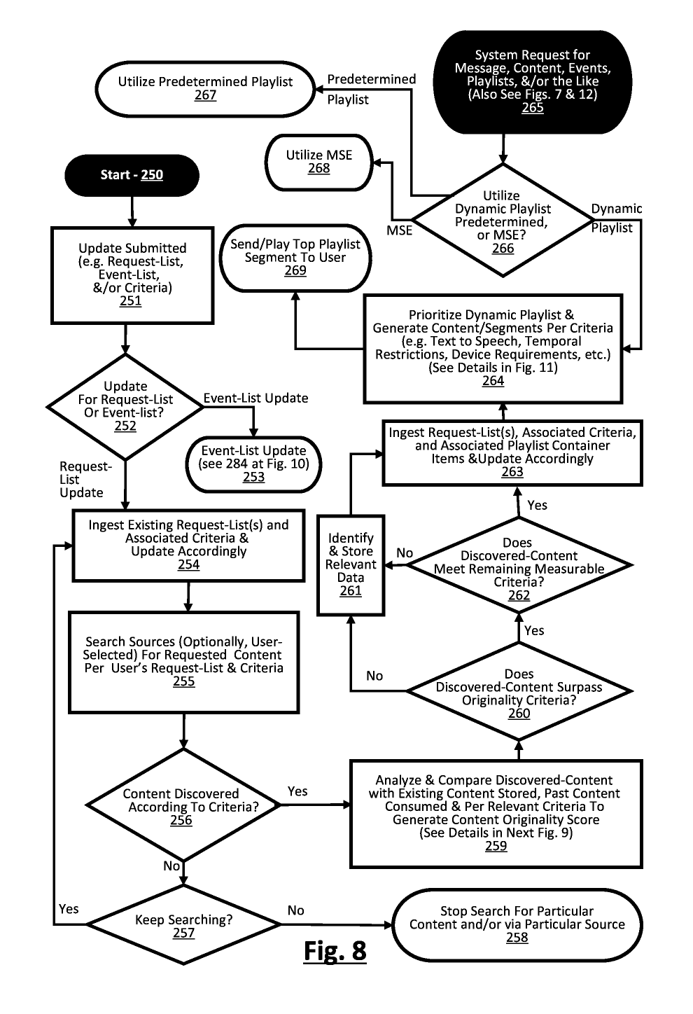

FIG. 7 is a flowchart of an embodiment depicting a relationship of FIGS. 8-12 following input from the EP 50 (and/or Media Servers), Clients, and 3^{rd} Parties for creating a new criteria and/or modifying an existing criteria. Starting with steps 440-442, where an “EP 50(50) (and/or Media Server (100))” 440, a one or more than “Clients (e.g. first, second, others, etc.)” 441, and a “3^{rd} Parties (e.g. MOs, MNOs, Accounts, etc.)” 442 then proceed to a step 444, where a “Create New and/or Modify Existing Criteria,” is executed.

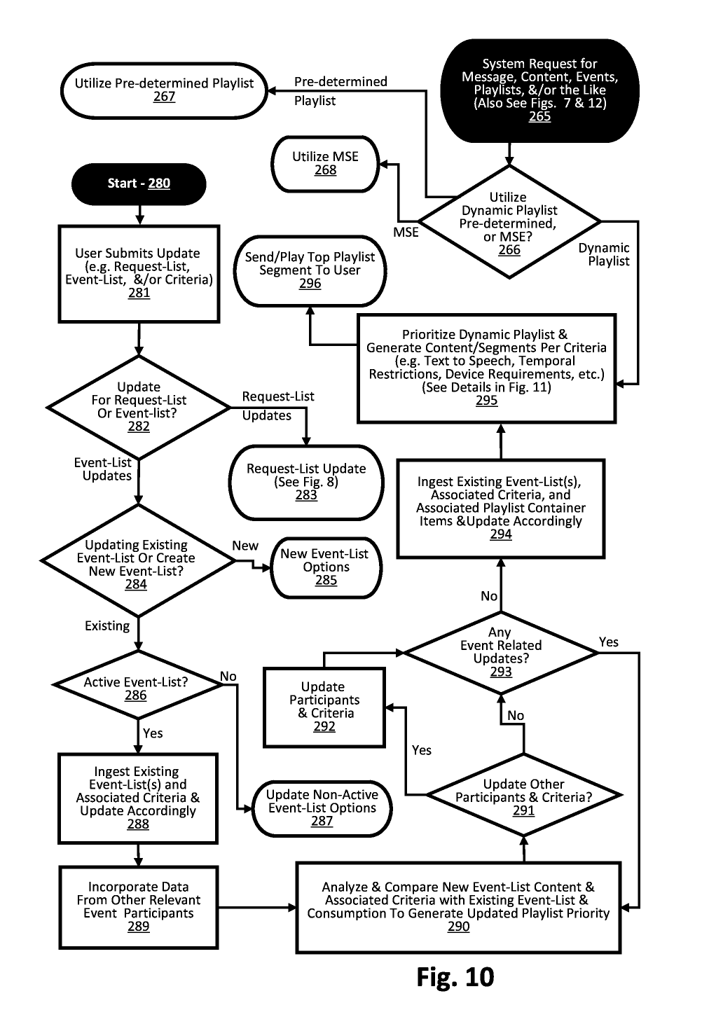

From step 444, the process proceeds to a query 446, which asks whether the Criteria is “Regarding Playlists, Request-Lists, and/or Event-Lists?” If the answer to query 446 is “Request-Lists” the process proceeds to a step 447 with a “See FIG. 8,” before proceeding to a step 450. If the answer to query 446, is instead “Event-Lists” then the process proceeds to a step 448 with a “See FIG. 10,” before proceeding to the Step 450, with a “See FIG. 10,” which then proceeds to a step 451.

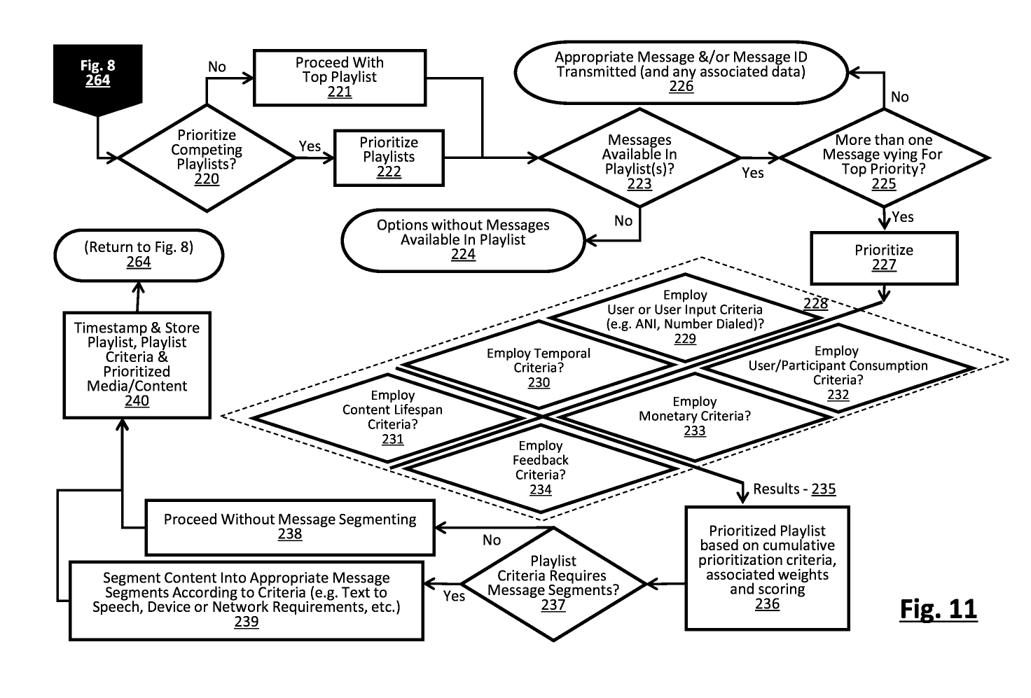

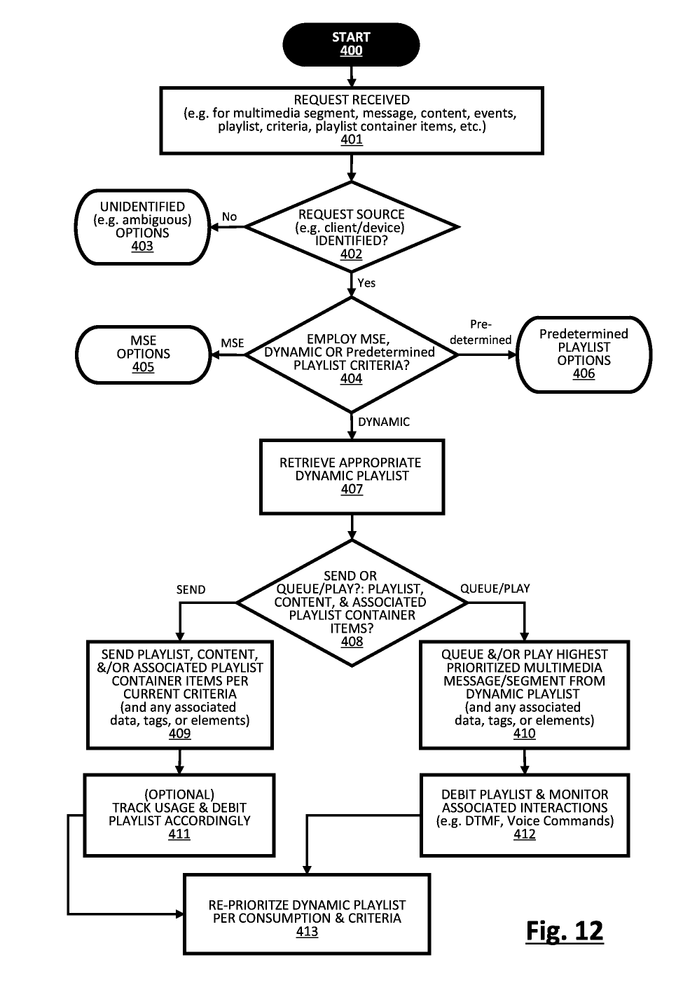

If the answer to query 446 is instead “Playlists,” then the process proceeds to the step 451, with a “See FIG. 11.” From step 451, the process proceeds to a query 452 which asks if there is “More Criteria?(e.g. to evaluate &/or for other list types).” If the answer to query 452 is “yes,” then the process loops back to step 444. If the answer to query 452 is instead “no,” then the process proceeds to a step 453, with a “See FIG. 12,” where the appropriate updates, modifications, and/or the like are then forwarded to the appropriate parties, in steps 454-456, to the “EP 50(50) (and/or Media Server (100))” 454, a one or more than “Clients (e.g. first, second, others, etc.)” 455, and the “3^{rd} Parties (e.g. MOs, MNOs, Accounts, etc.)” 456.

FIG. 8 depicts a flowchart of an embodiment of a request-list and criteria submission update by a particular user, where a search is performed and any discovered content is then prioritized within a dynamic playlist and typically, subsequently requested, retrieved, sent/transmitted, modified, skipped, deleted, consumed, queued, and/or played for the particular user. Starting with a terminal 250 followed by an “Update Submitted (e.g. Request-List, Event-List, &/or Criteria) 251” step where a submission is sent to the system (e.g. the Media Server 100). Additionally, the system evaluates the update submitted in step 251 in a query 252, to determine if it's an “Update For Request-List Or Event-List? If the answer to query 252 is for Event-List Update, then the update is passed to a terminal 253 for an “Event-List Update” depicted in a future figure (FIG. 10).

If the answer to query 252 is instead for a “Request-List Update,” then the update submitted is passed to a step 254, where the system performs an “Ingest Existing Request-List(s) and Associated Criteria & Update Accordingly,” in a step 255, which loads and evaluates the existing request-list data and criteria stored, in say a system database (or similar) when compared to the request-list submission from step 251 to update the associated data, rules, criteria and search instructions, accordingly.

If the updated data calls for (e.g. requests) a search, then the system performs a “Search Sources (Optionally, User-Selected) For Requested Content Per User's Request-List & Criteria,” where the sources searched can be user-selected and/or automatically, systematically, conditionally, and/or the like, searched per a system analysis of the request and an evaluation of likely content sources. For example, a request-list submission for NFL score updates may contain historical data on the system for similar searches and sources to either request data and/or an update from a particular sports feed or feeds and can request data, interrogate options (e.g. formats, peak vs off-peak fees, text only vs. graphics), and/or retrieve/receive an update from a particular RSS feed, and/or engage a bot, intelligent agent, Web-Crawler, or similar to crawl a particular source (e.g. a predefined source) say a sports website, URL, and/or database to request data, interrogate options (e.g. barter or bid for content), and/or retrieve/receive update, master content, metadata, and/or the like.

Further, the user may selectively choose specific content sources to search in addition to those evaluated as likely content sources, or in place of those evaluated and/or defaulted content sources. In addition, the user can place conditional rules or criteria on the search, the content, and/or the like by say placing restrictions on time, costs, size, relevance, accuracy, currency (e.g. how current), and/or the like on the search, content sources overall, and/or a particular content source and/or the like.

It should be appreciated by those skilled in the art that a search could employ other methodologies and/or other permutations of the search and source criteria, say between the system defaults, system evaluations, user criteria, and/or the like. Further, in various non-limiting embodiments, a search may not only be a one-way event where the system attempts to find content, but may also include data forwarded, cost per usage, cost per temporal window, metadata, meta-tags, costs, credits (e.g. author, photographer, videographer, newswire), links, and/or pushed to the system, say in the form of a news feed, RSS feed, twitter feed, and/or the like.

Next, a query 256 determines if any “Content Discovered [is] According To Criteria?” where the search has established rules, criteria, and instructions for meeting a threshold of fitness for the search results. If the answer to query 256 is “no” result, where the content discovered is determined to not meet the fitness threshold or criteria, then this “discovered-content” is passed to a query 257, where system evaluates the search data, rules, criteria, and instructions to determine if the system should “Keep Searching?” If the answer to query 257 is “yes,” then the system passes any necessary search data, rules, criteria, and instructions looping back to the step 254 to continue the process. If on the other hand, the answer to query 257 is “no,” then the system passes any necessary search data, rules, criteria, and instructions to a terminal 258 where a “Stop Search For Particular Content and/or via Particular Source” is performed.

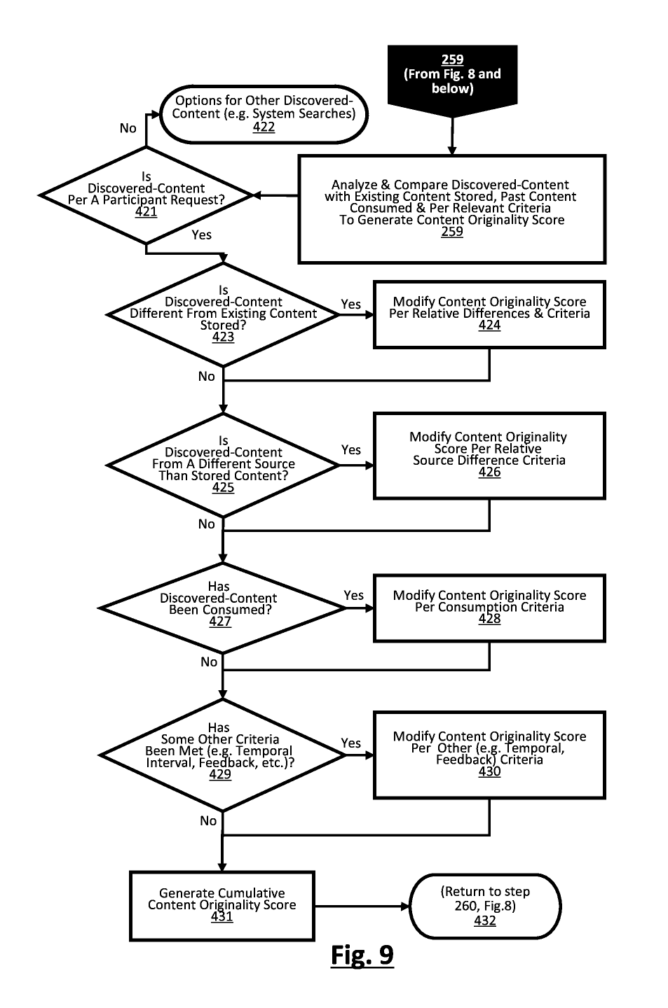

If the content discovered is determined to meet the fitness threshold or criteria, or returns a “yes” result, then this “discovered-content” is passed to a step 259, where system performs an “Analyze & Compare Discovered-Content with Existing Content Stored, Past Content Consumed, & Per Relevant Criteria To Generate Content Originality Score (See Details in Next FIG. 9)” 259. Here, the results are passed to a query 260, which asks “Does Discovered-Content Surpass Originality Criteria?” If the answer to query 260 is “no,” then the “discovered-content” is passed to a step 261, where the system performs an “Identify & Store Relevant Data” function.

Here in step 261, the system tracks, collects, evaluates, identifies, time stamps, and stores any data regarding the request-list search and the content-discovered, along with any associated rules, criteria, and instructions, and/or sources employed, to also evaluate the relative successfulness of each. From step 261, the data passed to a step 263. If the answer to query 260 is instead “yes,” then the “discovered-content” is passed to a query 262, which asks “Does Discovered-Content Meet Remaining Measurable Criteria?”

If the answer to query 262 is “no,” then the “discovered-content” is passed to the step 261, where the system performs the “Identify & Store Relevant Data” function. If the answer to query 262 is instead “yes,” then the “discovered-content” is passed to the step 263, which performs an “Ingest Request-List(s), Associated Criteria, and Associated Playlist Container Items & Update Accordingly,” where the system loads the existing request-list data and criteria stored and updates the request-list data with the content-discovered, along with any associated rules, criteria, and instructions and/or sources employed, say employed successfully, employed relatively successfully, employed unsuccessfully, and/or the like.

From step 263, the system passes the appropriate data to a step 264, where the system performs a “Prioritize Dynamic Playlist & Generate Content/Segments Per Criteria (e.g. Text to Speech, Temporal Restrictions, Device Requirements, etc.) (See Details in FIG. 11).” Here the system incorporated the discovered-content, along with any associated rules, criteria, and instructions to prioritize the content in the dynamic playlist.

For example, the request-list search may have been for any information regarding a weather report for tomorrow AM, where the “discovered-content” from the search has a conditional top priority for say a limited window of time, say until 8 am the following day. Where the next phone call made by this particular user before 8 AM tomorrow morning will play an audio message with the discovered-content to include the weather report for tomorrow AM and, assuming no other system/playlist requests, updates, system/playlist interruptions, and/or has a higher priority. For example, the system may have a rule to pre-empt the normal selection of the top prioritized playlist message when a particular condition exists, such as when the particular user's mobile phone minutes related to a prepaid billing plan drop below a certain threshold or a message from a particular predesignated friend or family member.

Turning back to discovered content, the particular user's dynamic playlist has the audio message with tomorrow morning's weather report prioritized at the top. Here the particular user may have set conditions to continually update the weather report until the message is actually heard, and/or where a subsequent call may, if a set of conditions are met, play another update for tomorrow's morning's weather, say where the projected temperature changes by “x” degrees and/or where the projected snow accumulation or rain precipitation changes by “y.” In addition, these weather reports can be for a city other than where the particular user is located, say for a destination he/she is traveling to tonight or tomorrow morning. Further, where the updates and priorities can conditionally change if another factor changes, e.g. an associated flight time or destination, interaction with a relevant calendar event or item on an event-list or similar.

Referring back to the flowchart of FIG. 8, a step 265 depicts a “System Request for Message, Content, Events, Playlists, and/or the like (Also See FIGS. 7 &12)” function in various non-limiting embodiments where, say the particular user has either requested a message manually via a user-interface input. In addition, the system request for the particular user may occur during a placed phone call. Further, the system request may occur via a 3^{rd} party system (e.g. 3^{rd} Party User, 3^{rd} Party System, and/or 3^{rd} Party Server) request for content, and/or the like.

As the placed phone call is initiated (e.g. see starting at 531, FIG. 6b), the audio message will generally be inserted in the call setup sequence. Back to FIG. 8, from step 265, next a query 266 asks if the system should “Utilize Dynamic Playlist, Predetermined Playlist, or MSE?” If the answer to the query is the “Predetermined Playlist,” then a Terminator 267 performs a “Utilize Predetermined Playlist,” where the system pulls and sends the appropriate data and content, say the highest prioritized content or content segment per existing rules and criteria and subsequently plays the audio message, along with any other associated content, data, actions, and/or the like.

If the answer to the query 266 is instead the “MSE” (as in the “Message Selection Engine,” see part 82, FIG. 2), then a Terminator 268 performs a “Utilize MSE,” where the system employs the Message Selection Engine to pull the data and content, say the highest prioritized content or content segment per existing rules and criteria and subsequently plays the audio message, along with any other associated content, data, actions, and/or the like. If the answer to the query is instead the “Dynamic Playlist”, then the step 264 with the “Prioritize Dynamic Playlist & Generate Content/Segments Per Criteria (e.g. Text to Speech, Temporal Restrictions, Device Requirements, etc.) (See Details in FIG. 11)” evaluates, and/or sends the highest prioritized content or content segment per existing rules and criteria, along with any other associated content, data, actions, and/or the like. From step 264, a Terminator 269 has a “Send/Play Top Playlist Segment To User,” where depending on whether request for a message was, say due to a phone call made, subsequent mobile client 105 request, a user request from a computer client, and/or the like, the pulled content segment is either played (e.g. in the pre-call setup sequence), queued, prioritized, and/or transmitted/sent and stored on the user's client computer (e.g. desktop, laptop, mobile device, smartphone, cellular phone and/or the like) and can be queued, modified, played on-demand, paused, rewound, fast-forwarded, downloaded, streamed, shared, segmented, reprioritized, and/or the like, as needed.

FIG. 9 depicts a flowchart of an embodiment of evaluating and generating a content originality score based on a variety of criteria and/or metrics. Starting with the step 259 (from FIG. 8) where the “Analyze & Compare Discovered-Content with Existing Content Stored, Past Content Consumed, & Per Relevant Criteria To Generate Content Originality Score” function is performed.

Next, a query 421 asks “Is Discovered-Content Per A Participant Request?” If the answer to query 421 is “No” then a Terminator 422 with an “Options for Other Discovered-Content (e.g. System Searches)” is performed. For example, Discovered-Content may not be based on a participant request, and may be a system generated and analyzed news feed, RSS feed, twitter feed, and/or the like that continually submits discovered-content, which could include system requested content, pushed-content, alerts, emergency information, and/or content feeds in-general.

If the answer to query 421 is instead “yes,” a next query 423 asks “Is Discovered-Content Different From Existing Content Stored?” where the system evaluates the discovered-content to determine if it is exactly the same or a relatively different, say in a character or number change, word spelling change, word structure change, author change, and/or the like. For example, the evaluation for what is exactly the same or a relatively different, say for a sporting event could incorporate conditions, metrics and criteria for temporal relevance (e.g. within an hour of the event/game starting/ending), team ahead changing, changes relative to a point spread or condition, and/or the like.

If the answer to query 423 is “yes,” a next step 424 performs a “Modify Content Originality Score Per Relative Differences & Criteria,” where the criteria may be to only update the dynamic playlist if the content changes by some particular threshold and/or for some particular element, say a number where the number is the score in event and/or per quarter. For instance, the criteria could be send any score change in a particular football game, but also send the score at the start and end of each quarter, even if it hasn't changed.

If the answer to query 423 is instead “no,” a next query 425 asks “Is Discovered-Content From A Different Source Than Stored Content?,” where the system evaluates the discovered-content to determine if it is from exactly the same or a relatively different content source, say where it could be the same sports website, but a different URL. If the answer to query 425 is “yes,” a next step 426 performs a “Modify Content Originality Score Per Relative Source Difference Criteria,” where the criteria may be to only update the dynamic playlist if the source change was from some particular source relatively perceived and/or measurably known to be more reliable to than the previously cited source for the discovered-content.

For instance, the discovered content could be “Celebrity X found guilty of Y” for content source A, and where the criteria could be to either conditionally append, annotate, modify, adjust, credit, and/or replace the existing discovered content, even though the “discovered-content” is exactly the same or relatively similar to existing content from a subsequent content search and source perceived to be relatively more or less reliable by a particular user, a group of users, a group of experts, family, friends, co-workers, the user who is requesting the information, and/or the like. For example, some may rank Fox News as a more reliable news source than say MSNBC, while others the reverse.

If the answer to query 425 is instead “no,” a next query 427 asks “Has Discovered-Content Been Consumed?,” where the system evaluates the discovered-content to determine if it has been wholly or partially consumed by, say previous request, viewing, listening, playing, interacting, and/or the like; and to what percentage consumed, what degree interacted, when, and/or the like. If the answer to query 427 is “yes,” a next step 428 performs a “Modify Content Originality Score Per Consumption Criteria.”

If the answer to query 427 is instead “no,” a next query 429 asks “Has Some Other Criteria Been Met (e.g. Temporal Interval, Feedback, etc.)?” where the system evaluates the search criteria to determine if it includes, say a criteria to send updates in time intervals, or say every hour, whether the data changes or not, say for a stock quote. Another example could be where the associated feedback from a group has passed a particular threshold, say where co-worker consensus are collecting the preferred times from the team meeting tomorrow at 3 pm or 4 pm, but where, say two more co-workers have chimed in as a group (e.g. say by conditionally quorum) and agreed on the proposed time of 3 pm tomorrow over, say other proposed times, and now there is a reached group consensus for 3 pm.

If the answer to query 429 is “yes,” a next step 430 performs a “Modify Content Originality Score Per Other (e.g. Temporal, Feedback, etc.) Criteria,” where the criteria may be to only update content and/or originality score if a certain period of time has elapsed or not elapsed. If the answer to query 429 is instead “no,” a next step 431 performs a “Generate Cumulative Content Originality Score,” where the system can incorporate historical data and/or user data to place weights, thresholds, rules, conditions, and/or the like to the cumulative score.

For example, the user may place a relatively higher value on the score of a particular event, the price reached for a particular stock, during a particular window of time, during a particular weather event, while driving to a particular location, while calling a particular circle of people, group, friend, party, and/or the like. From step 431, the flowchart routes back to FIG. 8 and step 260 in a terminator 432.

FIG. 10 depicts a flowchart of an embodiment of the event-list, criteria submissions, and retrievals. Starting with a step 280 and proceeding to a step 281 where a “User Submits Update (e.g. Request-List, Event-List, &/or Criteria),” followed by a query 282, which asks “Update For Request-List Or Event-list?” If the answer to query 282 is “Request-List Updates,” then a Terminator 283 with a “Request-List Update” is provided (see FIG. 8). If the answer to query 282 is instead “Event-List Updates,” then the process proceeds to a query 284, which asks whether to “Updating Existing Event-List Or Create New Event-List?”

If the answer to query 284 is “New,” then a Terminator 285 with a “New Event-List Options” is provided. If the answer to query 284 is instead “Existing,” then the process proceeds to a query 286, which asks if “Active Event-List?” If the answer to query 286 is “No,” then a Terminator 287 with an “Update Non-Active Event-List Options” is provided. If the answer to query 286 is instead “Yes,” then the process proceeds to a step 288, which invokes an “Ingest Existing Event-List(s) and Associated Criteria & Update Accordingly.”

Following step 288, the process proceeds to a step 289, which invokes an “Incorporate Data From Other Relevant Event Participants,” followed by a step 290, which invokes an “Analyze & Compare New Event-List Content & Associated Criteria with Existing Event-List & Consumption To Generate Updated Event List and Playlist Priority.”

Following the step 290 is a query 291 which asks whether to “Update Other Participants & Criteria?” If the answer to query 291 is “Yes,” the process proceeds to a step 292 with an “Update Participants & Criteria” is executed, before proceeding to a query 293. If the answer to query 291 is instead “No,” then the process proceeds to the query 293, which asks if “Any Event Related Updates?” If the answer to query 293 is “Yes,” then the process returns or loops back to the “Analyze & Compare New Event-List Content & Associated Criteria with Existing Event-List & Consumption To Generate Updated Event-List and Playlist Priority,” in step 290. If the answer to query 293 is instead “No,” then the process proceeds to a step 294, which invokes an “Ingest Existing Event-List(s), Associated Criteria, and Associated Playlist Container Items & Update Accordingly” function.

Next, the process precedes to a step 295, which invokes a “Prioritize Dynamic Playlist & Generate Content/Segments Per Criteria (e.g. Text to Speech, Temporal Restrictions, Device Requirements, etc.),” then (similar to step 269 in FIG. 8) the process ends with a Terminator 296 where a “Send/Play Top Playlist Segment To User” is executed. Referring to the Step 265 with the “System Request for Message, Content, Events, Playlists, and/or the like (Also See FIGS. 7 & 12),” the process proceeds to the query 266 with the Terminator 267 for the “Utilize Pre-determined Playlist” or the Terminator 268 with the “Utilize MSE,” If the answer to query 266 is the “Dynamic Playlist,” then the process proceeds to the step 295 (similar to the step 264 in FIG. 8).

FIG. 11 depicts a flowchart of an embodiment employing the dynamic playlist and associated prioritization before consumption (e.g. by a client/user/participant/device). Starting with step 264 from FIG. 8, the process proceeds to a query 220, which asks whether to “Prioritize Competing Playlists?” If the answer to the query 220 is “No,” then the process proceeds to a step 221 with a “Proceed With Top Playlist” before advancing to a query 223. If the answer to the query 220 is instead “Yes,” then the process proceeds to invoke a “Prioritize Playlists” in a step 222, before advancing to the same query 223, which asks if there are “Messages Available in Playlist?”

If the answer to query 223 is “No,” then the process proceeds to a Terminator 224 with an “Options without Messages Available In Playlist(s).” Here, in various non-limiting embodiments, the system analysis would preferably include incorporating conditionally predefined acceptable values comprising historical values, defaults values, ranges, thresholds, and/or the like, and/or methods for generating acceptable or suitable values, from say, existing data, similar defaults, and/or logic. In various non-limiting embodiments, a system generated value or default could require a condition, such as an approval or testing prior to being instituted.

In various non-limiting embodiments, the values that define each incorporated and associated threshold value, range start/end, and/or the like would preferably incorporate near-real-time, if not real-time, network intelligence to generate values dynamically. In various non-limiting embodiments, the generate values dynamically incorporate inputs comprising the user, artificial intelligence, machine learning, analysis, group consensus, conditions, and/or some combination or permutations of these.

If the answer to query 223 is instead “Yes,” then the process proceeds to a query 225, which asks if there is “More than one Message vying For Top Priority?” If the answer to query 225 is “No,” then the process proceeds to a Terminator 226 with an “Appropriate Message &/or Message ID Transmitted (and any associated data).” If the answer to query 225 is instead “Yes” then the process proceeds to a step 227, which invokes a “Prioritize,” for prioritizing any associated playlist container items, including audio messages in this example, but can comprise video, audio, music, messages, graphics, infographics, text, text to speech, speech to text, maps, presentation materials, content credits, alerts, code, instructions, criteria, rules, conditions, roles, permissions, permission per role, participants, groups, circles, analytics, historical data, metrics, previously stored playlist, previously stored events, previously stored requests, previously stored criteria, and/or the like.

From step 227, the process advances to an Option Pool 228, which in this example embodiment comprises an “Employ User or User Input Criteria (e.g. ANI, Number Dialed)?” Option 229, an “Employ Temporal Criteria?” Option 230, an “Employ Content Lifespan Criteria?” Option 231, an “Employ User/Participant Consumption Criteria?” Option 232, an “Employ Monetary Criteria?” Option 233, and/or an “Employ Feedback Criteria?” Option 234, where the collective Results 235 are passed to a step 236. This list of options (e.g. filtering methods and/or criteria) for prioritization may be preformed independently, sequently, in parallel, dynamically, conditionally, and/or user-selectively. The “Employ User or User Input Criteria (e.g. ANI, Number Dialed)?” Option 229 provides functionality to employ each “user-selectively,” “user-selection,” or similar referenced within the present disclosure. For example, user-selected friends or participants.

In various non-limiting embodiments, the “Employ Temporal Criteria?” Option 230 provides functionality to employ criteria relevant to time, say a specific moment in time; a conditional day; a specific day; a window of time; a range of time; a day; a date; a time-zone; a deadline; an extension; and/or any other temporal condition. The “Employ Content Lifespan Criteria?” Option 231 provides functionality to employ criteria relevant to a lifespan, say a content lifespan for a window of time. Further where the lifespan may include a specific format for a venue; a conditional association for a venue; a location; a score; an event; an inventory; a volume; a price; a device; a user, and/or a temporal condition.

In various non-limiting embodiments, the “Employ User/Participant Consumption Criteria?” Option 232 provides functionality to employ a content consumption criteria, and/or including, say a conditional percentage; a conditional quantity; a specific percentage; a specific quantity of consumption per a predefined list/bulk/group/volume; percentage or quantity of consumption per a predefined item/brand/vendor/product/source; percentage or quantity of consumption per a predefined whole/value; percentage or quantity of consumption per a predefined portion/segment; percentage or quantity of consumption per a predefined temporal element/predetermined criteria/value; and/or percentage or quantity of consumption per a predefined user.

In various non-limiting embodiments, the “Employ Monetary Criteria?” Option 233 provides functionality to employ criteria relevant to monetary criteria and/or including, say an exchange rate; an allowed foreign currency conversion; an exchange rate increase; an exchange rate decrease; an exchange rate freeze; an exchange rate unfreeze; an exchange rate change alert; an exchange rate change allowance; a fee allotment; a prize; and/or an economic condition.

In addition, in various non-limiting embodiments, there could be Budget Criteria provided and/or including, say a credit limit; a credit report; a credit request; a credit evaluation; a credit determination; a credit adjustment; a credit challenge; a credit increase; a credit decrease; a credit freeze; a credit unfreeze; a credit alert; credit; a credit alert; a credit per item; a credit per retailer, a budget per retailer, a budget per brand; a budget per product; a budget per brand; a budget per product; a credit per venue; a credit per location; a budget per venue; a budget per location; a credit per user; a budget per user, a budget allotment; a bid allotment; a free-item; a conditionally-free item; and/or a budget condition.

In various non-limiting embodiments, the “Employ Feedback Criteria?” Option 234 provides functionality to employ criteria relevant to a feedback criteria and/or including, say a specific format for a genre; a conditional association for a genre; a category, a meta-tag classification; a format; a distributor; a source; an author; an actor, a director, a singer, an artist; a photographer, a cinematographer, an inventor, a critic; a peer; an expert; a group, a circle, a family-member, a friend; a co-worker, a segment of participants/users/clients/device, an associate; a participation condition; a participation level; a consumption condition; and/or a consumption level.

In addition, in various non-limiting embodiments, the list of options (e.g. filtering methods and/or criteria) may also include a request list criteria, a source list criteria, an availability criteria, an originality criteria, an update criteria, and/or a previously stored prioritization criteria. In various non-limiting embodiments, the “request list criteria” may comprise a conditional genre; a specific genre; a category, a meta-tag classification; a format; a distributor; a source; an author, an actor, a director, a singer, an artist; a photographer, a cinematographer, an inventor, a critic; a peer, an expert; a family-member, a friend; a co-worker; an associate; a participation condition; a participation level; a consumption condition; and/or a consumption level. In various non-limiting embodiments, the “source list criteria” may comprise a conditional company; a specific company; a brand; a product; a website; a database; a data store; a government agency; a creditability score; a budget condition; a temporal condition; an existing participation condition; an existing participation level; an existing consumption condition; and/or an existing consumption level.

In various non-limiting embodiments, the “availability criteri” may comprise a conditional or specific format; venue; location; volume; in-stock; downloadable; stream-able; rentable; leasable; resalable; right-clearance; mechanic-rights; storage medium rights; other availability conditions; and/or some combination or permutation of these. In various non-limiting embodiments, the “originality criteria” and/or including, say a relative association with a conditional genre; a relative association with a specific genre; a category; a meta-tag classification; a format; a distributor, a source; an author, an actor, a director, a singer, an artist; a photographer, a cinematographer; an inventor, a critic; a peer, an expert; a family-member, a friend; a co-worker; an associate; a participation condition; a participation level; a consumption condition; a consumption level; a brand; a product; a service; a price; an inventory; an event; a location; a venue; a score; a stock quote; and/or a weather metric.

In various non-limiting embodiments, the “update criteria,” where the update may comprise a relative and/or conditional association with a conditional genre; a relative association with a specific genre; a category; a meta-tag classification; a format; a distributor, a source; an author; an actor; a director; a singer, an artist; a photographer, a cinematographer; an inventor, a critic; a peer; an expert; a family-member, a friend; a co-worker, an associate; a participation condition; a participation level; a consumption condition; a consumption level; a brand; a product; a service; a price; an inventory; an event; a location; a venue; a score; a stock quote; and/or a weather metric.

In various non-limiting embodiments, the “previously stored prioritization criteria” may comprise a relative association with a conditional or specific criteria. In addition, a relative or conditional association with a specific criteria or element of, say the budget criteria; the monetary criteria; the request-list criteria; the source-list criteria; the temporal criteria; the availability criteria; the consumption criteria; the user-input criteria; the lifespan criteria; the feedback criteria; the originality criteria; and/or the update criteria.

Back to the collective Results 235, which are passed to the step 236 and which then invokes a “Prioritized Playlist based on cumulative prioritization criteria, associated weights and scoring.” From step 236 the process proceeds to a query 237, which queries whether a “Playlist Criteria Requires Message Segments?” For example, where a particular message is, say too long, to play/hear the entire message all at once. If the answer to the query 237 is “No,” then the process proceeds to a step 238 where a “Proceed Without Message Segmenting” is invoked before proceeding to a step 240. If the answer to the query 237 is instead “Yes,” then a “Segment Content Into Appropriate Message Segments According to Criteria (e.g. Text to Speech, Device or Network Requirements, etc.)” is invoked before proceeding to the step 240, where a “Timestamp & Store Playlist, Playlist Criteria & Prioritized Media/Content” is invoked before “(Return to FIG. 8 Step 264).”

FIG. 12 depicts a flowchart of an embodiment of a dynamic-playlist request. Starting with a start step 400 and proceeding to a step 401 where a “Request Received (e.g. for multimedia segment, message, content, events, playlist, criteria, playlist container items, etc.),” followed by a query 402 which asks “Request Source (e.g. client/device) Identified?” If the answer to query 402 is “No,” then a Terminator 403 with an “Unidentified (e.g. ambiguous request) Options” is provided. Here, in various non-limiting embodiments, the system would preferably include analysis incorporating conditionally predefined acceptable values versus unacceptable and/or ambiguous values. In various non-limiting embodiments, the system could attempt to resolve an ambiguity with historical values, defaults values, ranges, thresholds, and/or the like, and/or methods for generating acceptable or suitable values, from say, existing data, similar defaults, and/or logic. In various non-limiting embodiments, a system generated value or default could require a condition, such as an approval or testing prior to being instituted.

In various non-limiting embodiments, the values that define each incorporated and associated threshold value, range start/end, and/or the like would preferably incorporate near-real-time, if not real-time, network intelligence to generate values dynamically. In various non-limiting embodiments, the generate values dynamically incorporate inputs comprising the user, artificial intelligence, machine learning, analysis, group consensus, conditions, and/or some combination or permutations of these.

If the answer to query 402 is instead “Yes,” then the process proceeds to a query 404, which asks whether to “Employ MSE, Dynamic Or Predetermined Playlist Criteria?” If the answer to query 404 is “MSE,” then a Terminator 405 with an “MSE Options” is provided. Here, the system employs the Message Selection Engine to pull the data and content, say the highest prioritized content or content segment per existing rules and criteria and subsequently plays the audio message, along with any other associated content, data, actions, and/or the like (e.g. also see part 82, FIG. 2).

If the answer to query 404 is instead “Predetermined,” then a Terminator 406 with an “Predetermined Playlist Options” is provided. If the answer to query 404 is instead “Dynamic,” then the process proceeds to a step 407 with a “Retrieve Appropriate Dynamic Playlist” is provided. From step 407, the process proceeds to a query 408, which asks whether to “Send Or Queue/Play?: Playlist, Content, & Associated Playlist Container Items?” If the answer to query 408 is “SEND,” then the process proceeds to a step 409 where the process invokes a “Send Playlist, Content, &/Or Associated Playlist Container Items Per Current Criteria (and any associated data, tags, or elements),” followed by a step 411 with an “(Optional) Track Usage & Debit Playlist Accordingly,” then followed by a step 413 where a “Re-Prioritize Dynamic Playlist Per Consumption & Criteria” is performed.

If the answer to query 408 is instead “Queue/Play,” then the process proceeds to a step 410 where the process invokes a “Queue &/Or Play Highest Prioritized (E.G. Top) Multimedia Message/Segment From Dynamic Playlist (and any associated data, tags, or elements),” followed by a step 412 with a “Debit Playlist & Monitor Associated Interactions (e.g. DTMF, Voice Commands),” then followed by the step 413 where the “Re-Prioritize Dynamic Playlist Per Consumption & Criteria” is performed.

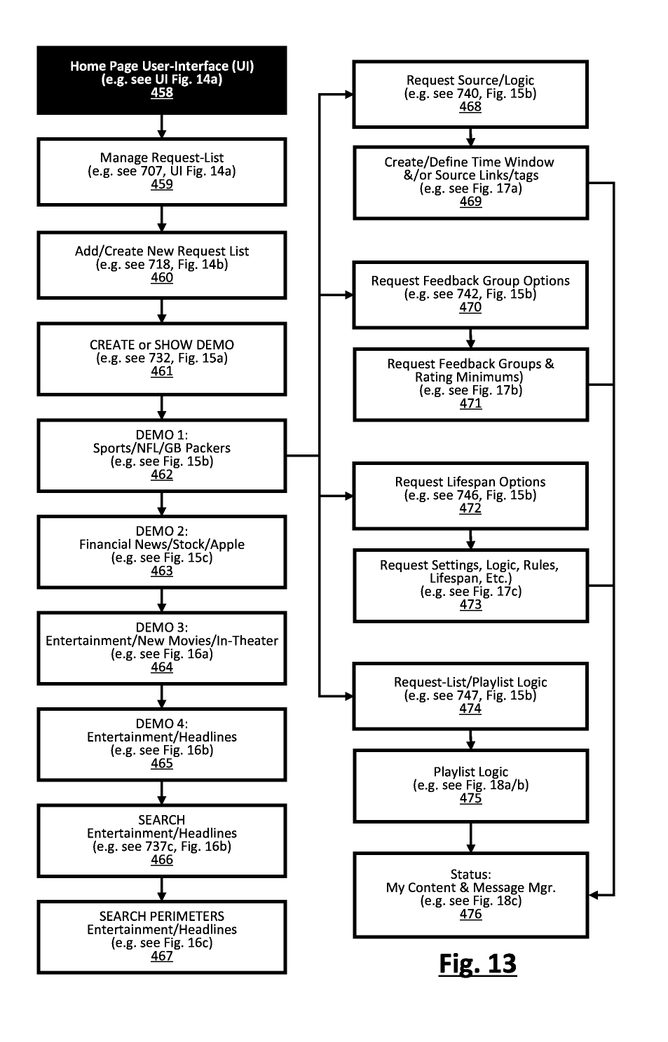

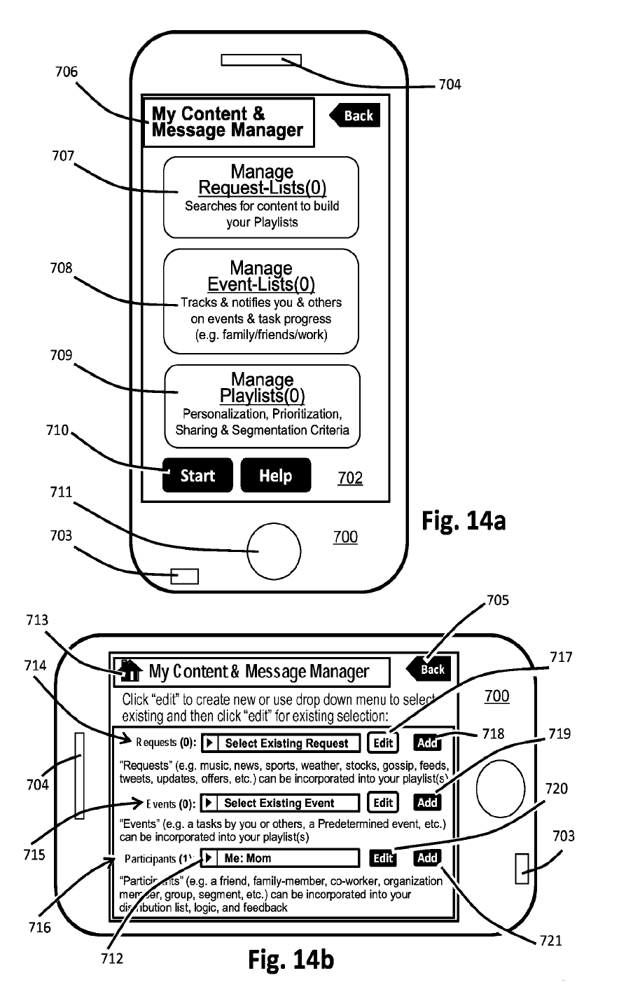

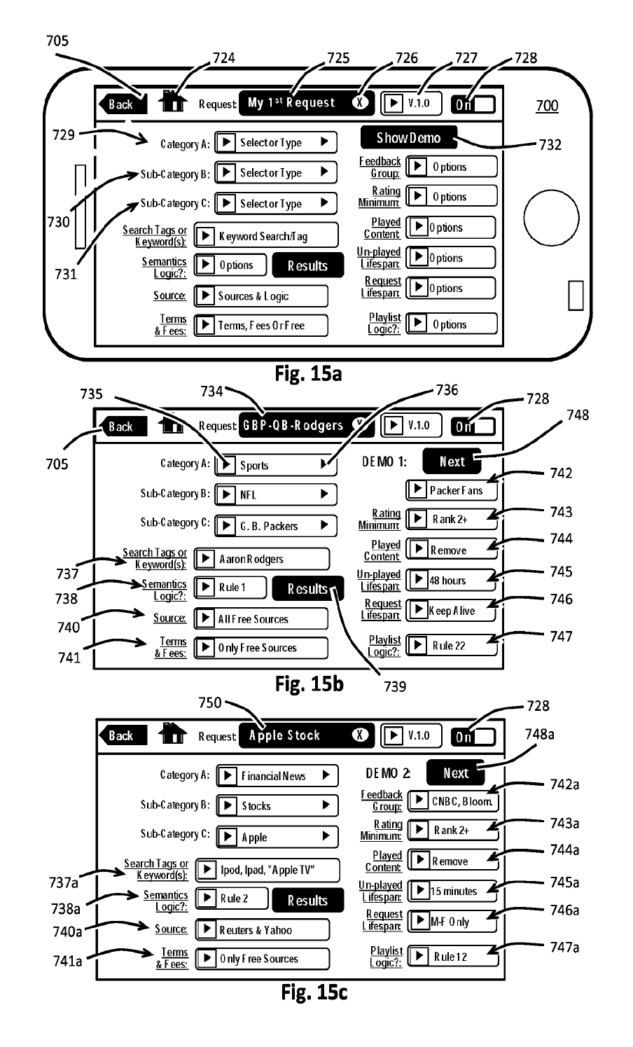

FIG. 13 is a flowchart of an embodiment depicting a relationship of UI Figs for managing Request lists. Starting with a step 458 with a “Home Page UI (e.g. see UI FIG. 14a), then proceeding to a step 459, with a “Manage Request-List (e.g. see 707, UI FIG. 14a).” Next, the process can proceed to a step 460 with an “Add/Create New Request List (e.g. see 718, FIG. 14b),” before proceeding to a step 461 with a “Create Or Show Demo (See 732, FIG. 15a),” where the UI provides methods to create a request-list, request list criteria, and/or show a demo.

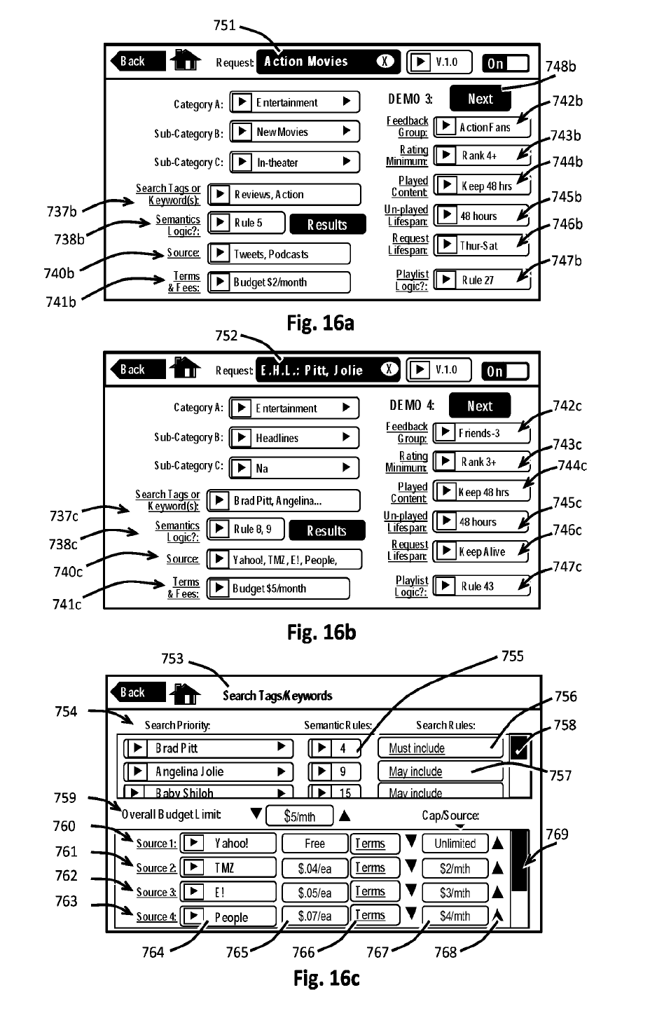

Pressing the “show demo,” the process then proceeds to a step 462 with a “Demo 1: Sports/NFIJGB Packers (See FIG. 15b).” The UI has a sequence of Demos, where the process can proceed to a step 463 with a “Demo 2: Financial News/Stock/Apple® (See FIG. 15c),” followed by a step 464 with a “Demo 3: Entertainment/New Movies/In-Theater (See FIG. 16a),” and followed by a step 465 with a “Demo 4: Entertainment/Headlines (See FIG. 16b).” Next, the process can proceed to a step 466 with a “SEARCH: Entertainment/Headlines (e.g. see 737c, FIG. 16b),” where the process can then proceeds to a step 467 with a “Search Perimeters: Entertainment/Headlines (e.g. see FIG. 16c).

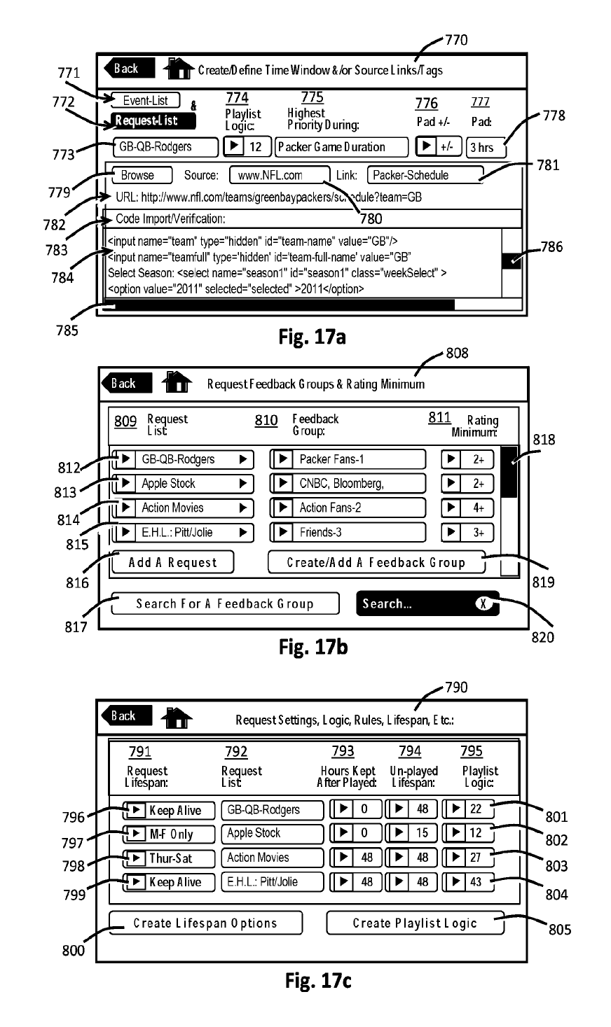

Back at Demo 1 in step 462 (and similar for Demos 2-4, steps 463-465), the UI can navigate and proceed to a step 468 with a “Request Source/Logic (e.g. see 740, FIG. 15b),” where the process can proceed to a step 469 with a “Create/Define Time Window &/or Source Links/tags (See FIG. 17a).” Also, back at Demo 1 in step 462 (and similar for Demos 2-4, steps 463-465), the UI can navigate and proceed to a step 470 with a “Request Feedback Group Options (e.g. see 742, FIG. 15b),” where the process can proceed to a step 471 with a “Request Feedback Groups & Rating Minimums) (See FIG. 17b).”

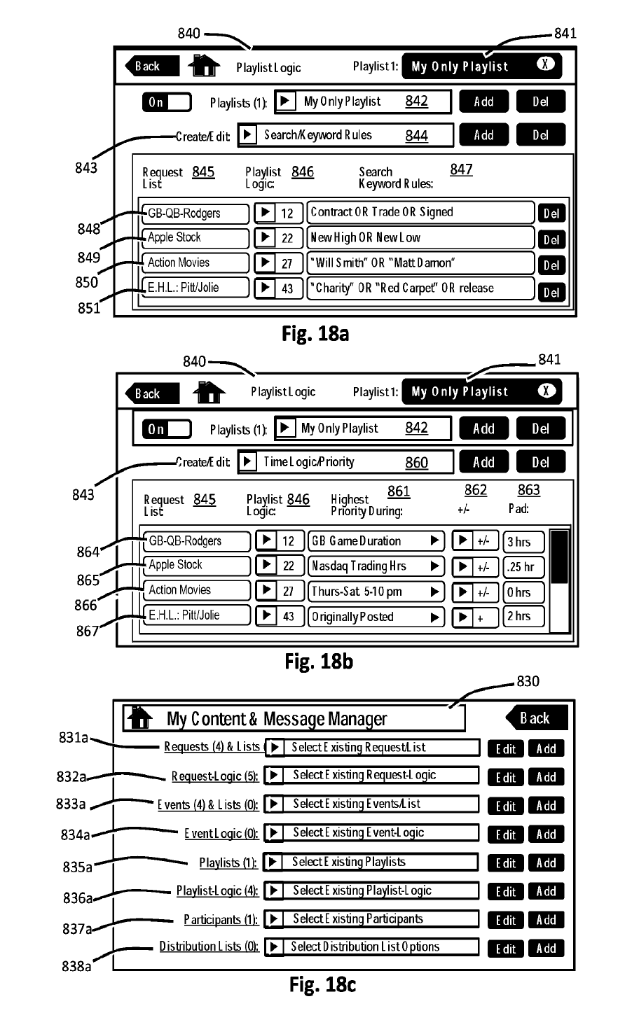

In addition, back at Demo 1 in step 462 (and similar for Demos 2-4, steps 463-465), the UI can navigate and proceed to a step 472 with a “Request Lifespan Options (e.g. see 746, FIG. 15b),” where the process can proceed to a step 473 with a “Request Settings, Logic, Rules, Lifespan, Etc.) (See FIG. 17c).” Last example back at Demo 1, in step 462 (and similar for Demos 2-4, steps 463-465), the UI can navigate and proceed to a step 474 with a “Request-List/Playlist Logic (e.g. see 747, FIG. 15b),” where the process can proceed to a step 475 with a “Playlist Logic (See FIG. 18a/b),” and followed by a step 476 with a “Status: My Content & Message Mgr. (e.g. see FIG. 18c).”

FIG. 14a illustrates a system 700 in an example implementation of the user interface in portrait mode in which the Participant/user 46 may create, modify, manage, and/or the like, content, data, feedback, logic, Request-List, Event-List, Playlists, and/or the like, in an embodiment. In various non-limiting embodiments, the illustrated system 700 depicts a plurality of functions 706, 707, 708, 709, 710, 711 that may be selected and utilized by the Participant/user 46 via a touch screen display 702 and the Participant/user's 46 finger. In various non-limiting embodiments, the Mobile Client 105 illustrated in FIG. 14a has a receiver 704 (e.g. a speaker), a microphone 703 (e.g. a mouthpiece), a home button 712, and may also have a dock connector, headset jack, camera, USB connector, SIM card tray, volume control, mute function, on/off switch, bluetooth connector/antenna, wifi connector/antenna, and/or the like. In various non-limiting embodiments, the Application Header 706, as illustrated, indicates “My Content & Message Manager,” where the Application Header 706 may change per the Participant/user's navigation and/or selected functionality, and where the system could create breadcrumbs of how nested he/she is within the application (not shown).

In various non-limiting embodiments, a “Manage Request-Lists” 707 function, as illustrated, indicates zero (0) Request-List created/existing, where the participant/user 46 may select this touchscreen button, which “searches for content to build your playlist” (and more) as depicted on the button. In various non-limiting embodiments, a “Manage Event-Lists” 708 function, as illustrated, indicates zero (0) Event-List created/existing, where the participant/user 46 may select this touchscreen button, which “Tracks and notifies you [the user] and others on events and task progress (e.g. family/friend/work)” (and more) as depicted on the button. In various non-limiting embodiments, a “Manage Playlists” 709 function as illustrated indicates zero (0) Playlist created/existing, where the participant/user 46 may select this touchscreen button which provides “Personalization, Prioritization, Sharing, & Segmentation Criteria” (and more) as depicted on the button. Pressing a 710 start button advances to UI depicted in FIG. 14b.

FIG. 14b illustrates the system 700 in an exemplary implementation of the user interface, now in landscape mode, where the Participant/user 46 has pressed the “start” 710 function in the previous FIG. 14a, in an embodiment. In various non-limiting embodiments, the Application Header has an application home icon 713 where the Participant/user 46 may press to revert to the previous home screen or he/she may use a “back” 705 function. Per the previous depiction on FIG. 14a, a Requests Section 714 is depicted at zero (0), where the Participant/user 46 may utilize an “Add” 718 function to add or create a Request, and where the illustration indicates “‘Requests’(e.g. music, news, sports, weather, stocks, gossip, feeds, tweets, updates, offers, etc.) can be incorporated into your playlist(s)” (and more) as depicted in the Requests Section 714. A drop-down field depicts “Select: Existing Request,” where the Participant/user 46 may select an existing Request from the Participant/user's history, from other Participants/users, and/or the like.

In various non-limiting embodiments, an Events Section 715 is depicted at zero (0), where the illustration indicates “‘Event’ (e.g. a tasks by you or others, a Predetermined event, etc.) can be incorporated into your playlist(s)” (and more) as depicted in the Events Section 715. Whereas a Participants Section 716 is depicted at one “(1)” and depicts “Me: Mom” in the drop-down field 712, where the Participant/user 46 may utilize an “Edit” 720 button/function to edit this input, or an “add” 721 button/function to add a particular participant, and where the illustration indicates “‘Participants’(e.g. a friend, family-member, co-worker, organization, member, group, segment, etc.) can be incorporated into your distribution list, logic, and feedback” (and more) as depicted in the Participant Section 716. In various non-limiting embodiments, the “Edit” 720 button/function has a reversed image (e.g. white text on a black background) to indicate that there is a particular participant currently selected, whereas an “Edit” 717 button/function has a white background to indicate that there currently is not a Request selected, in this example. “Add” 719 functions similar to 718 and 721, where the participant can create/add a new event list, event-list criteria and/or item to an associated event-list container (e.g. similar to an associated playlist container).

FIG. 15a illustrates the system 700 in an example implementation of the user interface in landscape mode in which the Participant/user 46 may create and/or modify a particular request, e.g. pressing button 707 back at FIG. 14a or pressing button 718 in FIG. 14b, in various non-limiting embodiments. Here, the participant can press the back 705 button to return to the previous navigation screen, press the home 724 button to return to the home screen, click a 725 field area to name or rename a particular request list and/or request list item. The participant can click the 726 button to delete the entry in the 725 field, the 727 field or associated drop down arrow to select a particular version (e.g. from an associated drop down option menu), say an earlier version and/or iteration of the particular Request listed in Field 725.

In various non-limiting embodiments, a 728 toggle function indicates that the Request listed in Field 725 is active or “On” versus inactive or “Off”. A Category A 729 field and associated drop down (e.g. with option menu) allows the participant to select the Category A from a list. Followed by a Sub-Category B and Sub-Category C. In various non-limiting embodiments, the Category A, Sub-Category B, Sub-Category C and so on, represent a hierarchy, where Category A is the highest level category. In various non-limiting embodiments, the Category A, Sub-Category B, Sub-Category C and so on, represent meta-tags with or without a hierarchy. A 732 button/function advances to a First Demo in a list of demos, or a Demo 1 in FIG. 15b.

FIG. 15b illustrates the system 700 in an example implementation of the user interface in which the Participant/user 46 has pressed the “Show Demo” 732 button/function in the previous FIG. 15a to advance to the Demo 1 for a particular Category A 735 example, here with Sports. In various non-limiting embodiments, the participant/user 46 may make the Request listed in a Field 734 active/inactive via the “on/off” toggle 728. A 735 Category A drop-down provides the ability to select another existing Category A, whereas a 736 button/function provides the ability to create a new Category A. Here in Demo 1, the demo has a “Search Tags or Keyword(s) 737 field and associated drop down (e.g. with option menu), where an “Aaron Rodgers” is currently depicted. This keyword could be by a global default, conditionally based upon previous usage by the participant, and/or based upon previous usage within a region, say the most selected keyword with a particular city, state, country, MNO, family plan, circle, group, and/or the like.

Next, a “Semantics Logic?” 738 field and associated drop down (e.g. with option menu) is where a “Rule 1” is currently depicted. The “Semantics Logic?” 738 field and associated drop down (e.g. with option menu) provides the participant the ability to select another rule and click a Results 739 button/function to see the results. For example, the semantics and logic associated with Rule 1 could incorporate searching for any data associated with the keyword “Aaron Rodgers” in the field 737 that is also associated with the Sub-Category C: “the Green Bay (GB) Packers®,” where for instance: “Green Bay Packers, GB Packers, the Pack, and Packers” are preset as applicable. Whereas, a different semantic rule, say a Rule 2, may not require any association with the Sub-Category C or any other category. Whereas another semantic rule, say a Rule 3, may not require the proper spelling of Aaron Rodgers and accept searches that include: “Aron Rodgers, Aaron Rogers, Arin Rodgers, Arin Rogers, Erin Rodgers, and Erin Rogers,” for example.

Whereas another semantic rule, say a Rule 4, may require a particular rating minimum per a particular group of people regarding relevant content associated with Aaron Rodgers before retrieving per the associated request. For example, the particular group could be a “Feedback Group” 742, where the associated field is depicted with a particular group: “Packer Fans.” Here, “Packer Fans” is a pre-established group, preferably where for example the content must meet a particular rating minimum, say a “Rating Minimum” 743 where the associated field is depicted with a “Rank 2+.” Here, Rule 4 could require that for a particular content to fit in the requested search, it must score at or above the “Rating Minimum” of “2” and per the specific Feedback Group of “Packer Fans.” The specific Feedback Group of “Packer Fans” may be a collection of participants, users, accounts, systems, and/or the like, where the Rating Minimum could be an average/means, median score, collectively and/or collaboratively score, or some other scoring methodology to produce a value, score, threshold and/or range for the predetermined rating minimum.

In various non-limiting embodiments, a Source 740 field and associated drop downs (e.g. with option menu) where a “All Free Sources” is currently depicted. Here, the Source 740 field and associated drop down (e.g. with option menu) provides the participant an ability to change the sources utilized in the request when searching for relevant content (e.g. multimedia segments, metadata, metatags, and/or the like). Further, a “Terms and Fees” 741 field and associated drop down (e.g. with option menu) is where a “Only Free Sources” is currently depicted. Here, the Terms and Fees 741 field and associated drop down (e.g. with option menu) provides the participant an ability to change the term and fees utilized in the request when searching for relevant content (e.g. multimedia segments, metadata, metatags, and/or the like).

In various non-limiting embodiments, a “Played Content” 744 field/rule and associated drop down (e.g. with option menu) where a “Remove” is currently depicted. Here, the “Remove” may be automatically, systematically, conditionally, and/or user-selectively set to remove any content associated with the particular Request listed in Field 734 after it has been consumed or “Played Content” Next, an “Unplayed Lifespan” 745 field/rule and associated drop down (e.g. with option menu) where a “48 Hours” is currently depicted. Here, the “48 Hours” may be automatically, systematically, conditionally, and/or user-selectively set to remove any content associated with the particular Request listed in Field 734, say from a playlist and/or associated playlist container, after it has been unconsumed for 48 hours or its “Unplayed Lifespan.”

Next, a “Request Lifespan” 746 field/rule and associated drop down (e.g. with option menu) where a “Keep Alive” is currently depicted. Here, the “Keep Alive” may be automatically, systematically, conditionally, and/or user-selectively set to monitor, track, source, interrogate, retrieve, update, select, and/or the like any content associated with the particular Request listed in Field 734, say for the content, playlist, and/or associated playlist container, after it has been turned on with the 728 on/off toggle button/function. Next, a “Playlist Logic” 747 field/rule and associated drop down (e.g. with option menu) where a “Rule 22” is currently depicted. Here, the “Rule 22” offers a range of options for automatically, systematically, conditionally, and/or user-selectively creating, establishing, adjusting and/or the like: what, where, how, when, who, and/or the like to monitor, track, source, interrogate, retrieve, update, select, and/or the like any content associated with the particular Request listed in Field 734, say for the content, playlist, and/or associated playlist container, after it has been turned on with the 728 on/off toggle button/function.

FIG. 15c illustrates the system 700 in an example implementation of the user interface in which the Participant/user 46 has pressed the “Next” 748 button/function in the previous FIG. 15b to advance to a Demo 2 for a Financial News Category A example, now a 748a button/function. In various non-limiting embodiments, the participant/user 46 may make the Request listed in a Field 750 active/inactive via the “on/off” toggle 728. The Category A drop-down provides the ability to select another existing Category A, here “Financial News” in Demo 2, the demo has a “Search Tags or Keyword(s) 737a field and associated drop down (e.g. with option menu), where an “Ipod, Ipad, ‘Apple TV’” is currently depicted. These keywords could be by a global default, conditionally based upon previous usage by the participant, and/or based upon previous usage within this Category A, Sub-Category B or C, say the most selected keyword with a particular Category A (e.g. Stocks), Sub-Category B or C, city, state, country, MNO, family plan, circle, group, and/or the like.

Next, a “Semantics Logic?” 738a field and associated drop down (e.g. with option menu) is where a “Rule 2” is currently depicted. The “Semantics Logic?” 738a field and associated drop down (e.g. with option menu) provides the participant the ability to select another rule and click the Results button/function to see the results. For example, the semantics and logic associated with Rule 2 could incorporate searching for any data associated with the keywords “Ipod®, Ipad®, Apple TV” in the field 737a collectively, independently, and/or the like; and perhaps also associated with the Sub-Category C: “Apple®,” where for instance: “Apple®” is determined to be as a Company and not a fruit, by say, searching for associated context and/or associated terms, such as Inc., data, products, and/or the like. Whereas, a different semantic rule, say an Apple® Stock Rule 3, may not require any association with the Sub-Category C or any other category.

Whereas another semantic rule, say an Apple® Stock Rule 4, may require a particular rating minimum per a particular group of people regarding relevant content associated with Apple® before retrieving per the associated request. For example, the particular group could be a “Feedback Group” 742a, where the associated field is depicted with a particular groups: “CNBC®, Bloomberg®” Here, “CNBC®, Bloomberg®” are pre-established groups, preferably where for example the content must meet a particular rating minimum, say a “Rating Minimum” 743a, where the associated field is depicted with a “Rank 2+.” Here, the Apple® Stock Rule 4 could require that for a particular content to fit in the requested search, it must score at or above the “Rating Minimum” of “2” and per the specific Feedback Groups of “CNBC®, Bloomberg®.” The specific Feedback Group of “CNBC®, Bloomberg®” may be a collection of groups, participants, users, accounts, systems, and/or the like, where the Rating Minimum could be an average/means, median score, collectively and/or collaboratively score, or some other scoring methodology to produce a value, score, threshold and/or range for the predetermined rating minimum.

In various non-limiting embodiments, a Source 740a field and associated drop downs (e.g. with option menu) where a “Reuters® & Yahoo®” is currently depicted. Here, the Source 740a field and associated drop down (e.g. with option menu) provides the participant an ability to change the sources utilized in the request when searching for relevant content (e.g. multimedia segments, metadata, metatags, and/or the like). Further, a “Terms and Fees” 741a field and associated drop down (e.g. with option menu) is where a “Only Free Sources” is currently depicted. Here, the Terms and Fees 741a field and associated drop down (e.g. with option menu) provides the participant an ability to change the term and fees utilized in the request when searching for relevant content (e.g. multimedia segments, metadata, metatags, and/or the like).

In various non-limiting embodiments, a “Played Content” 744a field/rule and associated drop down (e.g. with option menu) where a “Remove” is currently depicted. Here, the “Remove” may be automatically, systematically, conditionally, and/or user-selectively set to remove any content associated with the particular Request listed in Field 750 after it has been consumed or “Played Content” Next, an “Unplayed (e.g. unconsumed) Lifespan” 745 field/rule and associated drop down (e.g. with option menu) where a “15 minutes” is currently depicted. Here, the “15 minutes” may be automatically, systematically, conditionally, and/or user-selectively set to remove any content associated with the particular Request listed in Field 750, say from a playlist and/or associated playlist container, after it has been unconsumed for 15 minutes or its “Unplayed Lifespan.”

Next, a “Request Lifespan” 746a field/rule and associated drop down (e.g. with option menu) where a “M-F Only” is currently depicted. Here, the “M-F Only” may be automatically, systematically, conditionally, and/or user-selectively set to monitor, track, source, interrogate, retrieve, update, select, and/or the like any content associated with the particular Request listed in Field 750, say for the content, playlist, and/or associated playlist container, after it has been turned on with the 728 on/off toggle button/function. Next, a “Playlist Logic” 747 field/rule and associated drop down (e.g. with option menu) where a “Rule 12” is currently depicted. Here, the “Rule 12” offers a range of options for automatically, systematically, conditionally, and/or user-selectively creating, establishing, adjusting and/or the like: what, where, how, when, who, and/or the like to monitor, track, source, interrogate, retrieve, update, select, and/or the like any content associated with the particular Request listed in Field 750, say for the content, playlist, and/or associated playlist container, after it has been turned on with the 728 on/off toggle button/function.

FIG. 16a illustrates the system 700 in an example implementation of the user interface in which the Participant/user 46 has pressed the “Next” 748 button/function in the previous FIG. 15c to advance to a Demo 3 for an Entertainment Category A example, in an embodiment. In various non-limiting embodiments, the participant/user 46 may make the Request listed in a Field 751 active/inactive via the “on/off” toggle. The Category A drop-down provides the ability to select another existing Category A, here “Entertainment” in Demo 3, the demo has a “Search Tags or Keyword(s) 737b field and associated drop down (e.g. with option menu), where a “Reviews, Action” is currently depicted. These keywords could be by a global default, conditionally based upon previous usage by the participant, and/or based upon previous usage within this Category A, Sub-Category B or C, say the most selected keyword with a particular Category A, Sub-Category B or C, city, state, country, MNO, family plan, circle, group, and/or the like.

Next, a “Semantics Logic?” 738b field and associated drop down (e.g. with option menu) is where a “Rule 5” is currently depicted. The “Semantics Logic?” 738b field and associated drop down (e.g. with option menu) provides the participant the ability to select another rule and click the Results button/function to see the results. For example, the semantics and logic associated with Rule 5 could incorporate searching for any data associated with the keywords “Reviews, Action” in the field 737b collectively, independently, and/or the like; and perhaps also associated with the Sub-Category B: “New Movies,” where for instance: “New Movies” is determined in part by Sub-Category C: “In-theater”. Whereas, a different semantic rule, say an Rule 8, may not require any association with the Sub-Category B, C, or any other category.

Whereas another semantic rule, say a Rule 9, may require a particular rating minimum per a particular group of people regarding relevant content associated with “New Movies” that are currently “In-theater” within a particular region before retrieving per the associated request. In addition, there request can include a filter for a “Feedback Group” 742b, where the associated field is depicted with a particular group: “Action Fans.” Here, “Action Fans” can be a pre-established group of movie-enthusiasts, preferably where for example the content must meet a particular rating minimum, say a “Rating Minimum” 743b, where the associated field is depicted with a “Rank 4+.” Here, the Rule 9 could require that for a particular content to fit in the requested search, the New Movie must have scored at or above the “Rating Minimum” of “4,” say for a desire to see the movie and/or a rating for those that have seen the movie per the specific Feedback Groups of “Action Fans.” The specific Feedback Group of “Action Fans” may be a collection of move-enthusiasts, critics, friends, family, groups, participants, users, accounts, systems, and/or the like, where the Rating Minimum could be an average/means, median score, collectively and/or collaboratively score, or some other scoring methodology to produce a value, score, threshold and/or range for the predetermined rating minimum.

In various non-limiting embodiments, a Source 740b field and associated drop downs (e.g. with option menu) where a “Tweets, Podcasts” is currently depicted. Here, the Source 740b field and associated drop down (e.g. with option menu) provides the participant an ability to change the sources utilized in the request when searching for relevant content (e.g. multimedia segments, metadata, metatags, and/or the like). Further, a “Terms and Fees” 741b field and associated drop down (e.g. with option menu) is where a “Budget $2/month” is currently depicted. Here, the Terms and Fees 741b field and associated drop down (e.g. with option menu) provides the participant an ability to change the term and fees utilized in the request when searching for relevant content (e.g. multimedia segments, metadata, metatags, and/or the like). For example, the budget may be for the activity and/or for the content. Here, the “Budget $2/month,” could represent a budget for the content in a particular month, where the system would track the on-going expenditures for collected content/information for this particular request, a group of requests, and/or all requests, depending on the preset settings.

In various non-limiting embodiments, a “Played Content” 744b field/rule and associated drop down (e.g. with option menu) where a “Keep 48 Hours” is currently depicted. Here, the “Keep 48 Hours” may be automatically, systematically, conditionally, and/or user-selectively set to remove any content associated with the particular Request listed in Field 751 after it has been extended beyond the “Keep 48 Hours” perimeters, consumed or not.” Next, an “Unplayed Lifespan” 745 field/rule and associated drop down (e.g. with option menu) where a “48 Hours” is currently depicted. Here, the “48 Hours” may be automatically, systematically, conditionally, and/or user-selectively set to remove any content associated with the particular Request listed in Field 751, say from a playlist and/or associated playlist container, after it has been unconsumed for 48 Hours or its “Unplayed Lifespan.”

Next, a “Request Lifespan” 746b field/rule and associated drop down (e.g. with option menu) where a “Thur-Sat” is currently depicted. Here, the “Thur-Sat” may be automatically, systematically, conditionally, and/or user-selectively set to monitor, track, source, interrogate, retrieve, update, select, and/or the like any content associated with the particular Request listed in Field 751, say for the content, playlist, and/or associated playlist container, after it has been turned on with the on/off toggle button/function. Next, a “Playlist Logic” 747b field/rule and associated drop down (e.g. with option menu) where a “Rule 2T” is currently depicted. Here, the “Rule 2T” (similar to 747 and 747a) offers a range of options for automatically, systematically, conditionally, and/or user-selectively creating, establishing, adjusting and/or the like: what, where, how, when, who, and/or the like to monitor, track, source, interrogate, retrieve, update, select, and/or the like any content associated with the particular Request listed in Field 751, say for the content, playlist, and/or associated playlist container, after it has been turned on with the on/off toggle button/function.

FIG. 16b illustrates the system 700 in an example implementation of the user interface in which the Participant/user 46 has pressed the “Next” 748b button/function in the previous FIG. 16a to advance to a Demo 4 for another Entertainment Category A example, in an embodiment. In various non-limiting embodiments, the participant/user 46 may make the Request listed in a Field 752 active/inactive via the “on/off” toggle. The Category A drop-down provides the ability to select another existing Category A, here “Entertainment” in Demo 4, the demo has a “Search Tags or Keyword(s) 737c field and associated drop down (e.g. with option menu), where a “Brad Pitt, Angelina Jolie” is currently depicted. These keywords could be by a global default, conditionally based upon previous usage by the participant, and/or based upon previous usage within this Category A, Sub-Category B or C, say the most selected keyword with a particular Category A, Sub-Category B or C, city, state, country, MNO, family plan, circle, group, and/or the like.

Next, a “Semantics Logic?” 738c field and associated drop down (e.g. with option menu) is where a “Rule 8, 9” is currently depicted. The “Semantics Logic?” 738c field and associated drop down (e.g. with option menu) provides the participant the ability to select another rule and click the Results button/function to see the results. For example, the semantics and logic associated with Rule 8 could be combined with the Rule 9 when searching for any data associated with the keywords “Brad Pitt, Angelina Jolie” in the field 737c collectively, independently, and/or the like; and perhaps also associated with the Sub-Category B: “Headlines.” For instance: Rule 8 could be for search “Brad Pitt” and Rule 9 could be for searching “Angelina Jolie.” Whereas, a different pair of semantic rules, say a Rule 11 and Rule 12, may not require any association with the Sub-Category B, C, or any other category.

Whereas another semantic rule, say a Rule 13, may require a particular rating minimum per a particular group of people regarding relevant content associated with “Entertainment/Headlines” with a “Feedback Group” 742c, where the associated field is depicted with a particular group: “Friends-3.” Here, “Friends-3” can be a pre-established group of friends, preferably where for example the content must meet a particular rating minimum, say a “Rating Minimum” 743c, where the associated field is depicted with a “Rank 3+.” Here, the Rule 13 could require that for a particular content to match and/or fit within the requested search, the New Movie must have scored at or above the “Rating Minimum” of “3,” say for a desire to collect content with a rating from those Feedback Group: Friends-3 that have consumed the content. The specific Feedback Group of “Friends-3” may be a collection of friends, family, groups, participants, users, accounts, systems, and/or the like, where the Rating Minimum could be an average/means, median score, collectively and/or collaboratively score, or some other scoring methodology to produce a value, score, threshold and/or range for the predetermined rating minimum.

In various non-limiting embodiments, a Source 740c field and associated drop downs (e.g. with option menu) where a “Yahoo!®, TMZ®, E!®, People®” is currently depicted. Here, the Source 740c field and associated drop down (e.g. with option menu) provides the participant an ability to change the sources utilized in the request when searching for relevant content (e.g. multimedia segments, metadata, metatags, and/or the like). Further, a “Terms and Fees” 741c field and associated drop down (e.g. with option menu) is where a “Budget $5/month” is currently depicted. Here, the Terms and Fees 741b field and associated drop down (e.g. with option menu) provides the participant an ability to change the term and fees utilized in the request when searching for relevant content (e.g. multimedia segments, metadata, metatags, and/or the like). For example, the budget may be for the activity and/or for the content. Here, the “Budget $5/month,” could represent a budget for the content in a particular month, where the system would track the on-going expenditures for collected content/information for this particular request, a group of requests, and/or all requests, depending on the preset settings.

In various non-limiting embodiments, a “Played Content” 744c field/rule and associated drop down (e.g. with option menu) where a “Keep 48 Hours” is currently depicted. Here, the “Keep 48 Hours” may be automatically, systematically, conditionally, and/or user-selectively set to remove any content associated with the particular Request listed in Field 752 after it has been extended beyond the “Keep 48 Hours” perimeters, consumed or not.” Next, an “Unplayed Lifespan” 745 field/rule and associated drop down (e.g. with option menu) where a “48 Hours” is currently depicted. Here, the “48 Hours” may be automatically, systematically, conditionally, and/or user-selectively set to remove any content associated with the particular Request listed in Field 752, say from a playlist and/or associated playlist container, after it has been unconsumed for 48 Hours or its “Unplayed Lifespan.”

Next, a “Request Lifespan” 746c field/rule and associated drop down (e.g. with option menu) where a “Keep Alive” is currently depicted. Here, the “Keep Alive” may be automatically, systematically, conditionally, and/or user-selectively set to monitor, track, source, interrogate, retrieve, update, select, and/or the like any content associated with the particular Request listed in Field 752, say for the content, playlist, and/or associated playlist container, after it has been turned on with the on/off toggle button/function. Next, a “Playlist Logic” 747c field/rule and associated drop down (e.g. with option menu) where a “Rule 43” is currently depicted. Here, the “Rule 43” (similar to 747, 747a, and 747b) offers a range of options for automatically, systematically, conditionally, and/or user-selectively creating, establishing, adjusting and/or the like: what, where, how, when, who, and/or the like to monitor, track, source, interrogate, retrieve, update, select, and/or the like any content associated with the particular Request listed in Field 752, say for the content, playlist, and/or associated playlist container, after it has been turned on with the on/off toggle button/function.

FIG. 16c illustrates the system 700 in an example implementation of the user interface in which the Participant/user 46 has pressed the “Search Tags or Keyword(s)” 737c button/function in the previous FIG. 16b (or similarly with 737, 737a, 737b) to advance to an Application Header 753 which depicts “Search Tags/Keywords,” in various non-limiting embodiments. Here, a “Search Priority.” 754 area provides the functionality to set rules under a Semantic Rules column, for example with a 755 drop down field. A Search Rules column provides a 756 field, where a “Must include” is depicted, whereas a “May include” is depicted in a 757 field. A scroll thumb 758 provides an ability to scroll down for additional settings, functionality, visibility, and/or the like.

An “Overall Budget Limit.” 759 field currently has a “5/mth” depicted. A “Source 1:” 760 Row, where the Source 1 has drop downs and fields, depicted here as “Yahoo!®, Free, Terms, Unlimited.” Here, the “unlimited” falls under a “Cap/Source” column for capping the budget per Source and per the terms. In this example, Source 1 is followed by a Source 2, a Source 3, and a Source 4, where TMZ® is depicted with a budget of $0.04 per each content retrieved. Here, the content (e.g. the multimedia segment) could be defined by a set number of words, text, images, video, photos, dates, posting, and/or the like. A “2/month depicted in the row 761 is for setting the Cap/source, here TMZ®. The “Terms” can add additional terms, conditions, rules, and/or the like. A scroll thumb 769 provides an ability to scroll down for additional settings, functionality, visibility, and/or the like.

FIG. 17a illustrates the system 700 in an example implementation of the user interface in which the Participant/user 46 has pressed the “Playlist Logic” 747 button/function back in the previous FIG. 15b to advance to a “Create/Define Time Window and/or Source Links/Tags” page/functionality, in various non-limiting embodiments. Here a Request-List 772 button/functionality is selected versus an Event-List 771 button/functionality, where an applicable 770 header has a “Create/Define Time Window and/or Source Links/Tags” appears at the top. A 773 field is depicted with a “GB-QB-Rodgers,” which has a “Playlist Logic” of “12” from under a column 774, a “Highest Priority Duration” depicted here with a “Packer Game Duration” under a column 775, a Pad depicted here with a “plus/minus (+/−)” in a column 776, and a Pad depicted here as “4 hours” in a column 777, in a field 778. Here, in this example, the Request for information from a particular source is limited to the duration of the “Packer Game Duration” plus or minus 3 hours before the game kickoff and 3 hours after the conclusion.

In various non-limiting embodiments, a Source field 780 depicted with a “www.nfl.com” represents a selected source via a Browse 773 function, where further limitations and/or filter can incorporate a Link 781, depicted here with a “Packer-schedule,” and a URL 782, depicted here with a “URL: httpJwww.nfl.com/teams/greenbaypackers/schedule?team=GB,” where the system can track this URL, and make suitable adjustments, say when the link changes. For instance, between teams, where a player gets traded, and/or between years. A Code Import/Verification 783 provide a scrollable window 784 with a vertical scroll thumb 786 and a horizontal scroll thumb 785. Here, a participant can view code imported to verify and/or observe whether the selected source and request criteria will likely produce a result desired.

FIG. 17b illustrates the system 700 in an example implementation of the user interface in which the Participant/user 46 has a “Request Feedback Groups and Rating Minimum” page/functionality for the Request List, in various non-limiting embodiments. Here a drop down field 812 depicts a “GB-QB-Rodgers” appears under a “Request List” 809 column. Next, a “Feedback Group” 810 column depicts a “Packer Fans-1” in the 812 row, followed by a drop down field depicted by a “2+“under a “Rating minimum” 811 column. The 812 row is followed by a 813 row depicted with an “Apple® Stock,” followed by a 814 row depicted by an “Action Movies”, followed by a 815 row depicted with an “E.H.L (Entertainment/Headlines): Pitt/Jolie.” In various non-limiting embodiments, the order of rows (e.g. 812, 813, 814, 815, 816, and 817) can further prioritize content collected for a playlist.

In various non-limiting embodiments, an “Add A Request” 816 button/function provides the ability to add a request to the list and a “Create/Add A Feedback Group” 819 button/function provides the ability to create/add a feedback group to the list. A “Search For A Feedback Group” 817 button/function provides the ability to search for a feedback group from an existing list of Feedback Groups. In various non-limiting embodiments, the “Search For A Feedback Group” can be filter to existing Feedback Groups per a particular participant, user, device, group, category, region, MNO, city, state, country, and/or the like. A Search 820 provides the ability to perform the search per the perimeters listed, and/or a user-defined search.

FIG. 17c illustrates the system 700 in an example implementation of the user interface in which the Participant/user 46 has a “Request Settings, Logic, Rules, Lifespan, Etc.” page/functionality for the Request List, in various non-limiting embodiments. Here a row/drop down field 796 depicts a “Keep Alive” under a “Request Lifespan” 791 column. Next, a “Request List” 792 column depicts a ““GB-QB-Rodgers”” in the 796 row, followed by a drop down field depicted by a “0” under a “Hours Kept After Played” 793 column. Column 793 is followed by a “Un-played Lifespan” 794 column depicted with a “48,” followed by a “Playlist Logic” 795 column, depicted in the 796 row with a “22” in a field 801. The 796 row is followed by a 797 row/drop down field depicted with a “M-F Only,” followed by a 798 row/drop down field depicted by a “Thur-Sat”, followed by a 799 row/drop down field depicted with a “Keep Alive.”

In various non-limiting embodiments, the order of rows (e.g. 796, 797, 798, 799, and 800) can further prioritize content collected for a playlist. In various non-limiting embodiments, a “Create Lifespan Options” 800 button/function provides the ability to add a lifespan option to the list and a “Create Playlist Logic” 805 button/function provides the ability to create/add a playlist logic and/or criteria to the system, the participant's criteria list and/or the like.

FIG. 18a illustrates the system 700 in an example implementation of the user interface in which the Participant/user 46 has pressed the “edit” button/function in the previous FIG. 18a next to Playlists to advance to “My Only Playlist,” with the Request List and associated Playlist Logic incorporating Search/Keyword Rules via a drop-down selection 843 option, in various non-limiting embodiments.

FIG. 18b illustrates the system 700 in an example implementation of the user interface in which the Participant/user 46 has selected the drop-down selection 843 option for Time Logic/Priority, in various non-limiting embodiments.

FIG. 18c illustrates the system 700 in an example implementation of the user interface in which the Participant/user 46 has an overall view from a “My Content and Message Manager” page/functionality, in various non-limiting embodiments.

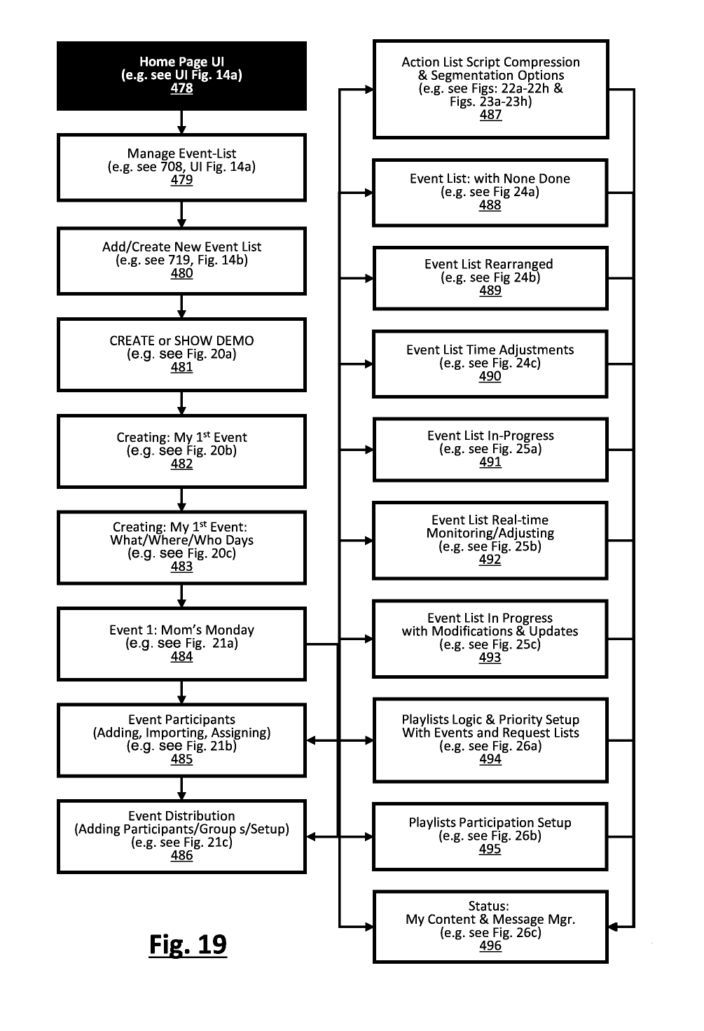

FIG. 19 is a flowchart of an embodiment depicting a relationship of UI Figs for managing Event Lists. Starting with a step 478 with a “Home Page UI (e.g. see UI FIG. 14a),” then proceeding to a step 479 with a “Manage Event-List (e.g. see 708, UI FIG. 14a),” followed by a step 480 with a “Add/Create New Event List (e.g. see 719, FIG. 14b).”

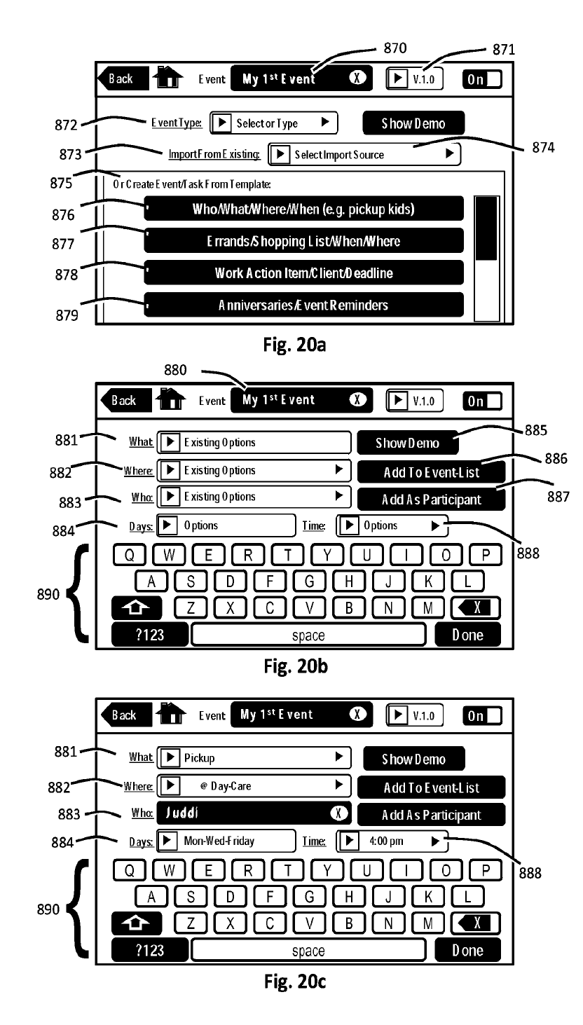

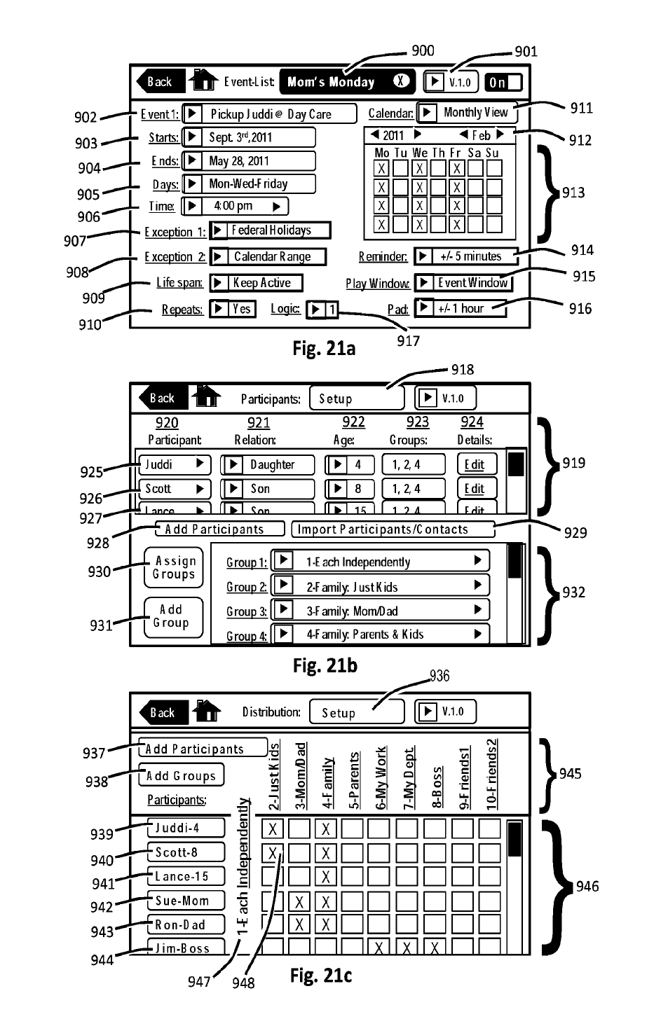

Next, from step 480 (similar to FIG. 13) comes a step 481 with a “Create or Show Demo (FIG. 20a),” where the process can then proceed to a step 482 with a “Creating: My 1^{st} Event (See FIG. 20b),” where the process can then proceed to a step 483 with a “Creating: My 1^{st} Event” What/Where/Who Days (See FIG. 20c).” From step 483, the process can then proceed to a step 484 with a “Event 1: Mom's Monday (See FIG. 21a),” where the process can then proceed to a step 485 with a “Event Participants (Adding, Importing, Assigning) (See FIG. 21b).” Next, from step 485, the process can then proceed to a step 486 with a “Event Distribution (Adding Participants/Groups/Setup) (e.g. see FIG. 21c).”

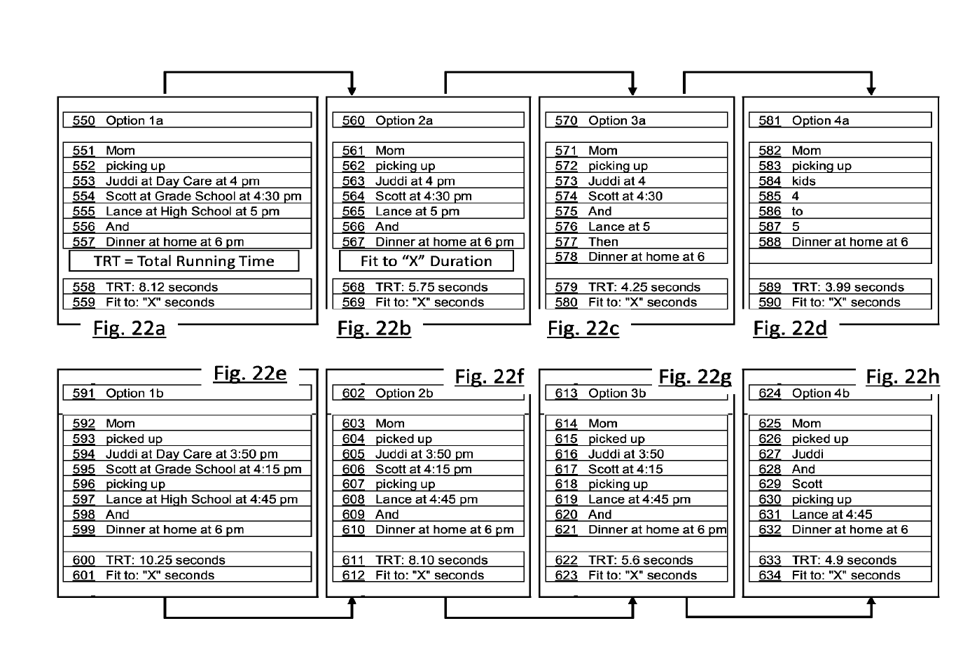

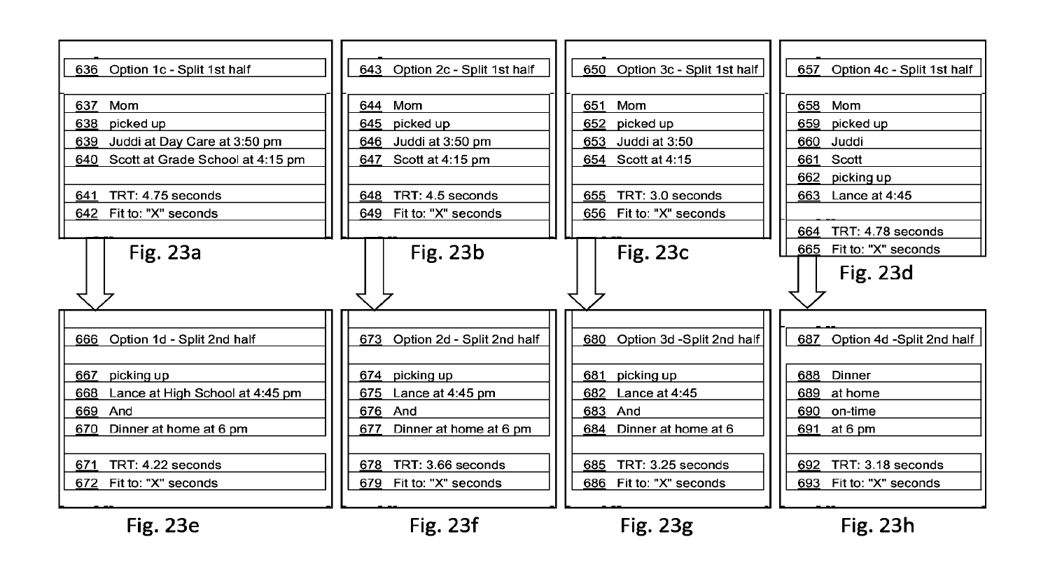

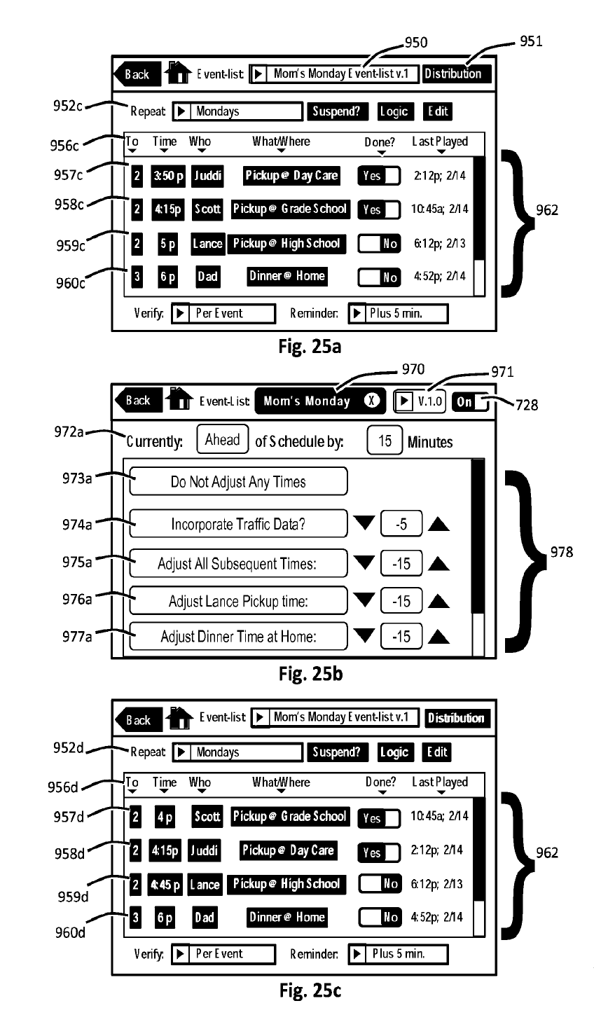

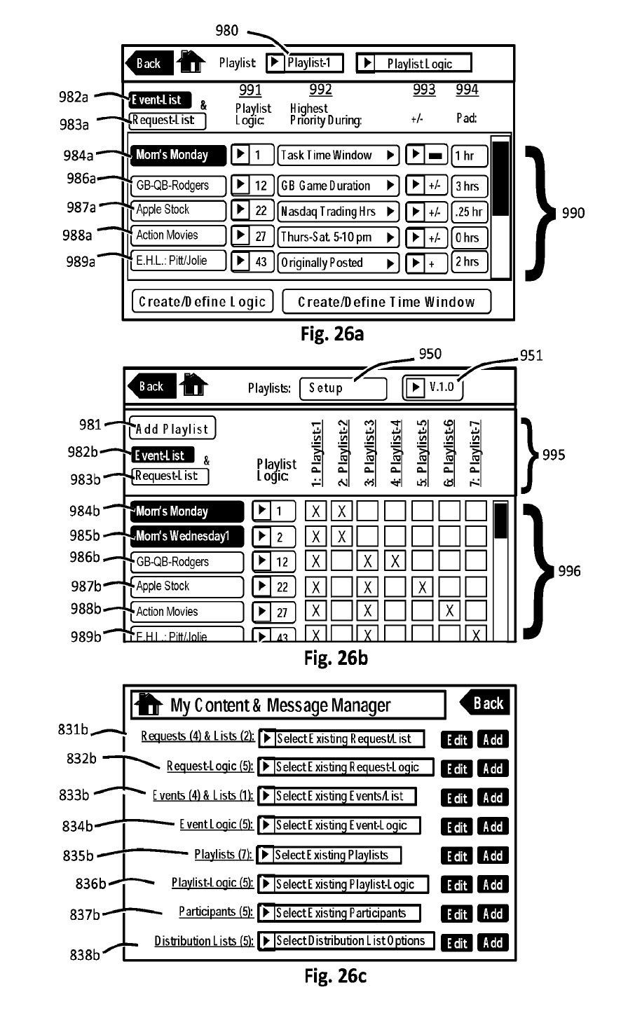

Back at step 484, the process can also proceed to a variety of steps 487-496, including a step 487 with a “Action List Script Compression & Segmentation Options (e.g. see FIGS. 22a-22h & FIGS. 23a-23h),” a step 488 with a “Event List: with None Done (e.g. see FIG. 24a),” a step 489 with a “Event List Rearranged (e.g. see FIG. 24b),” a step 490 with a “Event List Time Adjustments (e.g. see FIG. 24c),” a step 491 with a “Event List In-Progress (e.g. see FIG. 25a),” a step 492 with a “Event List Real-time Monitoring/Adjusting (e.g. see FIG. 25b),” a step 493 with a “Event List In Progress with Modifications & Updates (e.g. see FIG. 25c),” a step 494 with a “Playlists Logic & Priority Setup With Events and Request Lists (e.g. see FIG. 26a),” a step 495 with a “Playlists Participation Setup (e.g. see FIG. 26b),” where the steps 487-495 can then proceed to a step 496 with a “Status: My Content & Message Mgr. (e.g. see FIG. 26c).”

FIG. 20a illustrates the system 700 in an example implementation of the user interface in which the Participant/user 46 may create and/or modify a particular event or event-list, e.g. pressing button 708 at FIG. 14a, in various non-limiting embodiments. Here the Participant/user 46 may create and/or modify a particular event in an Event-List 771, depicted here as “My 1^{st} Event” in a 870 header, via the earlier button 708 in FIG. 14a or “edit” next to 715 in FIG. 14b. If the user wished to return to the requests (described earlier), he/she could utilized a “Request-List:” 772 function/button. Here, the participant can press the back button to return to the previous navigation screen, press the home button to return to the home screen, click a 872 field area to name, rename, and/or select a particular event list and/or event list item. The participant can click a 873 button/function to import an event-list, event list item and/or the like, here depicted with a “Select Import Source” in an associated drop down field 874.

On the other hand, the participant can utilize an “Or Create Event/Task From Template” area/functions, where there is a list of templates, depicted here starting with a “Who/What/Where/When (e.g. pickup kids)” 876 template, an “Errands/Shopping List/When/Where” 877 template, a “Work Action Item/Client/Deadline” 878 template, and an “Anniversaries/Event Reminder” 879 template. Here the participant can selected one of the templates (e.g. 876, 877, 878, or 879) to start building a new event list per the associated template.

FIG. 20b illustrates the system 700 in an example implementation of the user interface in which the Participant/user 46 has a “My First Event” 880 page/functionality for creating an event/task, in various non-limiting embodiments. A “Show Demo” 885 provides an ability (similar to 732, in FIG. 15a) to see demos of different templates and/or examples of event-list demos. Here, in FIG. 20b, the participant has selected the “Who/What/Where/When (e.g. pickup kids)” 876 template in FIG. 20a. In various non-limiting embodiments, a “What” 881 field and associated drop down options depicted here with an “Existing Options,” where the “Existing Options” can be based upon calendar entries, historical entries (e.g. from tasks, events, requests, playlists, playlist containers), entries from others (e.g. family, friends, co-workers, and/or the like), and/or the like.

In various non-limiting embodiments, a “Where” 882 field and associated drop down options also depicted here with an “Existing Options,” where the “Existing Options” can be based upon calendar entries, historical entries, entries from others (e.g. family, friends, co-workers, and/or the like), source links, event maps, GPS data, and/or the like. In various non-limiting embodiments, a “Who” 883 field and associated drop down options depicted here with an “Existing Options,” where the “Existing Options” can be based upon calendar entries, historical entries, entries from others (e.g. family, friends, co-workers, groups, circles, and/or the like), and/or the like. An “Add As Participant” 887 button/function provides the participant the ability to add a selection as a participant (e.g. also see FIGS. 21b and 21c).

In various non-limiting embodiments, a “Days” 884 field, followed by a “Time” 888 field both with an associated drop down options where the “Options” can be based upon calendar entries, historical entries, entries from others (e.g. family, friends, co-workers, and/or the like), and/or the like. A qwerty keyboard area 890 provides an ability to enter inputs per a traditional keyboard input. An “Add To Event-List” 886 provides an ability to add the created and/or modified entries as a new event-list or event-list item.

FIG. 20c illustrates the system 700 in an example implementation of the user interface in which the Participant/user 46 has the “My First Event” page/functionality and displays an event/task being created, in various non-limiting embodiments. Here, in FIG. 20c, the participant has selected “Pickup” from the “What” 881 field and associated drop down options, “At Day Care” from the “Where” 882 field and associated drop down options, and “Juddi” from the “Who” 883 field and associated drop down options. Here, the reverse video for “Juddi” can be set to depict a condition, such as where “Juddi” is an existing participant. In this example, the participant has also selected “Mon-Wed-Friday” in the “Days” 884 field, followed by “4:00 pm” in the “Time” 888 field.

FIG. 21a illustrates the system 700 in an example implementation of the user interface in which the Participant/user 46 has pressed the “Add To Event-List” 886 button/function back in the previous FIG. 20c to advance to a scheduled event titled “Event-List: ‘Mom's Monday,’” 900, where the page/functionality provides event details that can be viewed, entered, modified, and/or the like, along with providing event management options like Reminder, Life Span, Repeats, and/or the like, in various non-limiting embodiments. Here, the “Mom's Monday” 900 is depicted as a “Version 1.0” in a 901 field and associated drop down option.

An “Event 1:” 902 field and associated drop down depicted here with a “Pickup Juddi @Day Care,” followed by a “Start:” 903 field and associated drop down depicted here with a “Sep. 3^{rd}, 2011,” where the setting indicates that the event entitled “Event-List: ‘Mom's Monday,’” 900, is set run or be active starting on the “Sep. 3^{rd}, 2011” date, where as an “Ends:” 904 field and associated drop down depicted here with a “May 28, 2011,” where the setting indicates that the event entitled “Event-List: ‘Mom's Monday,’” 900, is set run up until or be activation ending on the “May 28, 2011” date, with an associated “Time” depicted here of “4:00 pm,” for the actual time of event of picking up Juddi at Day Care.

An Exception area provides for inputting exceptions to the event-list, starting with an “Exception 1:” 907 field and associated drop down option/menu depicted here with a “Federal Holidays,” where the system and/or user can incorporate an exception for known Federal Holidays. Followed by an “Exception 2:” 908 field and associated drop down option/menu depicted here with a “Calendar Range,” where the system and/or user can incorporate an exception for a selected date range, say for known family vacation or school break.

A “Lifespan” 909 field and associated drop down option/menu depicted here with a “Keep Alive,” where the system and/or user can set to keep this Event-List and/or Event-List item active. A “Repeats” 910 field and associated drop down option/menu depicted here with a “Yes,” where the system and/or user can set to repeat this Event-List and/or Event-List item while active. A “Logic” 917 field and associated drop down option/menu depicted here with a “1,” where the system and/or user can set the logic, conditions, and/or the like associated to this Event-List and/or Event-List item.

A “Reminder” 914 field and associated drop down option/menu depicted here with a “plus or minus 5 minutes,” where the system and/or user can set or change the number of minutes used to reminder either Mom, associated participants, and/or the like for this Event-List and/or Event-List items. A “Play/Window” 915 field and associated drop down option/menu depicted here with an “Event Window,” where the system and/or user can set or change to utilize this Event-List and/or Event-List item. A “Pad” 916 field and associated drop down option/menu depicted here with a “plus or minus 1 hour,” where the system and/or user can set or modify the time padding for this Event-List and/or Event-List item.

A “Calendar” 911 field and associated drop down option/menu depicted here with a “Monthly View,” where the system and/or user can set or modify the calendar visible in section 913 for selecting active Days (e.g. 905 field) for this Event-List and/or Event-List item active. A “Month” 912 field depicted here with a “February” where the system and/or user can set or modify the month for setting days/dates for this Event-List and/or Event-List item.

FIG. 21b illustrates the system 700 in an example implementation of the user interface in which the Participant/user 46 has a “Participants: Setup” page/functionality for creating/editing Participant/Contact profiles and related rules, in various non-limiting embodiments. Here, a “Participants” 918 field and associated drop down option/menu depicted here with a “Setup,” where the system and/or user can set or modify the participants for all Event-Lists and/or a particular Event-List. In a section 919, a Row 925 with an associated drop down menu/option depicted here with a “Juddi” is under a “Participant” 920 column, followed by a “Relation” 921 column, depicted by a “Daughter” in row 925, followed by an “Age” 922 column, depicted here with a “4” in row 925, followed by a “Groups” 923 column, depicted here with a “1, 2, 4” in row 925 (e.g. also see FIG. 21c), followed by a “Details” 924 column depicted here with an “Edit.” The row 925 is followed by a Row 926 with an associated drop down menu/option depicted here with a “Scott” under a “Participant” 920 column, followed by the Relation: “Son,” age: “8. Next, a Row 927 with an associated drop down menu/option depicted here with a “Lance” is under the “Participant” 920 column.

In various non-limiting embodiments, an “Add Participants” 928 button/function provides the ability to add other participants per a particular participant's input, history, device, group, circles, calendar, contacts, emails, messages, category, region, MNO, city, state, country, and/or the like. The participant can click a 929 button/function to import an existing participant/contact from an existing calendar, program, device, list, event-list, event list item and/or the like. In various non-limiting embodiments, an “Assign Groups” 930 button/function (e.g. see FIG. 21c) provides the ability to add or modify groups. A section 932 depicts a list of groups, starting with a Group 1: depicted here as a “1—Each independently,” a Group 2: depicted here as a “2—Family Just Kids,” a Group 3: depicted here as a “3—Family: Mom/Dad,” and a Group 4: depicted here as a “4—Family: Parents & Kids,” where the participant can scroll down with a vertical scroll thumb.

FIG. 21c illustrates the system 700 in an example implementation of the user interface in which the Participant/user 46 has a “Distribution: Setup” 936 page/functionality for creating/editing the Event-List's Participant distribution profiles and rules, in various non-limiting embodiments. Here, an “Add Participants” 937 field is where the system and/or user can set or modify the participants for all Event-Lists and/or a particular Event-List. An “Add Groups” 938 field is where the system and/or user can set or modify the groups for all Event-Lists and/or a particular Event-List.

In a section 946, a Row 939 with an associated drop down menu/option depicted here with a “Juddi-4” is under a “Participants” column, followed by the current list of groups (e.g. per FIG. 21b), starting with a “1—Each Independently” (depicted here, turned 90 degrees) column, followed by a “2—Just Kids” column, a “3—Mom/Dad” column, and a “4—Family” column, a “5—Parents” column, a “6—My Work” column, a “7—My Dept.” column, a “8—Boss” column, a “9—Friends1” column, and a “10—Friends2” column heading in a section 945.

Next, a section 946 has the Row 939, followed by a Row 940 with an associated drop down menu/option depicted here with a “Scott-8” is under the “Participants” column, where “Scott” is the participant's first name and “8” is the participants age. The Row 940 followed by a Row 941 with an associated drop down menu/option depicted here with a “Lance-15” is under the “Participants” column, followed by a “Sue-Mom,” where “Sue” is the participant's first name and “mom” is the participant's relationship selected relative to the other participants (e.g. Juddi, Scott, and Lance). Next, a Row 943 with an associated drop down menu/option depicted here with a “Ron” is under the “Participants” column, followed by a Row 944, with an associated drop down menu/option depicted here with a “Jim-Boss” is under the “Participants” column, where Jim could be a designation as a boss (e.g. Mom's boss, Dad's boss, both Mom and Dad's boss, and/or the like). A “X” 948 indicates that “Scott-8” is a member of the “2-Just Kids” Group. A scroll thumb provides an ability to scroll down for additional settings, functionality, visibility, and/or the like.

FIGS. 22a-22h depict a variety of options: (e.g. for playback scripts) Options 1a-4a and 1b-4b of the system 700 in an example implementation of the user interface in which the Participant/user 46 can select from the variety of options (e.g. formats, sources, participants, durations, compressions, truncations, segmentations, etc.). For example, Option 1a here in FIG. 22a has a total running time (TRT) of 8 minutes and twelve seconds due to the selected text options 551-557. Whereas, Option2a has a TRT of 5:75, since some text fields (e.g. 563 vs. 553) are shorter than in Option 1a. In addition, the Participant/user 46 can further adjust the TRT using the “Fit to: ‘X’ seconds 569 function, where the system can for example, adjust the speed, pitch and/or the like to compress and/or expand the TRT.

In addition, in various non-limiting embodiments, the system can employ shortcuts, abbreviations, and/or the like. For example, in Option 3a, it can drop the “pm” in field 576 to condense the TRT when compared to field 565 in Option 2a (FIG. 22b). In Option 4a, the system may know that parties listed for Juddi, Scott and Lance represent the family kids and substitute “kids” in field 584. Options 1b-4b depicted the fields while or after the events have occurred, e.g. field 593 “picked up”.

In various non-limiting embodiments, the system tracks how the projected times/dates for tasks match actual times/dates performed. In various non-limiting embodiments, the system would preferably make adjustments to tasks and/or events on Event-Lists automatically, systematically, conditionally, and/or user-selectively. For example, a particular user-selection could pre-establish a condition whereby showing up late to pick up one of three children from school would automatically adjust subsequent tasks (e.g. picking up child 2 and 3) and adjust playlists, texts, and/or notifications accordingly. For instance, in Option 1a, FIG. 22a, Mom was projected to pickup Juddi (e.g. child 1) at 4 pm (see 552), but actually picked up Juddi early, here at 3:50 pm (see 594) in Option 1b, FIG. 22e.

In various non-limiting embodiments, an event-list for Mom and/or other participants would be rearranged to match changing events, criteria, conditions (e.g. systematically tracking traffic conditions and/or weather, and/or the like, by mom, other participants, third party systems, groups (e.g. a child's after school coach adjustments to timed tasks), and/or the like. As well as track just who was notified of what, when, and/or the like. For example, whether Child 2 has acknowledged and/or received the most current playlist/message that Mom is running early or late.

For instance, if a particular child (e.g. Child 2/Scott) had already received a notification that Mom was coming at 4 pm, and the system may analyze data, historical events, conditions, and/or metrics to determine that Mom can make another errand on her task list before picking up Child 2/Scott at 4 pm. Then system can prompt Mom to let her decide what she would like to and/or simply track her decision, say via GPS. If on the other hand, if a child (e.g. Child 2/Scott) doesn't have a routine pickup time and has yet to retrieve/receive his pickup time for today, then the system may automatically, systematically, conditionally, and/or user-selectively change tasks, events, timing, and/or the like, say Child 2/Scott's pickup time, per changing circumstances.

FIGS. 23a-23h also depict a variety of options: (e.g. for playback scripts) Options 1c-4c and 1d-4d of the system 700 in an example implementation of the user interface in which the Participant/user 46 can select from the variety of (e.g. first half segments, second half segments, or segment/half combinations) options (e.g. formats, sources, participants, durations, compressions, truncations, segmentations, etc.). Here the messages, can be split into a sequence of messages, say 1c followed by 1d, where 1c is played (and/or queued) first and 1d is played (and/or queued) subsequently on the same call, a subsequent call, and/or the like. Further, the subsequent message could change based on events while the preceding message is playing.

FIG. 24a illustrates the system 700 in an example implementation of the user interface in which the Participant/user 46 may edit the Event-List, here “Mom's Monday Event-List” page/functionality that can include event details for a particular time (in this case, the time is one day). In various non-limiting embodiments, the Participant has event management options available on this page/functionality. In row 956a, listed are such headers as “Who,” “What/Where,” and “Done,” with “Done” being the fifth column that, in this embodiment, displays “No” to show that none of the tasks on this Event-list have yet been done/completed, in various non-limiting embodiments.

A Row 957a depicted here as a “2” indicates that this Row applies to Group “2,” whereas a Row 960a depicted here as a “3” indicates that this Row applies to Group “3,” where messages play to Group 3 and not Group 2 (e.g. See FIG. 21c). Here, a “Done” column header depicts a column of “No,” depicting that none of the listed events in rows 956a-960a are completed events or tasks. A “Suspend?” 953 provides an ability to suspend a particular event, event-list, associated event-list container, and/or event-list item. A “Logic” 954 provides an ability to create and/or adjust the logic of a particular event, event-list, associated event-list container, and/or event-list item. An “Edit” 955 provides an ability to edit and/or adjust a particular event, event-list, associated event-list container, and/or event-list item. A “Repeats” 952a provides an ability to repeat a particular event, event-list, associated event-list container, and/or event-list item, here depicted with “Mondays.” A “Verify” 963 field and associated drop down option/menu depicted here with a “Per Event,” where the system and/or user can automatically or manually verify items on the Event-List by a condition, here “per event.”

A “Reminder” 964 field and associated drop down option/menu depicted here with a “Plus 5 minutes,” where the system and/or user can automatically or manually queue, request, transmit and/or the like reminders, say per event, per participant, per modification, per time window, and/or the like.

FIG. 24b illustrates the system 700 in an example implementation of the user interface in which the Participant/user 46 has rearranged the order of the tasks in “Mom's Monday Event-List” page, in various non-limiting embodiments. Here, the tasks have been rearranged (e.g. reprioritized), where the rearrangement/reprioritization can be done automatically, systematically, conditionally and/or user-selectively (e.g. manually), say based upon changing events, notification successfulness, and/or the like.

FIG. 24c illustrates the system 700 in an example implementation of the user interface in which the Participant/user 46 is managing a particular task listed on “Mom's Monday” page/functionality, where the Participant can perform such actions as “Adjust Time” 978 and/or select the particular task listed, e.g. “Picked Up Juddi on Time,” “Picked Up Juddi Late,” Adjust Tasks &/or Times,” and/or the like, in various non-limiting embodiments.

FIG. 25a illustrates the system 700 in an example implementation of the user interface in which the Participant/user 46 may manage, edit and/or modify a particular event or event-list, e.g. here, pressing a “Yes” button in rows 957c and 958c under a “Done” header in the row 956c to show that two tasks on this Event-list are done/completed, in various non-limiting embodiments. A Row 957c depicted here as a “2” indicates that this Row applies to Group “2,” whereas a Row 960c depicted here as a “3” indicates that this Row applies to Group “3,” where messages play to Group 3 and not Group 2.

FIG. 25b illustrates the system 700 in an example implementation of the user interface in which the Participant/user 46 who may utilized a list of shortcut keys to update the status and logic employed in the Event-List and associated playlists heard by other participants (e.g. family members), e.g. “Currently Ahead of Schedule by 15 Minutes). Here, Mom is currently running ahead of schedule, where the system can automatically, conditionally, and/or user-selectively make adjustments. In various non-limiting embodiments, for example, the Participant (e.g. Mom) can also utilized the other shortcut keys, e.g. “Incorporate Traffic Data,” “Adjust All Subsequent (event) Times,” Adjust Dinner Time at Home,” and/or the like, in various non-limiting embodiments.

FIG. 25c illustrates the system 700 in an example implementation of the user interface in which the Participant/user 46 has adjusted the tasks times according to FIG. 25b, in various non-limiting embodiments. In various non-limiting embodiments, the system can automatically, conditionally, and/or user-selectively make adjustments dynamically as events unfold. Here, for example, the order of events can be rearranged from FIG. 25a to FIG. 25c, where the order of events/tasks have been rearranged, and where the system will attempt to notify participants accordingly. On the other hand, a participant can manually request a time and/or a task/event change, where the system can automatically, conditionally, and/or user-selectively make adjustments dynamically, say rearrange events, reprioritized playlists, and/or notify participants accordingly

FIG. 26a illustrates the system 700 in an example implementation of the user interface in which the Participant/user 46 accesses “Playlist-1” 980 to view/create/define Playlist Logic 991 and/or view/create/define Time Window, in various non-limiting embodiments. Here the participant can prioritize events and requests for generating merged items into a dynamic playlist of multiple sources, playlists, playlist items, associated playlist containers, and/or the like.

FIG. 26b illustrates the system 700 in an example implementation of the user interface in which the Participant/user 46 may organize and/or user-selectively assign content to a particular Playlist and/or Playlists, in various non-limiting embodiments. Here the participant can perform additional prioritization for events and requests for generating merged items into a dynamic playlist of multiple sources, playlists, playlist items, associated playlist containers, and/or the like. In addition, limiting which events, requests, items and/or the like are associated with which playlist container (e.g. Playlist 1 vs. Playlist 2, and so on).

FIG. 26c illustrates the system 700 in an example implementation of the user interface in which the Participant/user 46 has an overall view from a “My Content and Message Manager” page/functionality displaying the increase in Playlists 835b to 7 (an increase of +6 from the Playlists 835a in FIG. 18a), and the increase in Participants 837b to 5 (an increase of +4 from the Participants 837a in FIG. 18a), in various non-limiting embodiments.

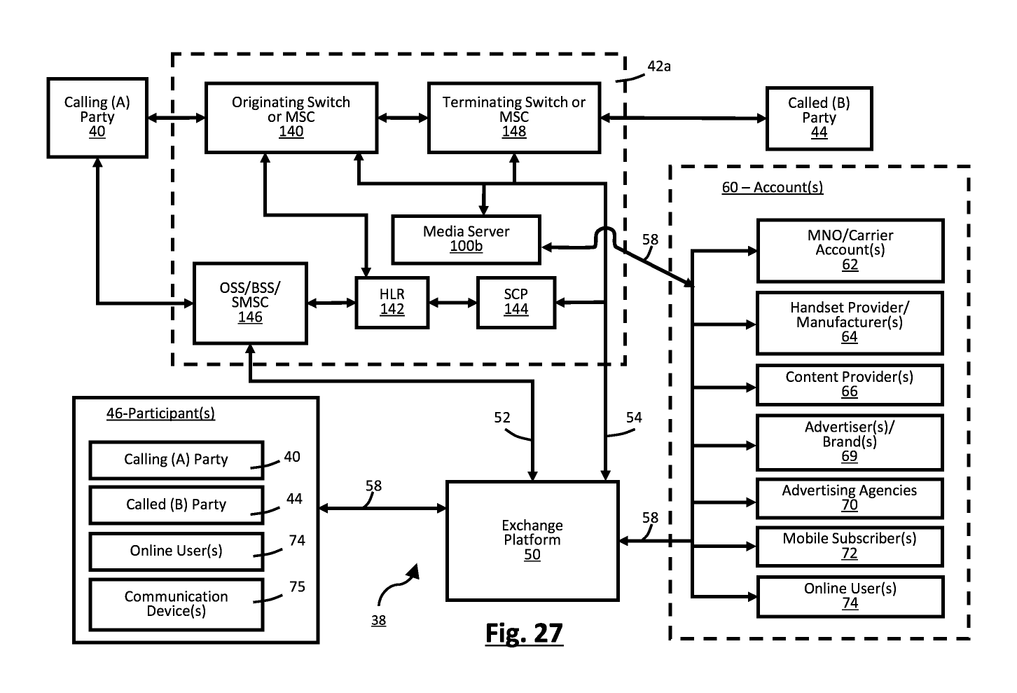

FIG. 27 is a block diagram depicting another embodiment of the Network Communication System 38. In various non-limiting embodiments, a Communication System (“CS”) 42a, the Participant(s) 46 and the Account(s) 60 are depicted in more detail. In various non-limiting embodiments and using cellular communication (e.g. including analog and/or digital networks) and/or MN, as an example, the Calling (A) Party 40 utilizes a mobile device (e.g. smartphone, cellular phone, PDA) as the communication device and connects to the Called (B) Party 44 through the CS 42a.

In various non-limiting embodiments, the CS 42a is comprised of at least one Originating Switch or Mobile Switching Center (MSC) 140, at least one Home Location Register (HLR) 142, at least one Service Control Point (SCP) 144, at least one OSS/BSS/SMSC 146 and at least one Terminating Switch or MSC 148, also referred to as a Terminating MSC or T-MSC. In various non-limiting embodiments the CS 42A is one or more Mobile Network Operators 42. Under certain conditions, the communication may be flagged and/or routed and interconnected to the EP 50 (e.g. see FIGS. 1-6b) and/or the Media Server 100b.

In various non-limiting embodiments, the NCS 38 includes Accounts 60 that are operatively couple and connected with the EP 50. In various non-limiting embodiments, the Accounts 60 are third parties who create, utilize, target, deliver, provide, and monitor information for communicating, marketing, advertising and/or selling to Participants 46. Participants 46, in various non-limiting embodiments, are the Calling (A) Party 40, the Called (B) Party 44, an Online User(s) 74, and/or the Communication Device 75. In various non-limiting embodiments, the Participants 46 can also be Accounts 60.

In various non-limiting embodiments, when any Calling (A) Party 40, Called (B) Party 44, Online User(s) 74 and/or Communication Device 75 is first routed to the EP 50 from the CS 42A where each is identified when capable and/or applicable. If the identified party who is to receive content (e.g. a multimedia segment from an associated playlist container) then that participant/user (e.g. calling party, called party, subscriber, party, person, client, device, and/or the like) is then flagged by the CS 42A and the call may be routed in a manner (e.g. through the EP 50 and/or Media Server 100b) where he/she/it may receive the Message and/or content (e.g. a multimedia segment from an associated playlist container). In various non-limiting embodiments, it is then up to the instructions stored in the EP 50 and/or Media Server 100b to determine if a particular item (e.g. message, multimedia segment, playback list, playlist, event-list, request-list, associated playlist container item, portion of a playlist, criteria, and/or the like) is sent, and what Message is sent/transmitted to whom, where (e.g. the Participant, Calling A Party, Calling B Party, Online Users, Communication Device(s) Account(s), equipment, location, event, targeted-component/profile, and/or the like).

In various non-limiting embodiments, the Communication Devices 75 used by Participant's 46 can be a transceiver (e.g. the mobile client/device 105, the cellular client/device 104) that allows operative communications between itself and the EP 50. In various non-limiting embodiments, the Participant 46 preferably would be physically carrying the Communication Devices 75. For example, a person/device/client 108 could be identified while in an environment where that identification in turn then triggers the EP 50 to queue/send/transmit that specific person/participant/client/device user (now the flagged participant) a particular Message (e.g. message, multimedia segment, playback list, playlist, event-list, request-list, associated playlist container item, portion of a playlist, criteria, and/or the like) to the Communication Devices 75 in the environment. In another embodiment, the Communication Devices 75 could simply have a speaker mechanism that can play the appropriate audio Message relative to any data known about the flagged person/participant in the EP 50 when, say passing a sensor and/or motion detector, such as those tracking devices (e.g. sensors and/or motion detectors) known in the art.

In various non-limiting embodiments, this person/participant who has been flagged to receive the Message from the EP 50 could respond to the audio Message queued/played/consumed using the same Communication Device 75 with the speaker attached and/or another Communication Device 75 (e.g. his/her smartphone), where the functionality could be broken into separate components where the person/participant flagged could respond by such methods as a voice command/prompt, pressing a designated button in the environment/area connected to the Communication Devices 75, by making a designated motion that surpasses a threshold, meets some identification criteria, and/or the like, and/or by some other method or means that can communicate a specific Action request back by the Participant 46, the environment, time of day, event profile, participant/user profile, and/or the like back to the EP 50.

In various non-limiting embodiments, the Accounts 60 may also be marketers and advertisers, which may also be the MNO/Carrier Account(s) 62 themselves. In various non-limiting embodiments, the data Accounts 60 input may include their total budget for messaging and advertising, a particular bid for a particular Campaign, and/or specific to segmentations, such as specific time, locations, and/or Participant 46 segments and/or as a content supply source/resource. In various non-limiting embodiments, the Accounts 60 input may also be content for audio Messages to a group of MNO/cellular subscriber/Participants 46, such as whose contract is ending soon, available minutes have been consumed, and/or eligible for a new phone offer. In various non-limiting embodiments, the terms “campaign” and “predetermined criteria” are interchangeable. In various non-limiting embodiments, “campaigns and “criteria” are interchangeable.

In various non-limiting embodiments, the input may also be the particular Account's 60 choices for profiling, targeting, delivering, tracking, and/or the like content, message, advertising, playlists, profile, segments, and/or the like with rules and instructions. In various non-limiting embodiments, the Accounts 60 may be categorized into segments, e.g. user and/or participant types, such as the MNO/Carrier Account(s) 62, Handset Provider/Manufacturer(s) 64, Content Provider(s) 66, Advertiser(s) and Brand(s) 68, Advertising Agencies 70, Mobile Subscriber(s) 72, and Online User(s) 74.

In various non-limiting embodiments, there may one mobile network operator 42 who is in control of the CS 42A, and/or some other component within the CS 42A (e.g. the Media Server 100b) would typically and preferably communicate with the EP 50, from within the CS 42A environment. For example, in this embodiment, a mobile network operator 42 such as Verizon® could communicate to the EP 50 from within the CS 42A environment, and/or along both the Connection 54 and via the TCP/IP 52 connections and/or any suitable network connection.

Verizon® in this example and embodiment could also connect from outside the CS 42A as a particular Account 60 (e.g. third party) or more precisely as a MNO/Carrier Account(s) 62 Account. Whereas a particular mobile network operator 42 who did not control the particular CS 42A in this example, such as Sprint®, may instead be allowed by the CS 42A owner, Verizon® here in this example and embodiment, to participate on the EP 50 through any network connection, here depicted as the Internet Connection 58 as the MNOCarrier Account(s) 62 Account. Further, in various non-limiting embodiments, Sprint® could have its own conditions, rules and permissions for Accounts 60 it allows access to the EP 50 connected to its own (Sprint's®) CS 42A that is completely or conditionally separate from the Verizon's® rules, conditions, and permissions employed by Verizon's®—and/or those rules, conditions and permissions employed at the Verizon® CS 42A which may also be connected to EP 50 and/or has the same or another Media Server 100b.

In various non-limiting embodiments, the EP 50 and/or accounts (e.g. MO 62, MNOs, etc.) could charge for tracking content, multimedia segmentation, requesting, queuing, prioritizing, reprioritizing, and/or the like. In various non-limiting embodiments, the EP 50 and/or accounts (e.g. MO 62, MNOs, etc.) could charge for tracking consumption of content, multimedia segments, requested sources, requested items, event items, and/or the like. In various non-limiting embodiments, the EP 50 and/or accounts (e.g. MO 62, MNOs, etc.) could charge for analyzing historical data/metrics and/or realtime data for evaluating, generating, and/or suggesting improved playlists, request-lists, event-lists, criteria, and/or associated playlist container items, say per reducing time inefficiencies, ambiguities, redundancies, inaccuracies, relevancies, and/or the like.

In various non-limiting embodiments, the same basic functionality applies for Handset Provider/Manufacturer(s) 64 that are Accounts 60 such as Samsung®, Motorola®, Nokia®, Research-In-Motion®, Apple®, Microsoft®, etc. where the information, content, media, playlists, event-lists, request-lists, messages, advertisements, communications, and/or the like that they provide, provide access to, along with the rules and logic governing each could be in general, and/or tailored to a particular mobile network operator 42 (e.g. Verizon®, AT&T®, T-Mobile®, Rogers®, Orange®, etc.), and/or to a particular mobile subscriber/participant who is using a particular handset brand, a particular OS, and/or a specific handset type (mobile communication device) used by any Calling (A) Party 40 and/or any Called (B) Party 44 that is connected to the CS 42A and/or the EP 50.

In various non-limiting embodiments, the Content Provider(s) 66 are Accounts 60 such as Yahoo! Financials®, Reuters®, NYSE®, NASDAQ®, Wikipedia®, Craigslist®, ESPN®, TMZ®, The Weather Channel®, etc. where the information, content, media, playlists, event-lists, request-lists, messages, advertisements, communications, logic/criteria, and/or the like that they provide to the EP 50 may be in any form retrievable by the Participant 46, such as audio Messages, SMS/MMS, text, images, video, etc. and/or may have designations for volume, duration, compression, truncation, segmentation, targeting, and/or the like. In various non-limiting embodiments, this content and/or designations may be made available for free, a fee, in exchange for service, in exchange for another event and/or Action, such as participating in a poll, and/or some combination of these. In various non-limiting embodiments, this content in some cases may be made available to Participants 46 in delineations referred to as multimedia segments, events, requests, playlist segments, event segments, request segments, and/or the like.

In various non-limiting embodiments, a playlist and/or associated playlist container item may include multimedia segments, content, media, events, requests, sources, resources, metadata, meta-tags, text, video, and/or may or may not include audio. In various non-limiting embodiments, a collection of content or multimedia segments is referred to as a playlist, where the playlist may be a predetermined playlist, and/or a dynamic playlist.

In various non-limiting embodiments, a collection of content is referred to as a playlist, predetermined playlist, and/or dynamic playlist. In various non-limiting embodiments, this content in some cases may also be delineated and/or grouped into programs, channels, and/or playlist profiles. In various non-limiting embodiments, a collection of programs may collected, associated, linked, correlated, and/or the like and may be referred to as a particular Program sequence, Channel, and/or a particular playlist profile.

In various non-limiting embodiments, the Advertiser(s) and Brand(s) 68 are Accounts 60 such as Coke®, McDonalds®, Nike®, Best Buy®, Starbucks®, etc. where the information, content, media, playlists, event-lists, request-lists, messages, advertisements, communications, logic/criteria, and/or the like that they provide to the EP 50 may be directly associated with a particular brand and/or a particular product and where such items are owned and controlled by the participating advertiser or brand. For example, the brand Coke® could supply a campaign of content with a collection of programs that creates a channel and/or playlist profile, where the content promotes a product, service, event, and/or the like owned or sponsored by Coke®. A retail brand such as Best Buy® could supply a campaign of content with a collection of programs that creates a channel and/or playlist profile, where the content promotes a particular product, location, event, hours, sale, and/or the like, say at the participating stores.

In various non-limiting embodiments, the Advertising Agencies 70 may also be Accounts 60 including Interpublic®, WPP Group®, Omnicom®, the Publicis Groupe®, Havas®, Dentsu®, etc. where the information, content, media, playlists, event-lists, request-lists, banners, skyscrapers, ad-containers, campaigns, messages, portions of a message, multimedia segments, portions of a playlist, items associated with a playlist container, advertisements, communications, logic, criteria, conditions, rules, updates, and/or the like that they provide to the EP 50 are for a client of theirs.

In various non-limiting embodiments, the Mobile Subscriber(s) 72 are Accounts 60 where the information, content, media, playlists, event-lists, request-lists, messages, advertisements, communications, logic/criteria, and/or the like that they provide to the EP 50 are as a mobile subscriber of a particular CS 42A owner, such as Verizon®, AT&T®, T-Mobile®, Sprint®, Rogers®, Orange®, etc. that has allowed the Mobile Subscriber 72 access to the EP 50 with an Account 60. In this embodiment, Mobile Subscriber(s) 72 are allowed to setup standard, or personalized content, data, media, events, requests, and/or the like that they provide to the EP 50

In various non-limiting embodiments, the Online User(s) 74 may be a participant, client, third-party, &/or Accounts 60 where the information, content, media, playlists, event-lists, request-lists, messages, advertisements, communications, logic, criteria, and/or the like that they provide to the EP 50 are in-general as a random consumer (e.g. user/participant), a particular user (e.g. a MNO subscriber/participant or an online user 74) or as a business (e.g. a particular account) who would typically connect via the World Wide Web. For example, a member of a social network, such as Facebook® could interact with the EP 50 as the online-user/participant 74 (versus as a mobile network subscriber). Here, for example, the online-user/participant 74 could interact with the EP 50 by, say creating a particular content message and/or Campaign (e.g. with a collection of programs, channels, multimedia segments, playlists, playlist conditions, request source conditions, event-list tasks, and/or the like) for others to interact with, e.g. hear, read, view, buy, sell, consume, reject, review, comment, add/delete, edit/modify content, edit/modify criteria, edit/modify playlists, edit/modify events, edit/modify requests, segment information, and/or the like.

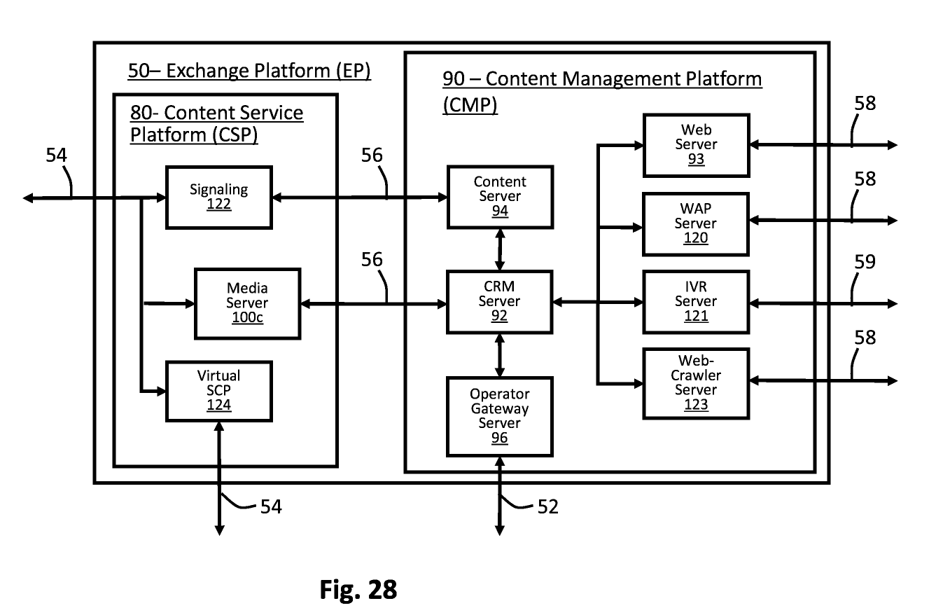

FIG. 28 is a block diagram depicting an another embodiment of the Exchange Platform (EP) 50 in more detail. In various non-limiting embodiments, the EP 50 intelligently receives, analyzes, selects, aggregates, searches, crawls, and delivers content, media, events, requests, playlist, data, logic/criteria, and/or the like throughout the NCS 38. In various non-limiting embodiments, the EP 50 includes user login assignments/capabilities, billing management, the ability to specify content, elements, events, requests, segmenting, profiling, targeting, intelligent agents (e.g. web-crawling), logic/criteria, rules, collections, programs, profiles, and/or the like electronically. In various non-limiting embodiments, the EP 50 would preferably minimize the effort of the Accounts 60 in how they select or want their content, data, media, events, requests, advertisement, messages, and/or the like, distributed, retrieved, transmitted, prioritized, viewed, consumed, sold, formatted, and/or the like.

In various non-limiting embodiments, the EP 50 may be accessed through a standard web interfaces via the Connection 58 into the Web Server 93, but may be any type of communication connection, and also provides a unique Application Programming Interface (API) solution for Accounts 60 who wish to build direct access to their messaging and advertising inventory.

In various non-limiting embodiments, the EP 50 further allows third parties or Accounts 60 to create, manage, distribute, measure, report and adjust their information, content, content/media/playlist portion, multimedia segment, playlists, event-lists, request-lists, messages, advertisements, communications, logic, criteria, condition, rule, and/or the like for, say a particular client, a particular participant, targeted profile, programs, channels, and/or the like. In various non-limiting embodiments, the EP 50 allows the Accounts 60 to setup specific Campaigns with information, content, content/media/playlist portion, multimedia segment, playlists, event-lists, request-lists, messages, advertisements, communications, logic, criteria, condition, rule, and/or the like, along with specific follow-up actions that may be taken by the Participants 46, setup with rules, instructions, and/or criteria for each particular content element, media outlet/source, playlist element, event-list element, request-list element, message element, advertisement element, communication element, logic/criteria element, and/or the like.

Further, in various non-limiting embodiments, the EP 50 provides the Accounts 60 other organization capabilities and reporting functionality, including revenue reports with various ways to analyzed, generate, view, review data, and/or the like, such as a summary total by Participant 46 and/or Participant segmentation (e.g. Demographics, Psychographics, Location, Motion, Contact History, Behavioral, etc.); timing, types of consumption (e.g. viewed, queued, deleted, played, saved, downloaded, streamed, copied, shared and/or the like), formats (e.g. device, OS, compression scheme, media player, and/or the like), sequences, prioritization, source-requests, playlists, event-lists, request lists, and usage tracking; action metrics, task/event completions, conversion metrics, and/or the like; and campaign, messaging, tasks, feedback, comments, number of likes, relatively how early “liked/disliked” (rated/ranked) compared to others, advertising and/or the like optimization goal types, say per targeting rules, consumption metrics, and/or conversion goals.

In various non-limiting embodiments, the EP 50 is comprised of a Content Service Platform (CSP) 80 and a Content Management Platform (CMP) 90. In various non-limiting embodiments, the CSP 80 and CMP 90 may communicate with each other through a standard Network Connection 56, typically a TCP/IP and/or a File Transfer Protocol (FIP) connection, but can be any type connection that is suitable (e.g. supports data). In various non-limiting embodiments, the CSP 80 and CMP 90 include a series of servers and modules, which communicate and are otherwise operatively connected within the EP 50.

In various non-limiting embodiments, the CMP 90 is comprised of a Content Server 94, a Customer Relationship Management (CRM) Server 92, an Operator Gateway Server 96, a Web Server 93, a WAP Server 120, an IVR Server 121, and a Web-Crawler Server 123 (e.g. Intelligent Agent/Bot/Web-Crawler/Web-Scutter). In various non-limiting embodiments, the Web Server 93 allows Accounts 60 to connect with the EP 50 via the Connection 58 or may be via any network connection suitable and allowed.

In various non-limiting embodiments, when Accounts 60 interact with the CMP 90 using a web interface accessible on the Web Server 93, the information needed for the logic and the association of items, such as what content, logic/criteria, timing, sequencing, consumptions, playlist logic/criteria, event-list logic/criteria, request-list logic/criteria, and usage tracking; action logic/criteria, tracking metrics, optimization, goals, tasks/events, completion thresholds, conversion metrics, modification history, profile modifications, behavior modifications, and/or the like; along with Account access and controls for administrators, employees, contractors, users, clients, advertisers, legal, shareholders, stakeholders, and/or the like.

Further, in various non-limiting embodiments, data, logic/criteria, metrics and/or the like regarding content collections for programs, campaigns, profiles, playlists, event-lists, request-lists, tasks, and/or the like. In various non-limiting embodiments, data, logic/criteria, metrics and/or the like regarding feedback, comments, number of likes, relatively how early “liked/disliked” (rated/ranked) compared to others, segments, time windows, related events, campaigns, and/or the like.

In various non-limiting embodiments, data, logic/criteria, metrics and/or the like regarding relative success and/or the like, and/or how it relates to a particular user, can comprise data, metrics and criteria regarding relative consumption, consumption rates, conversion rates, time savings, cost savings, efficient spending, and/or the like. In addition, relative feedback say regarding a particular user's satisfaction, say the client or participant, and/or in combination with a group or segmentation of users, family members, friends, co-workers, peers, experts, and/or the like.

In various non-limiting embodiments, data, logic/criteria, metrics and/or the like regarding relative success and/or the like, and/or how it relates to a particular user, participant, MNO 42, MNO/Carrier Account 62, Account 60 and/or Campaign is preferably stored and maintained on the CRM Server 92 and the associated content, data, events, Messages, and/or the like are stored and maintained on the Content Server 94.

In various non-limiting embodiments, a specific content is stored with a unique Content ID and a specific content segment (e.g. multimedia segment) is stored with a unique ID (e.g. a Content Segment ID). In various non-limiting embodiments, the content associated to a particular Account 60 and/or Campaign and addressable via the unique IDs and/or logic in the CRM Server 92 for WAP (Wireless Access Protocol) pages is stored and maintained on the WAP Server 120, which can be used interactively by the Participants 46 via the Connection 58 or any network connection. In various non-limiting embodiments, the content associated to a particular Account 60 and/or Campaign and addressable via the logic in the CRM Server 92 for IVR (Interactive Voice Response) information is stored and maintained on the IVR Server 121, which can be used interactively by the Participants 46 via the VTC 59 connection or any network connection.

In various non-limiting embodiments, all the content needed to support the near real-time playback of Messages is copied and pushed from the CMP's 90 Content Server 94 to the CSP's 80 Signaling 122 and Media Server 100c (sometimes combined and referred to as a Signal/Media Server 82) and tracked by the CRM Server 92. In various non-limiting embodiments, all the logic needed to support the near real-time instructions of an Account's 60 Campaign are pushed as a copy of the master file from the CMP's 90 CRM Server 92 to the CSP's 80 Content Server 94. In various non-limiting embodiments, this push (e.g. synchronization and/or updates) of needed content, Campaign logic, criteria, multimedia segments, metadata, and settings can either be set up to happen in preset time intervals (e.g. every hour), when updates are made, by rules determined by an Account 60, based on timing rules, based on billing/budgeting/bidding rules and/or some combination of these push methods.

In various non-limiting embodiments, the CS 42A (in the previous FIG. 24) can communicate with the CSP 80 via the Connection 54 and into a Signaling 122 Server/System/Module or via any suitable network communication connection. When the CS 42A routes a flagged call to the CSP 80 via the Signaling 122 (e.g. Server/System/Module) can comprise content and/or logic cached and/or communicates to an internal media server, a Media Server 100c. In various non-limiting embodiments, the Media Server 100c would preferably contain all the content, data, criteria, and/or the like needed to provide the appropriate prioritized dynamic or predetermined playlist content in near real-time, e.g. a playback of an audio Message (and/or Content/Message segment(s); any associated instructions and/or logic regarding the particular Message, (e.g. when to segment, when to compress, when to queue, when to play, to who, under what conditions, exceptions, how to prioritized, when to, search for updates, and/or the like), say per a particular Campaign/Criteria, say with a Timing Rule(s), a Sequencing Rule(s), &/or Prioritization Rule(s) for a particular Participant 46 and/or Campaign; any instructions for whether the particular Campaign employs and/or incorporates the Predetermined Participants 46, Predetermined Content, or if instead the particular Campaign will employ a Message Selection Engine 82 (“MSE”), (also see FIGS. 7-12), and/or the Dynamic Playlist. In various non-limiting embodiments, the term “Media Server” 100 and a “Playout Server” are interchangeable. In various non-limiting embodiments, the term “internal Media Server” 100c and an “internal Playout Server” are interchangeable. In various non-limiting embodiments, the term “Playout Platform and/or Server” and the “EP” 50 are interchangeable.

In various non-limiting embodiments, if a particular Playlist, Campaign, and/or the like employs and/or incorporates the MSE and/or the Dynamic Playlist, the EP 50 may employ multiple instructions, logic, rules, modules, engines, databases, resources, and/or the like to determine which Content, Content Segment, Content Sequence, Prioritization, Playlist, Actions, Data, Metrics, Feedback, Logic/Criteria (say to Mobile Client/Device) and/or the like are required where/when, present where/how, cached where/how, need to delivered where/how, play/queued/prioritized, where/how, streamed where/how, downloaded where/how/when, buffered where/how/for-how-long, queued where/how/for-how-long, forwarding attempted to where/how/for-how-long, and/or the like.

In various non-limiting embodiments, the Predetermined Playlist, MSE and/or the Dynamic Playlist would preferably employ as few instructions and resources as necessary to deliver the appropriate content and/or the like as promptly as possible. In various non-limiting embodiments, the Predetermined Playlist, MSE and/or the Dynamic Playlist would preferably employ work-around plans/logic, defaults, fail-safe logic/content, and/or the like, logic and content, for any missing, faulty and/or (under some conditions, see earlier examples) ambiguous content, logic, criteria, and/or the like.

In various non-limiting embodiments, the work-around plans/logic, defaults, fail-safe logic/content, and/or the like, would preferably incorporate metrics regarding what is unavailable within a particular metric (e.g. within a time threshold), including characterizations for “known to be missing,” “discerned to be missing,” “perceived to be missing,” and/or the like. In various non-limiting embodiments, the logic and content utilized may be relative to a number of factors, conditions, segments, characterizations, and/or the like, where for example, content characterized as “known to be missing,” could be preset to be treated differently than say content “perceived to be missing”.

In addition, the system tracks, analyzes, and generates what content gets retrieved, prioritized, sent, transmitted, buffered, queued, played, downloaded, shared, streamed, reprioritized, and/or the like and in what particular order (e.g. Prioritizing, Segmenting, and Sequencing Rules) during what windows of time (e.g. Timing Rules). In various non-limiting embodiments, any instructions for whether to incorporate an Optimization Selection Module would preferably be included and may be based on previous/historical performance data and metrics. In various non-limiting embodiments, the system tracks, analyzes, and generates any instructions as to whether to incorporate any user instructions and/or functionality (e.g. user inputs) for follow-up Actions to a particular Content ID, Content Segment ID, such as the DTMF signal from a button typically pressed by the Calling (A) Party 40 for requesting a SMS/MMS, a tiny URL, Web page, WAP page, Offer, coupons, External Communications (e.g. Email, Outbound Calls, Direct Mail, etc.), etc.

In various non-limiting embodiments, the EP 50 would preferably also communicate with the OSS/BSS/SMSC 146 (e.g. in the previous FIG. 24) via the Operator Gateway Server 96 through the TCP/IP 52 connection or any suitable network connection. In various non-limiting embodiments, the OSS/BSS/SMSC 146 represents the Mobile Operator's typical Legacy systems such as the Operations Support System (OSS); the Business Support System (BSS), the system typically to manage business operations such as provisioning, billing, sales management, customer-service management and customer database; the Short Message Service Center (SMSC), the system typically supports Short Message Service (SMS) and/or Multimedia Messaging Service (MMS) Message storage, point-to-point, mobile originated and terminated short message service.

In various non-limiting embodiments, the Participant 46 can respond to particular Content ID, Content Segment ID, a particular Campaign, a particular user feedback, and/or the like in a number of means, manners, and methods. For example, in various non-limiting embodiments, pressing any number or key combinations on their communication device (e.g. MNO/cellular client, mobile client 105, etc.) that have been pre-designated by a particular Account 60 as an approved and/or acceptable means to notify the EP 50 for a specific request for any additional information per Content ID or Content Segment ID heard, seen, played, queued, streamed, downloaded, reviewed, tagged, commented, shared, forwarded, and/or the like, referred as an Action.

In various non-limiting embodiments, if there is a series of potential sequential Actions to a particular Content ID or Content Segment ID (or Message ID), the first Action is referred to as the Initial Action for this embodiment. In various non-limiting embodiments, each Action following a previous Action is called a Subsequent Action whether initiated by the Participant 46 or the EP 50. In various non-limiting embodiments, an “Action Response” is a subset of Actions and refers to a specific Action that is sent back to the Participant 46 in “response” to particular Action taken by the Participant 46. In various non-limiting embodiments, the terms “participant, client 108, device, and/or mobile device” 105 are each interchangeable. In various non-limiting embodiments, the terms “participant” or “subscriber” and the term “MN subscriber” or “MNO subscriber” are interchangeable.

In various non-limiting embodiments, for example, the Calling (A) Party 40 and Called (B) Party 44 can communicate these Actions using SMS, when SMS is designated as an acceptable Action by an Account 60. In various non-limiting embodiments, the SMS is a mechanism/means of delivery of short messages over mobile networks. In various non-limiting embodiments, besides SMS, Smart Messaging (from Nokia), EMS (Enhanced Messaging System) and MMS have emerged. MMS adds images, text, audio clips and ultimately, video clips to SMS.

In various non-limiting embodiments, for example, if an Account 60 had a Campaign that included an audio clip/message (e.g. as the Content ID) where the audio clip played (and/or queued) a message that suggested the Participant 46 press any key on their communication device, known in the telecommunications industry as a DTMF command, to receive additional information in the form of a SMS or MMS, the Account 60 can utilize the Message Management Platform's 90 UI to setup this Action to a particular Message in advance. In various non-limiting embodiments, the MNO/Carrier Account 62 API's are typically connected via the TCP/IP 52 between the OSS/BSS/SMSC 146 and the Operator Gateway Server 96, but they can use any network connections suitable. In various non-limiting embodiments, the data contents and instructions are typically stored on the CRM Server 92.

In various non-limiting embodiments, for example, employing the Connection 54, or any network connection suitable such as the SS7/VTC, in one embodiment a particular Participant 46 presses the DTMF Action described (and pre-assigned by the Account 60) in response to an audio Message (e.g. as the Content ID) where the audio clip played (and/or queued) a message with an instruction that could be heard, seen, and/or per a previous Action explanation, as long as there is still an open and/or persistent Connection 54 or similar network connection there would preferably remain a one-to-one relationship for identifying the specific Participant 46 and the request, or Action, comes through the CS 42A to the EP 50 or via some other network connection.

For example, information not known or discerned when some content, logic, feedback, content sequencing, and/or the like, when an initial content/playlist (e.g. digital media item) and/or the like was initially delivered, could subsequently be updated, say as better and/or updated content, information, data, logic, and/or the like becomes/became available, say for a particular piece of content not yet played/heard in a sequence/playlist.

In various non-limiting embodiments, the EP 50 preferably knows which particular incoming Action request or set of instructions, came from which particular Participant 46, because of the one-to-one relationship between the audio clip/message played (and/or queued) via the audio message's Content ID, and the associated, correlated, and/or corresponding Action ID and/or instructions. In various non-limiting embodiments, the Content Server 94 sends the Action request to the CRM Server 92 where the associated content and instructions are stored and are in turn passed to the Operator Gateway Server 96 and back to the OSS/BSS/SMSC 146 via the TCP/IP 52 connection. In various non-limiting embodiments, the term “request-list” and “playlist” are interchangeable. In various non-limiting embodiments, the “associated criteria, items, elements, metadata, multimedia segments, and/or containers of the “playlist” and the “request-list are interchangeable.

In various non-limiting embodiments, the MNO/Carrier Account 62 in control of the CS 42A with the corresponding OSS/BSS/SMSC 146 can then push the SMS/MMS Action Response back to the appropriate Calling (A) Party via Path 57 or any network connection suitable. In various non-limiting embodiments, from the beginning of the call flow connection between the Participant 46 and the EP 50, the Content Server 94 creates and stores a unique session ID for that particular Participant 46 and any subsequent communications. In various non-limiting embodiments, should this particular Participant 46 later perform an Action such as request information based on instructions delivered in an earlier audio Message, SMS/MMS, or some other Action, those Actions will contain the original unique session ID to track that particular Participant 46 and the corresponding Actions.

In various non-limiting embodiments, types of Actions which can be performed by a Participant 46 can also include Clicks (on URLs embedded in the SMS/MMS message), Conversions (transactions traced through the unique session ID back to subscribers who heard or saw a particular Message), Page Views on WAP or Web sites (traced through the unique session ID back to subscribers/participants/users who heard, viewed, downloaded, saw, tagged, commented, re-ordered, re-sequenced, and/or the like, a particular Content ID, Content Segment ID, Action ID, Playlist logic/criteria, and/or the like).

In various non-limiting embodiments, the WAP Server 120, for example, can deliver WAP content and interact directly with Participants 46 via Connection 58 or any network connection suitable for communications with the EP 50. In various non-limiting embodiments, when a particular Participant 46 requests a WAP page, that Action request comes with the original session ID mapped through Tiny URL for that WAP page. In various non-limiting embodiments, both WAP pages and Web Pages also can be related with this particular Participant's 46 initial session ID by mapping through Tiny URL for the pages for tracking the collective effectiveness/success of a multi-step Campaign. Besides sending SMS/MMS responses through the MNO/Carrier Account 62 who controls the CS 42A and correlating OSS/BSS/SMSC 146. In another embodiment, the EP 50 could also host or subscribe to its own independent SMS/MMS server or service and such capabilities (not shown), similar to the WAP Server 120.

In various non-limiting embodiments, the IVR Server 120, for example, can deliver IVR content and interact directly with Participants 46 via Connection 59 or any network connection suitable for communications with the EP 50. In various non-limiting embodiments, the Web-Crawler Server 123, for example, can perform Web-Crawling, Intelligent Agent, Bot, Spider, and/or the like functions, e.g. searching and locating content. In various non-limiting embodiments, the Web-Crawler Server 123 can interact directly with Participants 46 via Connection 58 or any network connection suitable for communications with the EP 50 to accept and/or modify logic, content, metrics, and/or the like.

The present disclosure has advanced various systems and modules which support various systems and methods, which include, but are not limited to, the following systems and methods, which can themselves, include various systems and methods.

System 1. A system for network communications, the system comprising: a) an exchange platform; b) at least one network communicatively coupled to the exchange platform; c) a storage medium operably connected to the exchange platform; and d) a plurality of clients communicatively coupled to the exchange platform; e) wherein the exchange platform is configured for: receiving a request from a first client of the plurality of clients at the exchange platform; identifying the first client; retrieving a playlist for the first client from the storage medium, wherein the playlist comprises at least one multimedia segment; and transmitting the at least one multimedia segment to the identified first client based upon a predetermined criteria.

System 2. The system of System 1, wherein the exchange platform comprises a group consisting of at least one of: non-transitory instructions operable to monitor and manage quality of service (QoS); non-transitory instructions for notifications, interactions, and requests via the network communication system; and/or updates for the at least one client.

System 3. The system of System 1 or 2, wherein the exchange platform comprises a group consisting of at least one of: non-transitory instructions, modules, and associated computer implemented methods operable to track and analyze a network traffic; predetermined criteria and requests for the playlist, non-transitory instructions for notifications and interactions; and/or the plurality of clients.

System 4. The system of System 3, wherein the network communication system comprises a group consisting of at least one of: the exchange platform; a server; a computer, a display; an input device; an output device; a storage device; the storage medium; an internet; an intranet; a wireless network; a local area network; a wireless local area network; a wide area network; a metropolitan area network; at least one wired connection; a mobile network; a mobile network operator, a public switched telephone network; an access point; the first client; and/or the plurality of clients.

System 5. The system of System 4, wherein the predetermined criteria is determined by an input from an entity other than the first client.

System 6. The system of System 5, wherein the predetermined criteria is determined by reprioritizing a first client criteria based upon the input from the entity other than the first client.

System 7. The system of Systems 1 through 6, further comprising the step of determining if the predetermined criteria is ambiguous, preferably further comprising the step of transmitting an alert if the predetermined criteria is ambiguous.

System 8. The system of Systems 1 through 7, wherein the generated playlist comprises a plurality of multimedia segments, wherein the plurality of multimedia segments is transmitted according to a priority determined by the predetermined criteria.

Method 9. A method for network communications comprising a non-transitory computer readable medium, wherein the computer readable medium comprises instructions executable on a processor for: a) receiving a request from a first client at an exchange platform; b) identifying the first client; c) retrieving a playlist comprising at least one multimedia segment from a storage medium for the first client; and d) transmitting at least one multimedia segment based on a predetermined criteria of the first client.

Method 10. The method of Method 9, wherein the generated playlist is comprised of a plurality of multimedia segments, wherein the plurality of multimedia segments are transmitted according to a priority determined by the predetermined criteria, wherein the transmission of the plurality of multimedia segments is sequential.

Method 11. The methods of Method 9 or 10, further comprising the step of determining if the request from the first client is an ambiguity, preferably wherein the ambiguity prompts an alert.

Method 12. The method of Method 11, further comprising the step of transmitting the alert to the first client.

Method 13. The method of Methods 9 through 12, wherein the predetermined criteria for determining the at least one multimedia segment of the playlist to be transmitted comprises a manual operation; or an automatic operation; or both a manual and an automatic operation.

Method 14. The method of Method 13, wherein the manual operation comprises the steps of: a) transmitting to the first client at least the playlist; b) receiving an update to the playlist from the first client; c) monitoring a consumption and the predetermined criteria; and d) reprioritizing the at least one media segment contained in the playlist.

Method 15. The method of Method 13, wherein the automatic operation comprises the steps of: a) transmitting to the first client the at least one multimedia segment; b) debiting a consumption of the playlist by the first client; c) monitoring the consumption and the predetermined criteria of the first client; d) receiving an update from the first client; and e) reprioritizing the at least one media segment contained in the playlist.

Method 16. The method of Methods 9 through 15, wherein the playlist includes an associated playlist container, wherein the associated playlist container comprises a group consisting of at least one of: the at least one multimedia segment; at least one metadata; and/or at least one metatag.

Method 17. The method of Methods 13 through 16, wherein the manual operation or the automatic operation is performed by the exchange platform; or the client; or both the exchange platform and the client.

Method 18. The method of Methods 14 through 17, wherein the received update can be based in part on a group consisting of at least one of: the first client; a second client; at least one client; or both the first and second client.

Method 19. The method of Methods 14 through 18, wherein the reprioritization of the at least one media segment contained in the playlist can occur in real-time or near real-time.

Method 20. The method of Methods 14 through 19, wherein the reprioritization of the at least one media segment contained in the playlist can occur at the first client; at the exchange platform; or at both the first client and exchange platform.

Method 21. The method of Methods 9 through 20, wherein the playlist comprises a group consisting of at least one of: a predetermined playlist; a message selection engine playlist; a request list; an event list; and/or a dynamic playlist.

Method 22. The method of Method 21, wherein the dynamic playlist comprises a merging of the predetermined playlist, the message selection engine playlist, the request list, the event list, and/or a previously stored dynamic playlist.

Method 23. The method of Method 22, wherein the merged dynamic playlist comprises a group consisting of at least one of: segmented playlist; playlist item; associated playlist container item; and/or the predetermined criteria.

Method 24. The method of Method 23, wherein the segmented playlist comprises a group consisting of at least one of: at least one character, text; symbol; string; pixel; bit; byte; image; map; audio; video; graphic; placeholder, code; instructions; number, unique identifier, event; request; update; predetermined criteria; condition; rule; and/or condition.

Method 25. The method of Method 23 or 24, wherein the segments of the merged dynamic playlist can be reprioritized, preferably based upon an input from an entity other than the first client.

Method 26. The method of Methods 21 through 25, wherein the dynamic playlist is generated using a manual operation; an automatic operation; or both a manual and an automatic operation by the first client.

Method 27. The method of Methods 9 through 26, wherein the received request consists of a request selected from a group consisting of at least one of: a message; content; an event; a source; a resource; and/or the playlist.

Method 28. The method of Methods 9 through 27, wherein the predetermined criteria comprises a group consisting of at least one of: a consensus of a plurality of users; an artificial intelligence source; or both the consensus of the plurality of users and the artificial intelligence source.

Method 29. The method of Methods 9 through 28, wherein transmitting the at least one multimedia segment based on the predetermined criteria comprises a group consisting of at least one of: queuing; displaying; modifying; updating; storing; deleting; scoring; reading; linking; converting text to speech; playing; compressing format; expanding; paraphrasing; converting speech to text; translating; converting format; and/or reprioritizing the at least one multimedia segment.

Method 30. The method of Methods 9 through 29, wherein the predetermined criteria comprises a budget criteria, the budget criteria comprising a group consisting of at least one of the following: a credit limit; a credit report; a credit request; a credit evaluation; a credit determination; a credit adjustment; a credit challenge; a credit increase; a credit decrease; a credit freeze; a credit unfreeze; a credit alert; credit; a credit alert; a credit per item; a credit per retailer; a budget per retailer, a budget per brand; a budget per product; a budget per brand; a budget per product; a credit per venue; a credit per location; a budget per venue; a budget per location; a credit per user, a budget per user, a budget allotment; a bid allotment; a free-item; a conditionally-free item; and/or a budget condition.

Method 31. The method of Methods 9 through 30, wherein the predetermined criteria comprises a monetary criteria, the monetary criteria comprising a group consisting of at least one of the following: an exchange rate; an allowed foreign currency conversion; an exchange rate increase; an exchange rate decrease; an exchange rate freeze; an exchange rate unfreeze; an exchange rate change alert; an exchange rate change allowance; a fee allotment; a prize; and/or an economic condition.

Method 32. The method of Methods 9 through 31, wherein the at least one multimedia segment comprising a group consisting of at least one of the following: a conditional genre; a specific genre; a category; a meta-tag classification; a format; a distributor, a source; an author, an actor; a director; a singer, an artist; a photographer, a cinematographer, an inventor, a critic; a peer; an expert; a family-member, a friend; a co-worker; an associate; a participation condition; a participation level; a consumption condition; and/or a consumption level.

Method 33. The method of Methods 9 through 32, wherein the predetermined criteria comprises a source-list criteria for the at least one multimedia segment, the source-list comprising a group consisting of at least one of the following: a conditional company, a specific company; a brand; a product; a website; a database; a data store; a government agency, a creditability score; a budget condition; a temporal condition; an existing participation condition; an existing participation level; an existing consumption condition; and/or an existing consumption level.

Method 34. The method of Methods 9 through 33, wherein the predetermined criteria comprises a temporal criteria for the at least one multimedia segment, the temporal criteria comprising a group consisting of at least one of the following: a conditional moment in time; a specific moment in time; a conditional day, a specific day, a window of time; a range of time; a day, a date; a time-zone; a deadline; an extension; and/or any other temporal condition.

Method 35. The method of Methods 9 through 34, wherein the predetermined criteria comprises a availability criteria for the at least one multimedia segment, the availability criteria comprising a group consisting of at least one of the following: a conditional or specific format; venue; location; volume; in-stock; downloadable; stream-able; rentable; leasable; resalable; right-clearance; mechanic-rights; storage medium rights; other availability conditions; and/or some combination or permutation of these.

Method 36. The method of Methods 9 through 35, wherein the predetermined criteria comprises a consumption criteria for the at least one multimedia segment, the consumption criteria comprising a group consisting of at least one of the following: a conditional percentage; a conditional quantity; a specific percentage; a specific quantity of consumption per a predefined list/bulk/group/volume; percentage or quantity of consumption per a predefined item/brand/vendor/product/source; percentage or quantity of consumption per a predefined whole/value; percentage or quantity of consumption per a predefined portion/segment; percentage or quantity of consumption per a predefined temporal element/predetermined criteria/value; and/or percentage or quantity of consumption per a predefined user.

Method 37. The method of Methods 9 through 36, wherein the predetermined criteria comprises a user-input criteria for the at least one multimedia segment, the user-input criteria comprising a group consisting of at least one of the following: a prompt; a conditional prompt; and/or a specific prompt.

Method 38. The method of Method 37, wherein the prompt; conditional prompt; and/or specific prompt comprising a group consisting of at least one of the following: a keystroke; a specific keystroke; a dual-tone multi-frequency; a screen swipe; a screen pinch; an over the screen gesture; a voice command; a text input; a rule; a condition; a threshold; a range; a weighting; a score; a value; a limitation; a restriction; and/or a metric; analysis.

Method 39. The method of Methods 9 through 38, wherein the predetermined criteria comprises a lifespan criteria for the at least one multimedia segment, the lifespan criteria comprising a group consisting of at least one of the following: a specific format for a venue; a conditional association for a venue; a location; a score; an event; an inventory; a volume; a price; a device; a user; and/or a temporal condition.

Method 40. The method of Methods 9 through 39, wherein the predetermined criteria comprises a feedback criteria for the at least one multimedia segment, the feedback criteria comprising a group consisting of at least one of the following: a specific format for a genre; a conditional association for a genre; a category; a meta-tag classification; a format; a distributor, a source; an author, an actor; a director; a singer, an artist; a photographer, a cinematographer, an inventor a critic; a peer; an expert; a family-member, a friend; a co-worker; an associate; a participation condition; a participation level; a consumption condition; and/or a consumption level.

Method 41. The method of Methods 9 through 40, wherein the predetermined criteria comprises a originality criteria for the at least one multimedia segment, the originality criteria comprising a group consisting of at least one of the following: a relative association with a conditional genre; a relative association with a specific genre; a category; a meta-tag classification; a format; a distributor; a source; an author, an actor, a director, a singer, an artist; a photographer, a cinematographer, an inventor; a critic; a peer, an expert; a family-member; a friend; a co-worker, an associate; a participation condition; a participation level; a consumption condition; a consumption level; a brand; a product; a service; a price; an inventory; an event; a location; a venue; a score; a stock quote; and/or a weather metric.

Method 42. The method of Methods 9 through 41, wherein the predetermined criteria comprises a update criteria for the at least one multimedia segment, the update criteria comprising a group consisting of at least one of the following: a relative association with a conditional genre; a relative association with a specific genre; a category; a meta-tag classification; a format; a distributor; a source; an author, an actor, a director, a singer, an artist; a photographer, a cinematographer; an inventor, a critic; a peer, an expert; a family-member, a friend; a co-worker, an associate; a participation condition; a participation level; a consumption condition; a consumption level; a brand; a product; a service; a price; an inventory; an event; a location; a venue; a score; a stock quote; and/or a weather metric.

Method 43. The method of Methods 9 through 42, wherein the predetermined criteria comprises a prioritization criteria for the at least one multimedia segment, the prioritization criteria comprising a group consisting of at least one of the following: a relative association with the conditional budget criteria; a relative association with the specific budget criteria; the monetary criteria; the request-list criteria; the source-list criteria; the temporal criteria; an availability criteria; the consumption criteria; the user-input criteria; the lifespan criteria; the feedback criteria; the originality criteria; and/or the update criteria.

Method 44. The method of Methods 30 through 43, wherein the prioritized multimedia segments of the playlist is based in part on a group consisting of at least one of: the budget criteria; the monetary criteria; the request list criteria; the source list criteria; the temporal criteria; an availability criteria; the consumption criteria; the user input criteria; the lifespan criteria; the feedback criteria; the originality criteria; the update criteria; and/or the previously stored prioritization criteria.

Method 45. The method of Methods 30 through 44, wherein the predetermined criteria comprises a group consisting of at least one of: the budget criteria; monetary criteria; request list criteria; source list criteria; temporal criteria; availability criteria; consumption criteria; user input criteria; lifespan criteria; feedback criteria; originality criteria; update criteria; and/or prioritization criteria.

Method 46. The method of Methods 23 through 45, wherein the reprioritized segments of the merged dynamic playlist comprises a group consisting of at least one of: a budget criteria; a monetary criteria; a request list criteria; a source list criteria; a temporal criteria; an availability criteria; a consumption criteria; a user input criteria; a lifespan criteria; a feedback criteria; an originality criteria; an update criteria; and/or a previously stored prioritization criteria.

Method 47. A method for network communications comprising a non-transitory computer readable medium, wherein the computer readable medium comprises instructions executable on a processor for: a) providing an exchange platform; b) prioritizing a dynamic playlist from at least one playlist, wherein the at least one playlist comprises a plurality of multimedia segments retrieved from a first storage medium in the exchange platform; c) generating the dynamic playlist based on a predetermined criteria; and d) storing the prioritized dynamic playlist in a second storage.

Method 48. The method of Method 47, wherein the predetermined criteria can be based in part on a group consisting of at least one of the following: a first client; a second client; at least one client; a third party; a plurality of clients; both the third party and at least one client; and/or both the first and second client.

Method 49. The method of Method 47 or 48, wherein the generated dynamic playlist is comprised of the plurality of multimedia segments, preferably wherein the plurality of multimedia segments are transmitted according to a priority determined by the predetermined criteria, wherein the transmission of the plurality of multimedia segments is sequential.

Method 50. The method of Method s 47 through 49, wherein the at least one playlist comprises a group consisting of at least one of: a predetermined playlist; a message selection engine playlist; a request list; an event list; and/or a previously stored dynamic playlist.

Method 51. The method of Method s 47 through 50, wherein the plurality of multimedia segments comprises a group consisting of at least one of: a multimedia segment, message; content; event; request; source; resource; and/or a playlist.

Method 52. The method of Methods 47 through 51, wherein the exchange platform comprises a group consisting of at least one of: non-transitory instructions operable to monitor and manage quality of service (QoS); non-transitory instructions for notifications and interactions; requests for the network communication system; and/or updates for the at least one client.

Method 53. The method of Methods 48 through 52, wherein the exchange platform comprises non-transitory instructions, modules, and associated computer implemented methods operable to track and analyze data traffic, requests for the network communication system (NCS); and the plurality of clients.

Method 54. The method of Methods 47 through 53, wherein the network communication system (NCS) operatively couples the exchange platform with the at least one client.

Method 55. The method of Methods 47 through 54, further comprising the step of determining if the predetermined criteria is ambiguous.

Method 56. The method of Methods 47 through 55, further comprising the step of transmitting an alert if the predetermined criteria is ambiguous.

Method 57. The method of Methods 47 through 56, further comprising the step of retrieving the at least one multimedia segment based on the predetermined criteria.

Method 58. The method of Methods 47 through 57, further comprising the step of sourcing the at least one multimedia segment based on the predetermined criteria.

Method 59. The method of Methods 47 through 58, further comprising the step of retrieving the at least one multimedia segment based on the predetermined criteria.

Method 60. The method of Methods 47 through 59 further comprising the step of transmitting an at least one multimedia segment based on the predetermined criteria.

Method 61. The method of Methods 47 through 60, wherein the at least one multimedia segment comprises a group consisting of at least one of: digital content, analog content; or both digital and analog content.

Method 62. The method of Methods 48 through 61, wherein the at least one client comprises a group consisting of at least one of: a computer, client; server, mobile device; tablet computer, storage medium; internet protocol television (IPTV); computerized vehicle; global satellite positioning device; desktop computer, wireless-enabled-device; smartphone; digital-multimedia-enabled device; analog-media-enabled device; and/or cellular phone.

Method 63. The method of Methods 47 through 62, wherein the network communication comprises a group consisting of at least one of: the exchange platform; a server, computer, display; input device; output device; storage; an internet; intranet; wireless network; local area network (LAN); wireless local area network (WLAN); wide area network (WAN); metropolitan area network (MAN); wired connections; mobile network (MN); mobile network operator (MNO); public switched telephone network (PSTN); and/or access point.

Method 64. The method of Methods 47 through 63, wherein the generated playlist of the at least one multimedia segment comprises a priority.

Method 65. The method of Methods 47 through 64, wherein the predetermined criteria comprises a group consisting of at least one of: a consensus of a plurality of users; an artificial intelligence source; or both the consensus of the plurality of users and the artificial intelligence source.

Method 66. The method of Methods 47 through 65, wherein transmitting the at least one multimedia segment based on the predetermined criteria comprises a group consisting of at least one of: queuing; displaying; modifying; updating; storing; deleting; scoring; reading; linking; converting text to speech; playing; compressing format; expanding; paraphrasing; converting speech to text; translating; converting format; and/or reprioritizing the at least one multimedia segment.

Method 67. The method of Methods 47 through 66, wherein the predetermined criteria comprises a budget criteria, the budget criteria comprising a group consisting of at least one of the following: a credit limit; a credit report; a credit request; a credit evaluation; a credit determination; a credit adjustment; a credit challenge; a credit increase; a credit decrease; a credit freeze; a credit unfreeze; a credit alert; credit; a credit alert; a credit per item; a credit per retailer; a budget per retailer, a budget per brand; a budget per product; a budget per brand; a budget per product; a credit per venue; a credit per location; a budget per venue; a budget per location; a credit per user, a budget per user, a budget allotment; a bid allotment; a free-item; a conditionally-free item; and/or a budget condition.

Method 68. The method of Methods 47 through 67, wherein the predetermined criteria comprises a monetary criteria, the monetary criteria comprising a group consisting of at least one of the following: an exchange rate; an allowed foreign currency conversion; an exchange rate increase; an exchange rate decrease; an exchange rate freeze; an exchange rate unfreeze; an exchange rate change alert; an exchange rate change allowance; a fee allotment; a prize; and/or an economic condition.

Method 69. The method of Methods 47 through 68, wherein the at least one multimedia segment comprising a group consisting of at least one of the following: a conditional genre; a specific genre; a category; a meta-tag classification; a format; a distributor, a source; an author; an actor; a director; a singer, an artist; a photographer, a cinematographer; an inventor, a critic; a peer, an expert; a family-member, a friend; a co-worker, an associate; a participation condition; a participation level; a consumption condition; and/or a consumption level.

Method 70. The method of Methods 47 through 69, wherein the predetermined criteria comprises a source-list criteria for the at least one multimedia segment, the source-list comprising a group consisting of at least one of the following: a conditional company, a specific company; a brand; a product; a website; a database; a data store; a government agency, a creditability score; a budget condition; a temporal condition; an existing participation condition; an existing participation level; an existing consumption condition; and/or an existing consumption level.

Method 71. The method of Methods 47 through 70, wherein the predetermined criteria comprises a temporal criteria for the at least one multimedia segment, the temporal criteria comprising a group consisting of at least one of the following: a conditional moment in time; a specific moment in time; a conditional day a specific day; a window of time; a range of time; a day, a date; a time-zone; a deadline; an extension; and/or any other temporal condition.

Method 72. The method of Methods 47 through 71, wherein the predetermined criteria comprises a availability criteria for the at least one multimedia segment, the availability criteria comprising a group consisting of at least one of the following: a conditional or specific format; venue; location; volume; in-stock; downloadable; stream-able; rentable; leasable; resalable; right-clearance; mechanic-rights; storage medium rights; other availability conditions; and/or some combination or permutation of these.

Method 73. The method of Methods 47 through 72, wherein the predetermined criteria comprises a consumption criteria for the at least one multimedia segment, the consumption criteria comprising a group consisting of at least one of the following: a conditional percentage; a conditional quantity, a specific percentage; a specific quantity of consumption per a predefined list/bulk/group/volume; percentage or quantity of consumption per a predefined item/brand/vendor/product/source; percentage or quantity of consumption per a predefined whole/value; percentage or quantity of consumption per a predefined portion/segment; percentage or quantity of consumption per a predefined temporal element/predetermined criteria/value; and/or percentage or quantity of consumption per a predefined user.

Method 74. The method of Methods 47 through 73, wherein the predetermined criteria comprises a user-input criteria for the at least one multimedia segment, the user-input criteria comprising a group consisting of at least one of the following: a prompt; a conditional prompt; and/or a specific prompt.

Method 75. The method of Method 74, wherein the prompt; conditional prompt; and/or specific prompt comprising a group consisting of at least one of the following: a keystroke; a specific keystroke; a dual-tone multi-frequency; a screen swipe; a screen pinch; an over the screen gesture; a voice command; a text input; a rule; a condition; a threshold; a range; a weighting; a score; a value; a limitation; a restriction; and/or a metric; analysis.

Method 76. The method of Methods 47 through 75, wherein the predetermined criteria comprises a lifespan criteria for the at least one multimedia segment, the lifespan criteria comprising a group consisting of at least one of the following: a specific format for a venue; a conditional association for a venue; a location; a score; an event; an inventory; a volume; a price; a device; a user; and/or a temporal condition.

Method 77. The method of Methods 47 through 76, wherein the predetermined criteria comprises a feedback criteria for the at least one multimedia segment, the feedback criteria comprising a group consisting of at least one of the following: a specific format for a genre; a conditional association for a genre; a category, a meta-tag classification; a format; a distributor, a source; an author, an actor; a director; a singer, an artist; a photographer, a cinematographer, an inventor, a critic; a peer; an expert; a family-member, a friend; a co-worker; an associate; a participation condition; a participation level; a consumption condition; and/or a consumption level.

Method 78. The method of Methods 47 through 77, wherein the predetermined criteria comprises a originality criteria for the at least one multimedia segment, the originality criteria comprising a group consisting of at least one of the following: a relative association with a conditional genre; a relative association with a specific genre; a category; a meta-tag classification; a format; a distributor; a source; an author, an actor, a director, a singer, an artist; a photographer, a cinematographer, an inventor; a critic; a peer, an expert; a family-member; a friend; a co-worker, an associate; a participation condition; a participation level; a consumption condition; a consumption level; a brand; a product; a service; a price; an inventory; an event; a location; a venue; a score; a stock quote; and/or a weather metric.

Method 79. The method of Methods 47 through 78, wherein the predetermined criteria comprises a update criteria for the at least one multimedia segment, the update criteria comprising a group consisting of at least one of the following: a relative association with a conditional genre; a relative association with a specific genre; a category; a meta-tag classification; a format; a distributor; a source; an author, an actor, a director, a singer, an artist; a photographer, a cinematographer; an inventor, a critic; a peer, an expert; a family-member, a friend; a co-worker, an associate; a participation condition; a participation level; a consumption condition; a consumption level; a brand; a product; a service; a price; an inventory; an event; a location; a venue; a score; a stock quote; and/or a weather metric.

Method 80. The method of Methods 47 through 79, wherein the predetermined criteria comprises a prioritization criteria for the at least one multimedia segment, the prioritization criteria comprising a group consisting of at least one of the following: a relative association with the conditional budget criteria; a relative association with the specific budget criteria; the monetary criteria; the request-list criteria; the source-list criteria; the temporal criteria; an availability criteria; the consumption criteria; the user-input criteria; the lifespan criteria; the feedback criteria; the originality criteria; and/or the update criteria.

Method 81. The method of Methods 47 through 80, wherein the prioritized multimedia segments of the playlist is based in part on a group consisting of at least one of: the budget criteria; the monetary criteria; the request list criteria; the source list criteria; the temporal criteria; an availability criteria; the consumption criteria; the user input criteria; the lifespan criteria; the feedback criteria; the originality criteria; the update criteria; and/or the previously stored prioritization criteria.

Method 82. The method of Methods 47 through 81, wherein the predetermined criteria comprises a group consisting of at least one of: the budget criteria; monetary criteria; request list criteria; source list criteria; temporal criteria; availability criteria; consumption criteria; user input criteria; lifespan criteria; feedback criteria; originality criteria; update criteria; and/or prioritization criteria.

System 83. A system for network communications; the system comprising: a) an exchange platform; b) at least one network communicatively coupled to the exchange platform; c) a playlist based on a predetermined criteria; d) a storage medium operably connected to the exchange platform, wherein the playlist and the predetermined criteria are electronically stored on the storage medium; and e) a plurality of clients communicatively coupled to the exchange platform, wherein the plurality of clients receive the playlist.

System 84. The system of System 83, wherein the network communication system comprises a group consisting of at least one of: the exchange platform; a server; a computer; a display, an input device; an output device; a storage device; the storage medium; an internet; an intranet; a wireless network; a local area network; a wireless local area network; a wide area network; a metropolitan area network; at least one wired connection; a mobile network; a mobile network operator, a public switched telephone network; an access point; the first client; and/or the plurality of clients.

System 85. The system of System 83 or 84, wherein the plurality of clients comprises a group consisting of at least one of the following: a first client; a second client; at least one client; a third party; both the third party and the at least once client; and/or both the first and second client.

System 86. The system of Systems 83 through 85, wherein the exchange platform comprises non-transitory instructions operable to monitor and manage quality of service (QoS); interactions; requests; and/or updates for the at least one client.

System 87. The system of Systems 83 through 86, wherein the exchange platform comprises non-transitory instructions; modules; and/or associated computer implemented methods operable to track and analyze data traffic; requests for the network communication system and the plurality clients.

System 88. The system of Systems 83 through 87, wherein the network communication system comprises a group consisting of at least one of: the exchange platform; a server, a computer, a display, an input device; an output device; a storage; an internet; an intranet; a wireless network; a local area network; a wireless local area network; a wide area network; a metropolitan area network; at least one wired connection; a mobile network; a mobile network operator, a public switched telephone network; and/or an access point.

System 89. The system of Systems 85 through 88, wherein the predetermined criteria can be based in part on a group consisting of at least one of: the first client; a second client; the at least one client; a third party, both the third party and the at least once client; and/or both the first and second client.

System 90. The system of Systems 86 through 89, further comprising the step of determining if the predetermined criteria is ambiguous, preferably further comprising the step of transmitting an alert if the predetermined criteria is ambiguous, preferably further comprising the step of retrieving the at least one multimedia segment based on the predetermined criteria.

System 91. The system of Systems 86 through 90, further comprising the step of sourcing the at least one multimedia segment based on the predetermined criteria.

System 92. The system of Systems 86 through 91, further comprising the step of retrieving the at least one multimedia segment based on the predetermined criteria.

System 93. The system of Systems 86 through 92, further comprising the step of transmitting the at least one multimedia segment based on the predetermined criteria.

System 94. The system of Systems 86 through 93, wherein the at least one multimedia segment comprises a group consisting of at least one of: digital content; analog content; and/or both digital and analog content.

System 95. The system of Systems 86 through 94, wherein the client comprises a group consisting of at least one of: a computer, client; server, mobile device; tablet computer, storage medium; internet protocol television (IPTV); computerized vehicle; global satellite positioning device; desktop computer, wireless-enabled-device; smartphone; digital-multimedia-enabled device, analog-media-enabled device; and/or cellular phone.

System 96. The system of Systems 86 through 95, wherein the network communication comprises a group consisting of at least one of: the exchange platform; a server, computer, display; input device; output device; storage; an internet; intranet; wireless network; local area network (LAN); wireless local area network (WLAN); wide area network (WAN); metropolitan area network (MAN); wired connections; mobile network (MN); mobile network operator (MNO); public switched telephone network (PSTN); and/or access point.

System 97. The system of Systems 86 through 96, wherein the generated playlist of the at least one multimedia segment comprises a priority.

System 98. The system of System 97, wherein the prioritized segments of the playlist is based in part on a group consisting of at least one of: a budget criteria; a monetary criteria; a request list criteria; a source list criteria; a temporal criteria; an availability criteria; a consumption criteria; a user input criteria; a lifespan criteria; a feedback criteria; an originality criteria; an update criteria; and/or a previously stored prioritization criteria.

System 99. The system of Systems 83 through 98, wherein the predetermined criteria comprises a group consisting of at least one of: a consensus of a plurality of clients; an artificial intelligence source; or both the consensus of the plurality of clients and the artificial intelligence source.

System 100. The system of System 93 through 99, wherein transmitting at least one multimedia segment based on the predetermined criteria comprises a group consisting of at least one of: queuing; displaying; modifying; updating; storing; deleting; scoring; reading; linking; converting text to speech; playing; compressing format; expanding format; paraphrasing; converting speech to text; translating; converting format; and/or reprioritizing the at least one multimedia segment.

System 101. The system of Systems 83 through 100, wherein the predetermined criteria comprises a budget criteria, the budget criteria comprising a group consisting of at least one of the following: a credit limit; a credit report; a credit request; a credit evaluation; a credit determination; a credit adjustment; a credit challenge; a credit increase; a credit decrease; a credit freeze; a credit unfreeze; a credit alert; credit; a credit alert budget per item; a credit per retailer, a budget per retailer, a credit per brand; a credit per product; a budget per brand; a budget per product; a credit per venue; a credit per location; a budget per venue; a budget per location; a credit per user; a budget per user a budget allotment; a bid allotment; a free-item; a conditionally-free item; a budget condition.

System 102. The system of Systems 83 through 101, wherein the predetermined criteria comprises a monetary criteria, the monetary criteria comprising a group consisting of at least one of the following: an exchange rate; an allowed foreign currency conversion; an exchange rate increase; an exchange rate decrease; an exchange rate freeze; an exchange rate unfreeze; an exchange rate change alert; an exchange rate change allowance; a fee allotment; a prize; and/or an economic condition.

System 103. The system of Systems 83 through 102, wherein the predetermined criteria comprises a request-list criteria, the request-list criteria for the at least one multimedia segment comprising a group consisting of at least one of the following: a conditional genre; a specific genre; a category; a meta-tag classification; a format; a distributor; a source; an author, an actor, a director, a singer, an artist; a photographer, a cinematographer, an inventor a critic; a peer, an expert; a family-member, a friend; a co-worker; an associate; a participation condition; a participation level; a consumption condition; and/or a consumption level.

System 104. The system of Systems 83 through 103, wherein the predetermined criteria comprises a source-list criteria for the at least one multimedia segment, the source-list criteria comprising a group consisting of at least one of the following: a conditional company; a specific company, a brand; a product; a website; a database; a data store; a government agency, a creditability score; a budget condition; a temporal condition; an existing participation condition; an existing participation level; an existing consumption condition; and/or an existing consumption level.

System 105. The system of Systems 83 through 104, wherein the predetermined criteria comprises a temporal criteria for the at least one multimedia segment, the temporal criteria comprising a group consisting of at least one of the following: a conditional moment in time; a specific moment in time; a conditional day; a specific day; a window of time; a range of time; a day; a date; a time-zone; a deadline; an extension; and/or any other temporal condition.

System 106. The system of Systems 83 through 105, wherein the predetermined criteria comprises an availability criteria for the at least one multimedia segment, the availability criteria comprising a group consisting of at least one of the following: a conditional or specific format; venue; location; volume; in-stock; downloadable; stream-able; rentable; leasable; resalable; right-clearance; mechanic-rights; storage medium rights; other availability conditions; and/or some combination or permutation of these.

System 107. The system of Systems 83 through 106, wherein the predetermined criteria comprises a consumption criteria for the at least one multimedia segment, the consumption criteria comprising a group consisting of at least one of the following: a conditional percentage; a conditional quantity, a specific percentage; a specific quantity of consumption per a predefined list/bulk/group/volume; percentage or quantity of consumption per a predefined item/brand/vendor/product/source; percentage or quantity of consumption per a predefined whole/value; percentage or quantity of consumption per a predefined portion/segment; percentage or quantity of consumption per a predefined temporal element/predetermined criteria/value; and/or percentage or quantity of consumption per a predefined user.

System 108. The system of Systems 83 through 107, wherein the predetermined criteria comprises a user-input criteria for the at least one multimedia segment, the user-input criteria comprising a group consisting of at least one of the following: a conditional keystroke; a specific keystroke; a dual-tone multi-frequency, a screen swipe; a screen pinch; an over the screen gesture; a voice command; a text input; a rule; a condition; a threshold; a range; a weighting condition; a score; a value; a limitation; a restriction; a metric condition; and/or an analysis condition.

System 109. The system of Systems 83 through 108, wherein the predetermined criteria comprises a lifespan criteria for the at least one multimedia segment, the lifespan criteria comprising a group consisting of at least one of the following: a specific format for a venue; a conditional association for a venue; a location; a score; an event; an inventory; a volume; a price; a device; a user; and/or a temporal condition.

System 110. The system of Systems 83 through 109, wherein the predetermined criteria comprises a feedback criteria for the at least one multimedia segment, the feedback criteria comprising a group consisting of at least one of the following: a specific format for a genre; a conditional association for a genre; a category; a meta-tag classification; a format; a distributor, a source; an author, an actor; a director; a singer, an artist; a photographer, a cinematographer, an inventor, a critic; a peer; an expert; a family-member, a friend; a co-worker; an associate; a participation condition; a participation level; a consumption condition; and/or a consumption level.

System 111. The system of Systems 83 through 110, wherein the predetermined criteria comprises an originality criteria for the at least one multimedia segment, the originality criteria comprising a group consisting of at least one of the following: a relative association with a conditional genre; a relative association with a specific genre; a category; a meta-tag classification; a format; a distributor; a source; an author, an actor, a director, a singer, an artist; a photographer, a cinematographer, an inventor; a critic; a peer, an expert; a family-member; a friend; a co-worker, an associate; a participation condition; a participation level; a consumption condition; a consumption level; a brand; a product; a service; a price; an inventory; an event; a location; a venue; a score; a stock quote; and/or a weather metric.

System 112. The system of Systems 83 through 111, wherein the predetermined criteria comprises an update criteria for the at least one multimedia segment, the update criteria comprising a group consisting of at least one of the following: a relative association with a conditional genre; a relative association with a specific genre; a category, a meta-tag classification; a format; a distributor, a source; an author, an actor, a director, a singer, an artist; a photographer, a cinematographer, an inventor, a critic; a peer, an expert; a family-member, a friend; a co-worker, an associate; a participation condition; a participation level; a consumption condition; a consumption level; a brand; a product; a service; a price; an inventory; an event; a location; a venue; a score; a stock quote; and/or a weather metric.

System 113. The system of Systems 83 through 112, wherein the predetermined criteria comprises a prioritization criteria for the at least one multimedia segment, the prioritization criteria comprising a group consisting of at least one of the following: a relative association with a conditional budget criteria; a relative association with a specific budget criteria; a monetary criteria; a request-list criteria; a source-list criteria; a temporal criteria; an availability criteria; a consumption criteria; a user-input criteria; a lifespan criteria; a feedback criteria; an originality criteria; and/or a update criteria.

System 114. The system of Systems 83 through 113, wherein the predetermined criteria comprises a group consisting of at least one of: the budget criteria; monetary criteria; request list criteria; source list criteria; temporal criteria; availability criteria; consumption criteria; user input criteria; lifespan criteria; feedback criteria; originality criteria; update criteria; and/or prioritization criteria.

System 115. The method of Systems 83 through 114, wherein the prioritized multimedia segments of the playlist is based in part on a group consisting of at least one of: the budget criteria; the monetary criteria; the request list criteria; the source list criteria; the temporal criteria; an availability criteria; the consumption criteria; the user input criteria; the lifespan criteria; the feedback criteria; the originality criteria; the update criteria; and/or the previously stored prioritization criteria.

In various non-limiting embodiments, the disclosure presents various methods performed by a computer having a memory and a processor for data interchange, the method compromising, a receiving a first user input; analyzing the first user input; generating a relative accuracy score, where the first user input is relatively compared with a second input; analyzing the relative accuracy score against a relative accuracy criteria, wherein a violation of the relative accuracy criteria generates a prompt; sending the prompt to an entity; and receiving a decision from the entity.

In various non-limiting embodiments, the disclosure presents various methods performed by a computer having a memory and a processor for information extraction, natural language processing, and relationship mapping, including parsing, analyzing, indexing, classifying, evaluating, and/or the like, including the utilization of semantics analysis where each every data element, object, person, item, node, device, location, subject, delineation, segment, interval, and/or the like, mentioned herein should be considered a node for relationship mapping. Further, where this entire specification, pages, headings, paragraphs, sentences, words, figures, steps, parts, objects, tables, fields, and/or the like is a node, and/or can be parsed and treated like a node for relationship purposes. Further, each and every element herein this specification, pages, headings, paragraphs, sentences, words, figures, steps, parts, objects, tables, fields, node, user, term, rule, element, and/or the like can be parsed, analyzed, and evaluated to provide a relationship to each every other node, including nodes referenced outside the specifications, such as website, other art, prior applications. Further, each and every element herein this specification, pages, headings, paragraphs, sentences, words, figures, steps, parts, objects, tables, fields, node, user, term, rule, element, and/or the like can be parsed, analyzed, and evaluated to generate triples, IP-Triples, triple statements, IP-Statements, and/or the like.

The foregoing description of the present disclosure has been provided for purposes of illustration and description. It is not intended to be exhaustive or to limit any invention to the precise forms disclosed. Many modifications and variations will be apparent to the practitioner skilled in the art. Embodiments were chosen and described in order to best explain the principles of any particular invention and its practical application, thereby enabling others skilled in the art to understand any particular invention, the various embodiments and with various modifications that are suited to the particular use contemplated. It is intended that the scope of a particular invention be defined by the following claims and their equivalents.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. In various non-limiting embodiments, the computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. In various non-limiting embodiments, the program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet 136 using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. In various non-limiting embodiments, these computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In various non-limiting embodiments, these computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

In various non-limiting embodiments, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure. Therefore, one having ordinary skill in the art will readily understand that the disclosure as discussed above may be practiced with steps in a different order, may be practiced with hardware elements in configurations which are different than those which are disclosed, and that embodiments may be combined in any appropriate manner.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In addition, the term application as used herein refers to computer software program in general and can further encompass data, configuration settings, etc., used by the computer software program. Examples include utilities such as e-mail, Short Message Service (SMS) text utility, DTMF, IM, chat interface, web browsers, calculators, viewers, media players, games, calendars, tasks, to-do-lists, shopping-lists, contact managers, home monitoring/security surveillance, etc. In an exemplary aspect, application can refer to software that is suitable for use on a mobile device, especially to being downloaded via a Wireless Local Access Network (WLAN) or Wireless Wide Area Network (WWAN).

As a further example, applications as used herein can also refer to widgets, which can be a code set installed or executed in a webpage without compilation. Examples of widget information which can be downloaded through the Internet 136 include information of weather, sports, financial news, stock data/ticks/reports, stock market data/ticks/reports, medical records, prescription records/data, traffic, real-time search ranking, photos, slides, presentations, videos, playlists, post-it notes, horoscopes, etc. Widgets can be added to social networking profiles, blogs, or Web sites. Examples of types of widgets include (1) a widget engine, (2) GUI widgets (which are a component of a graphical user interface in which the user interacts), (3) Web widgets (which refer to a third party item that can be embedded in a Web page), and (4) mobile widgets (a third party item that can be embedded in a mobile device/phone).

For clarity, examples herein denote applications that are locally stored on user equipment, mobile devices, handset, access terminals, etc. However, implementations can encompass applications that are remotely stored. Similarly, for clarity distributing of the applications to the mobile devices can be described as being wirelessly downloaded from a WWAN or WLAN or P2P. However, implementations can include wired distribution, manual insertion of non-transitory computer readable storage medium, and unlocking a previously installed software object.

The word “exemplary” used anywhere herein is to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (Cl)), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet 136 or a local area network (IAN). Of course, those skilled in the art will recognize many modifications may be made to this configuration without departing from the scope of the disclosed aspects.

In various non-limiting embodiments, the steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In various non-limiting embodiments, the processor and the storage medium may reside in an ASIC. In various non-limiting embodiments, the ASIC may reside in a user terminal. In the alternative, the processor and the storage medium may reside as discrete components in a user terminal. The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. In various non-limiting embodiments, a process is terminated when its operations are completed. In various non-limiting embodiments, a process may correspond to a method, a function, a procedure, a subroutine, a subprogram, etc. When a process corresponds to a function, its termination corresponds to a return of the function to the calling function or the main function.

In view of the exemplary systems described supra, methodologies that may be implemented in accordance with the disclosed subject matter have been described with reference to several flowcharts, flow diagrams. While for purposes of simplicity of explanation, the methodologies are shown and described as a series of blocks, it is to be understood and appreciated that any claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

Similarly, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. In various non-limiting embodiments, a code segment may represent a procedure, a function, a subprogram, a program, a routine, a subroutine, a module, a software package, a class, or a combination of instructions, data structures, or program statements. In various non-limiting embodiments, a code segment may be coupled to another code segment or a hardware circuit by passing and/or receiving information, data, arguments, parameters, or memory contents. In various non-limiting embodiments, information, arguments, parameters, data, etc. may be passed, forwarded, or transmitted through a suitable means including memory sharing, message passing, token passing, network transmission, etc.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

1. A system for network communications, the system comprising:
a) an exchange platform;
b) at least one network communicatively coupled to the exchange platform;
c) a storage medium operably connected to the exchange platform; and
d) a plurality of clients communicatively coupled to the exchange platform;
e) wherein the exchange platform is configured for:
receiving a request from a first client of the plurality of clients at the exchange platform;
identifying the first client;
retrieving a playlist for the first client from the storage medium, wherein the playlist comprises at least one multimedia segment; and
transmitting the at least one multimedia segment to the identified first client based upon a predetermined criteria.

2. The system of claim 1, wherein the exchange platform comprises a group consisting of at least one of: non-transitory instructions operable to monitor and manage quality of service (QoS); non-transitory instructions for notifications, interactions, and requests via the network communication system; and updates for the at least one client.

3. The system of claim 2, wherein the exchange platform comprises a group consisting of at least one of: non-transitory instructions, modules, and associated computer implemented methods operable to track and analyze a network traffic; predetermined criteria and requests for the playlist; non-transitory instructions for notifications and interactions; and the plurality of clients.

4. The system of claim 3, wherein the network communication system comprises a group consisting of at least one of: the exchange platform; a server; a computer; a display; an input device; an output device; a storage device; the storage medium; an internet; an intranet; a wireless network; a local area network; a wireless local area network; a wide area network; a metropolitan area network; at least one wired connection; a mobile network; a mobile network operator; a public switched telephone network; an access point; the first client; and the plurality of clients.

5. The system of claim 4, wherein the predetermined criteria is determined by an input from an entity other than the first client.

6. The system of claim 5, wherein the predetermined criteria is determined by reprioritizing a first client criteria based upon the input from the entity other than the first client.

7. The system of claim 6, further comprising the step of determining if the predetermined criteria is ambiguous, preferably further comprising the step of transmitting an alert if the predetermined criteria is ambiguous.

8. The system of claim 7, wherein the generated playlist comprises a plurality of multimedia segments, wherein the plurality of multimedia segments is transmitted according to a priority determined by the predetermined criteria.

9. A method for network communications comprising a non-transitory computer readable medium, wherein the computer readable medium comprises instructions executable on a processor for:
a) receiving a request from a first client at an exchange platform;
b) identifying the first client;
c) retrieving a playlist comprising at least one multimedia segment from a storage medium for the first client; and
d) transmitting at least one multimedia segment based on a predetermined criteria of the first client.

10. The method of claim 9, wherein the generated playlist is comprised of a plurality of multimedia segments, wherein the plurality of multimedia segments are transmitted according to a priority determined by the predetermined criteria, wherein the transmission of the plurality of multimedia segments is sequential.

11. The method of claim 10, further comprising the step of determining if the request from the first client is an ambiguity, preferably wherein the ambiguity prompts an alert.

12. The method of claim 11, further comprising the step of transmitting the alert to the first client.

13. The method of claim 12, wherein the predetermined criteria for determining the at least one multimedia segment of the playlist to be transmitted comprises a manual operation; or an automatic operation; or both a manual and an automatic operation.

14. The method of claim 13, wherein the manual operation comprises the steps of:
a) transmitting to the first client at least the playlist;
b) receiving an update to the playlist from the first client;
c) monitoring a consumption and the predetermined criteria; and
d) reprioritizing the at least one media segment contained in the playlist.

15. The method of claim 13, wherein the automatic operation comprises the steps of:
a) transmitting to the first client the at least one multimedia segment;
b) debiting a consumption of the playlist by the first client;
c) monitoring the consumption and the predetermined criteria of the first client;
d) receiving an update from the first client; and
e) reprioritizing the at least one media segment contained in the playlist.

16-82. (canceled)

83. A system for network communications; the system comprising:
a) an exchange platform;
b) at least one network communicatively coupled to the exchange platform;
c) a playlist based on a predetermined criteria;
d) a storage medium operably connected to the exchange platform, wherein the playlist and the predetermined criteria are electronically stored on the storage medium; and
e) a plurality of clients communicatively coupled to the exchange platform, wherein the plurality of clients receive the playlist.

84. The system of claim 83, wherein the network communication system comprises a group consisting of at least one of: the exchange platform; a server; a computer; a display; an input device; an output device; a storage device; the storage medium; an internet; an intranet; a wireless network; a local area network; a wireless local area network; a wide area network; a metropolitan area network; at least one wired connection; a mobile network; a mobile network operator; a public switched telephone network; an access point; the first client; and the plurality of clients.

85. The system of claim 84, wherein the plurality of clients comprises a group consisting of at least one of the following: a first client; a second client; at least one client; a third party; both the third party and the at least once client; and both the first and second client.

86. The system of claim 85, wherein the exchange platform comprises non-transitory instructions operable to monitor and manage quality of service (QoS); interactions; requests; and updates for the at least one client.

87. The system of claim 86, wherein the exchange platform comprises non-transitory instructions; modules; and associated computer implemented methods operable to track and analyze data traffic; requests for the network communication system and the plurality clients.

88-115. (canceled)
